(19) United States
(12) Patent Application Publication
(10) Pub. No.: US 2025/0299249 A1
(43) Pub. Date: Sep. 25, 2025

(54) SYSTEMS AND METHODS FOR DYNAMICALLY MANAGING ONLINE AUCTIONS

(71) Applicant: VIRROW, LLC, Manchester, NH (US)

(72) Inventor: Thomas Svoleantopoulos, Manchester, NH (US)

(21) Appl. No.: 19/086,362

(22) Filed: Mar. 21, 2025

Related U.S. Application Data
(60) Provisional application No. 63/568,023, filed on Mar. 21, 2024.

(51) Int. Cl. G06Q 30/08; G06Q 40/02; G06Q 40/03; G06Q 50/16

(52) U.S. Cl. CPC G06Q 30/08; G06Q 40/02; G06Q 40/03; G06Q 50/16

(57) ABSTRACT

Examples of the disclosure include one or more non-transitory computer-readable media that enable at least one processor to determine an online auction close time, provide a bidder interface to enable the bidder to place at least one bid on an asset, determine, dynamically in real-time while the online auction is being conducted, whether the bidder has access to an immediate-purchase option and provide user-interface elements on the bidder interface to enable the bidder to immediately purchase the asset for an immediate-purchase price prior to the auction close time expiring based on the bidder having access to the immediate-purchase option, update the bidder interface in real-time to display a current highest bid in response to a bid, and in response to a selection of user-interface elements to immediately purchase the asset, update the bidder interface in real-time prior to the auction close time expiring to indicate that the auction is closed.

### CROSS-REFERENCE TO RELATED APPLICATIONS

This application claims priority under 35 U.S.C. § 119 (e) to U.S. Provisional Application Ser. No. 63/568,023, titled “SYSTEMS AND METHODS FOR DYNAMICALLY MANAGING ONLINE AUCTIONS,” filed on Mar. 21, 2024, which is hereby incorporated by reference in its entirety.

### BACKGROUND

At least one example in accordance with the present disclosure relates generally to conducting online auctions.

### SUMMARY

Examples of the methods and systems discussed herein are not limited in application to the details of construction and the arrangement of components set forth in the following description or illustrated in the accompanying drawings. The methods and systems may be capable of implementation in other embodiments and of being practiced or of being carried out in various ways. Examples of specific implementations are provided herein for illustrative purposes and are not intended to be limiting. Acts, components, elements, and features discussed in connection with any one or more examples may be configured to operate and/or be implemented in a similar role in any other examples.

The phraseology and terminology used herein is for the purpose of description. References to examples, embodiments, components, elements, or acts of the systems and methods herein referred to in the singular may also embrace embodiments including a plurality. Similarly, references in plural to embodiments, components, elements, or acts may be implemented as a singularity. References in the singular or plural form may therefore not be intended to limit the presently disclosed systems or methods, their components, acts, or elements. The use herein of “including,” “comprising,” “having,” “containing,” “involving,” and variations so forth, may encompass the items listed thereafter and equivalents thereof as well as additional items.

References to “or” may be construed as inclusive so that any terms described using “or” may indicate any of a single, more than one, and all of the described terms. For example, the phrase “at least one of A or B” may refer A and/or B—that is, A only, B only, or A and B together. In addition, in the event of inconsistent usages of terms between this document and documents incorporated herein by reference, the term usage in the incorporated documents is supplementary to this document. For irreconcilable differences, the term usage in this document controls.

According to at least one aspect of the present disclosure At least one non-transitory computer-readable medium storing thereon sequences of computer-executable instructions for providing a real-time dynamically adjusted user interface for an online auction, the sequences of computer-executable instructions including instructions that instruct at least one processor to: determine, for an asset being auctioned in the online auction, an auction close time at which the online auction will close; provide a bidder interface for a bidder, the bidder interface including one or more first user-interface elements to enable the bidder to place at least one bid on the asset being auctioned; determine, dynamically in real-time while the online auction is being conducted, whether the bidder has access to an immediate-purchase option; in response to determining that the bidder has access to the immediate-purchase option, provide one or more second user-interface elements on the bidder interface to enable the bidder to immediately purchase the asset for an immediate-purchase price prior to the auction close time expiring; in response to determining that a bid has been received on the asset being auctioned while the online auction is in progress and prior to the auction close time expiring, update the bidder interface in real-time to display a current highest bid; and in response to determining that a selection of the one or more second user-interface elements has been received to immediately purchase the asset prior to the auction close time expiring, update the bidder interface in real-time prior to the auction close time expiring to indicate that the auction has been closed prematurely.

In at least one example, the instructions further instruct the at least one processor to: monitor one or more asset-popularity metrics indicative of an amount of interest in the asset; and dynamically update the immediate-purchase price in real-time on the bidder interface while the online auction is in progress based on the one or more asset-popularity metrics. In at least one example, the one or more asset-popularity metrics include an amount of website traffic to the bidder interface for the asset. In at least one example, the one or more asset-popularity metrics include a number of bids placed on the asset. In at least one example, the one or more asset-popularity metrics include a frequency of bids placed on the asset.

In at least one example, the one or more asset-popularity metrics include an amount of time until the auction close time expires. In at least one example, the one or more asset-popularity metrics include whether the bidder has previously placed a bid on the asset during the online auction. In at least one example, dynamically updating the immediate-purchase price is executed within a lower bound and an upper bound of purchase prices. In at least one example, the instructions further instruct the at least one processor to extend the auction close time based on the one or more asset-popularity metrics.

In at least one example, the instructions further instruct the at least one processor to determine whether the bidder has access to the immediate-purchase option based on authenticating at least one of financial information, identity information, or closing documentation of the bidder. In at least one example, the financial information includes documentation indicating the bidder's ability to pay the immediate-purchase price. In at least one example, the documentation includes bank account information indicative of an amount of money currently held by the bidder in a bank account. In at least one example, the documentation includes loan information indicative of an amount of money available to the bidder as a pre-approved loan.

Examples of the disclosure include a method of providing a real-time dynamically adjusted user interface for an online auction, the method comprising: determining, for an asset being auctioned in the online auction, an auction close time at which the online auction will close; providing a bidder interface for a bidder, the bidder interface including one or more first user-interface elements to enable the bidder to place at least one bid on the asset being auctioned; determining, dynamically in real-time while the online auction is being conducted, whether the bidder has access to an immediate-purchase option; in response to determining that the bidder has access to the immediate-purchase option, providing one or more second user-interface elements on the bidder interface to enable the bidder to immediately purchase the asset for an immediate-purchase price prior to the auction close time expiring; in response to determining that a bid has been received on the asset being auctioned while the online auction is in progress and prior to the auction close time expiring, updating the bidder interface in real-time to display a current highest bid; and in response to determining that a selection of the one or more second user-interface elements has been received to immediately purchase the asset prior to the auction close time expiring, updating the bidder interface in real-time prior to the auction close time expiring to indicate that the auction has been closed prematurely.

In at least one example, the method includes monitoring one or more asset-popularity metrics indicative of an amount of interest in the asset; and dynamically updating the immediate-purchase price in real-time on the bidder interface while the online auction is in progress based on the one or more asset-popularity metrics. In at least one example, the one or more asset-popularity metrics include an amount of website traffic to the bidder interface for the asset. In at least one example, the one or more asset-popularity metrics include a number of bids placed on the asset. In at least one example, the one or more asset-popularity metrics include a frequency of bids placed on the asset. In at least one example, the one or more asset-popularity metrics include an amount of time until the auction close time expires. In at least one example, the one or more asset-popularity metrics include whether the bidder has previously placed a bid on the asset during the online auction.

### BRIEF DESCRIPTION OF THE DRAWINGS

Various aspects of at least one embodiment are discussed below with reference to the accompanying figures, which may not be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or substantially similar component that is illustrated in various figures may be represented by a like numeral. For purposes of clarity, not every component may be labeled in every figure. In the figures:

FIG. 1 illustrates a block diagram of a transaction system according to an example;

FIG. 2 illustrates a process of operating a buyer computing device according to an example;

FIG. 3 illustrates a process of operating a seller computing device according to an example;

FIG. 4 illustrates a process of operating computing devices to conduct a sale process according to an example;

FIG. 5 illustrates a process of determining and displaying an immediate-purchase option according to an example;

FIGS. 6-30 illustrate examples of screens which may be provided to buyers in a real-estate transaction;

FIGS. 31-55 illustrate examples of screens which may be provided to sellers in a real-estate transaction; and

FIGS. 56-71 illustrate examples of screens which may be provided to administrators in a real-estate transaction.

### DETAILED DESCRIPTION

Examples of the disclosure relate to dynamically managing online auctions, such as real estate auctions. Real estate transactions are often lengthy and complex. Many real estate transactions involve substantial amounts of documentation and legal due diligence to protect the parties' interests given the large sums of money involved. Buyers and sellers may be overwhelmed by the amount of documentation and legal due diligence involved, particularly because most individuals conduct very few real estate transactions in their lives and are therefore unfamiliar with such transactions.

Furthermore, buyers and/or sellers may abruptly cancel a transaction due to unexpected issues arising, such as one of the parties being unable to provide the required documentation before a transaction is finalized or being unable to secure a necessary loan. This may impose substantial hardship for the other party. For example, a buyer who submits an offer on an asset may need to wait an indeterminate amount of time for the seller to respond; the buyer is thus losing the opportunity to bid on other properties while waiting for the seller to respond. This may be particularly difficult for a buyer who, for example, must close on a real estate transaction before the buyer's lease expires or before the buyer closes on a separate transaction to sell a home that the buyer currently lives in. Existing solutions to conducting real estate transactions are therefore complex, confusing, and fraught with potential pitfalls for buyers and sellers alike.

Examples of the disclosure provide systems and methods for dynamically managing online auctions. In various examples, sellers may list properties for sale on a platform to be bid upon by one or more buyers. In the process of listing the property, the seller may provide all relevant documentation that may be required to close the transaction to the platform, such as the deed to the property, any relevant mortgage information, and so forth. The platform may verify the documentation such that, before the seller's property is ever listed, the platform has confirmed that all documentation that the seller needs to provide has been properly completed. Buyers may therefore place bids on properties knowing that the transaction is unlikely to be canceled due to unforeseen documentation issues.

Similarly, buyers may undergo a verification process prior to placing a bid. The platform may verify the identity of the buyer, such as by requiring that the buyer submit photo identification for review. In some examples, the platform may verify that the buyer has sufficient funds and/or has secured a loan to satisfy a particular bid or purchase offer before the buyer is allowed to submit the bid or purchase offer. In other examples, the platform may verify that the buyer has sufficient funds and/or has secured a loan to satisfy a particular bid or purchase offer after the buyer has been selected as a winning bid or purchase offer.

Examples in the disclosure provide systems and methods of preventing some or all relevant parties, at least a buyer and at least a seller, from missing something, failing to provide something, sharing an inapplicable or incorrect document, and so forth. For instance, if a seller fails to provide results of a plumbing inspection when appropriate, the platform may immediately notify the seller of the missing documents. In another example, if a buyer selects an incorrect option concerning a property acquisition, the platform may notify the buyer of the issue in real-time. Furthermore, the platform may also notify an administrative party of any issues that occur simultaneously. The platform may bring attention to the issue of the relevant party by sending a notification to a device associated with the platform, by making a phone call to a phone number associated with the relevant parties and reciting details concerning the issue, and so forth. The notification sent by the platform can be in the form of a push notification, a message on the platform, a SMS/RCE message, an email, a combination of the above, or some other way known to effectively notify. The platform may transmit the message over a network, including an intranet, the internet, a phone line, and so forth. The real-time communication of any relevant issues allows the platform to prevent the buyer or the seller from feeling overwhelmed by effectively organizing the many moving parts associated with a property sale.

In at least one example, an asset, such as real estate, may be listed for auction as well as immediate sale. For example, an asset may be listed for bidders to place bids on. In addition, an asset may be listed with an immediate-purchase price that enables a buyer to buy the property immediately and prematurely terminate the auction. In some examples, the immediate-purchase price may be a fixed price (for example, set by the seller). In other examples, the immediate-purchase price may vary based on asset-popularity metrics. Asset-popularity metrics may indicate how popular the asset is, that is, how much demand exists for the particular asset. If the asset-popularity metrics indicate that the asset is in high demand, then the immediate-purchase price may be increased to reflect the asset's popularity in the market. The platform may dynamically monitor the asset-popularity metrics and update the immediate-purchase price in real-time. By dynamically monitoring the metrics and updating the immediate-purchase price in real time, the platform is capable of responding in real-time to each small change in demand for an asset. Moreover, certain asset-popularity metrics may include metrics existing only in a computer environment, such as an amount of website traffic. Accordingly, examples of the disclosure provide improvements to online-auction technology that is specifically rooted in computer technology.

Current real-estate-sales systems may allow users to view or bid on real-estate assets, but may not allow pre-authenticated users to buy properties immediately. Such real-estate-sales systems may operate inefficiently, because delays or cancellations in a bid on a real-estate asset being accepted may have disastrous consequences for buyers and sellers alike. This is a technical problem. An exemplary embodiment of a real-estate-purchase platform discussed herein allows real-estate buyers to immediately purchase real-estate assets rather than (or as an alternative to) submitting a bid or offer. At least this foregoing combination of features comprises an asset-purchase system that serves as a technical solution to the foregoing technical problem. This technical solution is not routine and is unconventional. This technical solution is a practical application of the asset-purchase system design that solves the foregoing technical problem and constitutes an improvement in the technical field of asset-purchase transactions at least by entirely avoiding the uncertainty, delays, and potential for human error associated with placing a bid or offer.

Examples of the disclosure further improve on existing online auction technology. Current auction systems may allow users to submit bids on items, but may not allow bidders to both place bids and/or buy assets immediately. Such auction systems may operate inefficiently, because bidders who are particularly motivated to acquire a certain asset may not have an option to circumvent a long and arduous auction, and sellers who would be content to sell an asset immediately for a certain price may be forced to instead endure a lengthy, and potentially less profitable, auction. This is a technical problem. An exemplary embodiment of an online auction platform discussed herein allows real-estate buyers to immediately purchase real-estate assets rather than (or as an alternative to) submitting a bid or offer for an immediate-purchase price that may be dynamically updated in real-time based on one or more asset-popularity metrics. At least this foregoing combination of features comprises an auction system that serves as a technical solution to the foregoing technical problem. This technical solution is not routine and is unconventional. This technical solution is a practical application of the auction system design that solves the foregoing technical problem and constitutes an improvement in the technical field of online auctions at least by monitoring asset-popularity metrics in real-time and dynamically updating the immediate-purchase price to immediately reflect changes in estimated demand for the asset.

In various examples, this solution may be specifically rooted in computer technology at least because one or more asset-popularity metrics may be specific to a computer environment (for example, website-traffic data), and/or because dynamically updating the immediate-purchase price may be performed in real-time with changes in the asset-popularity metrics. Dynamically updating the immediate-purchase price in real-time with changes in the asset-popularity metrics may be critical in an online-auction environment in which even very minor delays in updating the immediate-purchase price may have unacceptable implications. For example, if asset-popularity metrics indicate a sudden, dramatic spike in demand for an asset, but a buyer purchases the asset for the immediate-purchase price before the seller (or selling platform) can update the immediate-purchase price to reflect the spike in demand, the seller may be forced to sell their asset for a dramatically lower price than the asset's actual value. Accordingly, dynamically updating the immediate-purchase price in real-time with changes in the asset-popularity metrics may be feasible online in a computerized environment and may provide substantial technical improvements to the field of auction technology.

Examples of the disclosure will be described with respect to a mobile application which may be executed at least in part by a personal electronic device, such as a smartphone. However, examples of the disclosure may be executed at least in part by other computing devices, such as laptop computers, desktop computers, cloud computers, tablets, and so forth, in addition to and/or in combination with smartphones. Accordingly, a platform as discussed herein may include one or more applications executed by one or more computing devices individually or in combination, and examples are provided with respect to a personal electronic device for purposes of example.

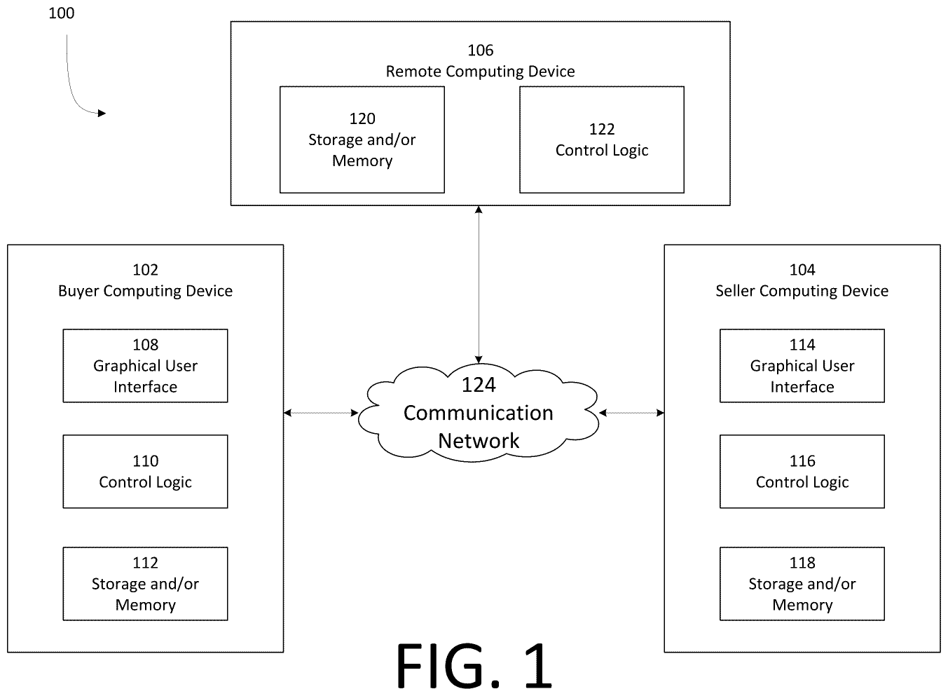

FIG. 1 illustrates a block diagram of a transaction system 100 according to an example. The transaction system 100 may represent a simplified example of a computerized system for conducting a transaction in which only a single computer device operated by a buyer and a single computer device operated by a seller are shown. In various examples, however, a given transaction may be conducted between many different computer devices operated by potential buyers, and any given potential buyer may use their respective computer device to perform transactions with many different sellers' computer devices. Moreover, buyers and sellers may each use multiple different computing devices; for example, a buyer or seller may perform parts of a transaction on a first computing device (for example, a smartphone), and parts of the transaction on a second computing device (for example, a laptop computer).

The transaction system 100 includes a buyer computing device 102, a seller computing device 104, and a remote computing device 106. The buyer computing device 102 and the seller computing device 104 may include computing devices operated by buyers and sellers, respectively, such as laptop computing devices, smartphones, desktop computing devices, tablets, and so forth. The remote computing device 106 may include a remote server device or other remote computing device.

The buyer computing device 102 includes a graphical user interface (GUI) 108, control logic 110, and storage and/or memory 112. Similarly, the seller computing device 104 includes a GUI 114, control logic 116, and storage and/or memory 118. The remote computing device 108 includes storage and/or memory 120 and control logic 122.

Each of the GUIs 108, 114 may include a display screen to provide output information to a respective user. In some examples, one or both of the GUIs 108, 114 may include a touchscreen configured to receive input information from a respective user. Each of the control logics 110, 116, 122 may include processing circuitry configured to execute computer instructions. In at least one example, the control logics 110, 116, 122 may each include one or more controllers and/or processors. The storages and/or memories 112, 118, 120 may each include one or more transitory and/or non-transitory computer-readable media. In at least one example, the storages and/or memories 112, 118, 120 may include non-transitory computer-readable media configured to store the computer-executable instructions to be executed by the control logics 110, 116, 122.

In various examples, the computing devices 102, 104, 106 may each be communicatively coupled to one other via a communication network 124. For example, the communication network 124 may include a wired and/or wireless network. Each of the computing devices 102, 104, 106 may include a communication interface, such as an antenna or wired-communication port, to enable the computing devices 102, 104, 106 to communicate with one another. In at least one example, the computing devices 102, 104, 106 are configured to communicate with one another in real- or near-real-time.

Collectively, the computing devices 102, 104, 106 enable users to execute an online transaction. In various examples discussed herein, an online transaction may include an online auction for assets such as real-estate assets. Accordingly, buyers may alternately be referred to as bidders. For purposes of explanation rather than limitation, examples are provided with respect to real-estate assets. In other examples, the computing devices 102, 104, 106 may be utilized to execute other online transactions.

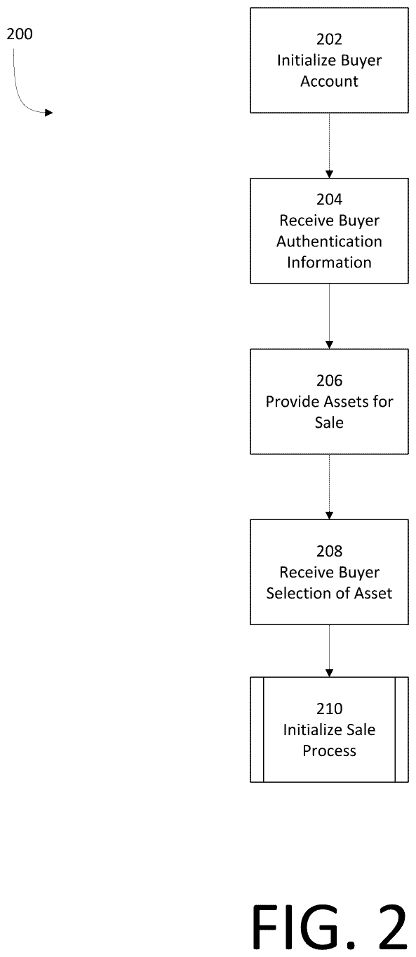

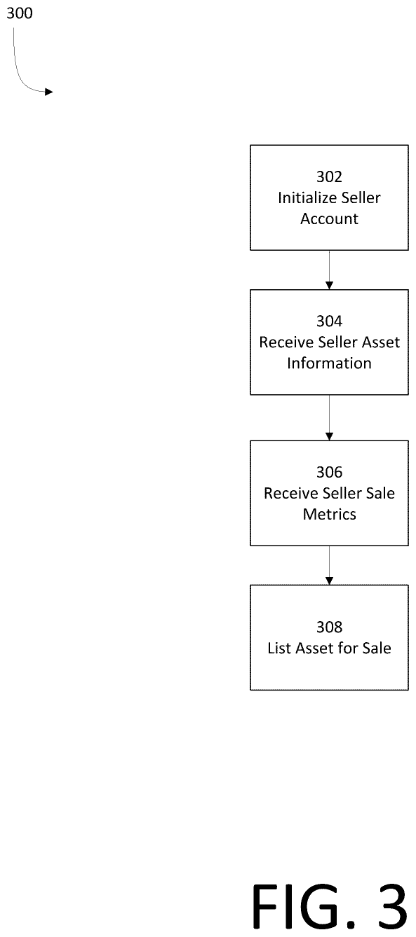

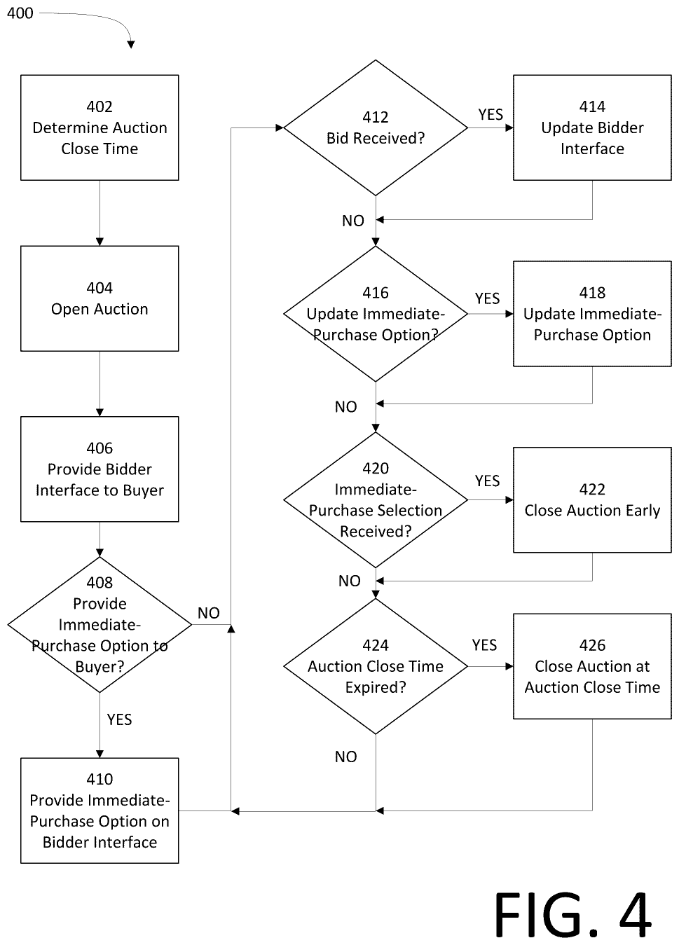

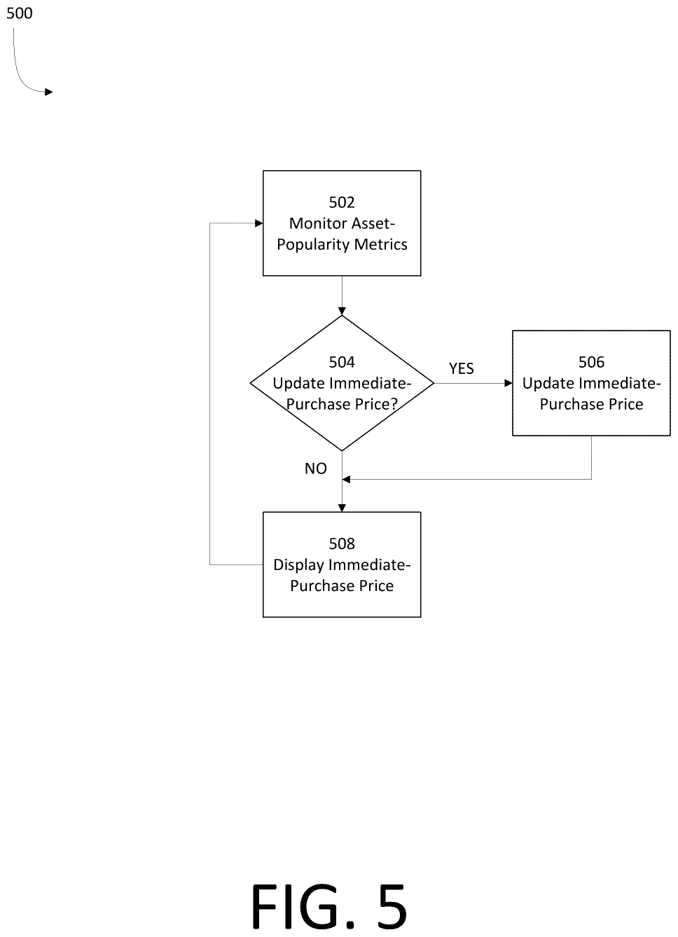

As discussed in greater detail below, FIGS. 2 and 3 provide processes of operating the buyer computing device 102 and seller computing device 104, respectively. FIG. 4 provides a process of executing an online auction. Although the sale process may be referred to as an auction, in various examples, buyers may have an option to circumvent a traditional bidding process by purchasing an asset immediately for a certain immediate-purchase price. As discussed in connection to FIG. 5, in some examples the immediate-purchase price may be dynamically updated in real-time based on one or more asset-popularity metrics.

FIG. 2 illustrates a process 200 of operating a buyer computing device according to an example. For example, the process 200 may provide an example of operating the buyer computing device 102. For purposes of example, the process 200 is described as beginning when a user initially begins using the buyer computing device 102 for an online transaction.

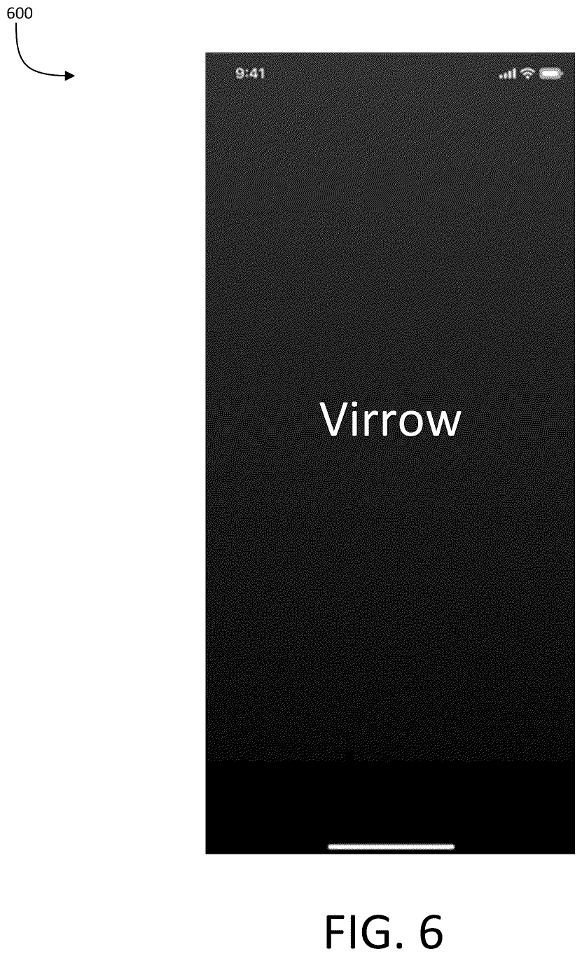

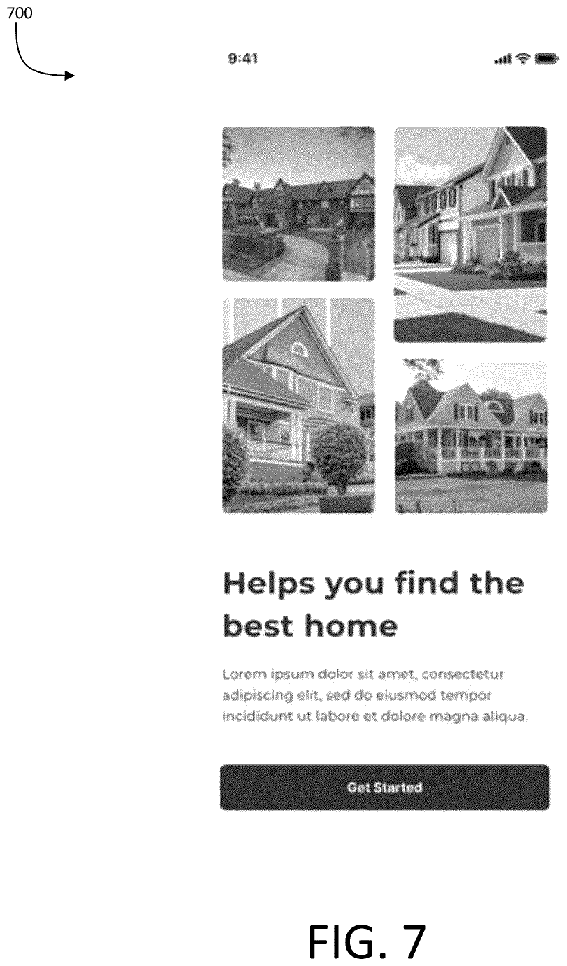

At act 202, the buyer computing device 102 initializes a buyer account. Initializing a buyer account may include the control logic 110 controlling the GUI 108 to display a splash screen. For example, FIG. 6 illustrates an example splash screen 600 displayed by the buyer computing device 102 on the GUI 108. This serves as the first screen users will see upon launching the application. The control logic 110 may then control the GUI 108 to display a start-up screen. FIG. 7 illustrates an example of a start-up screen 700 displayed by the buyer computing device 102 on the GUI 108. The start-up screen 700 may provide comprehensive guidance on how buyers can utilize the application to purchase a home.

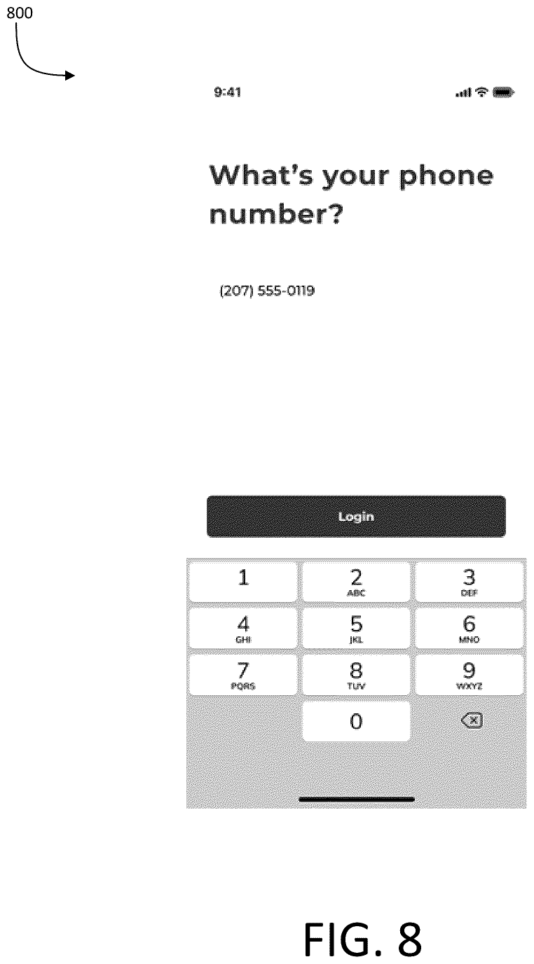

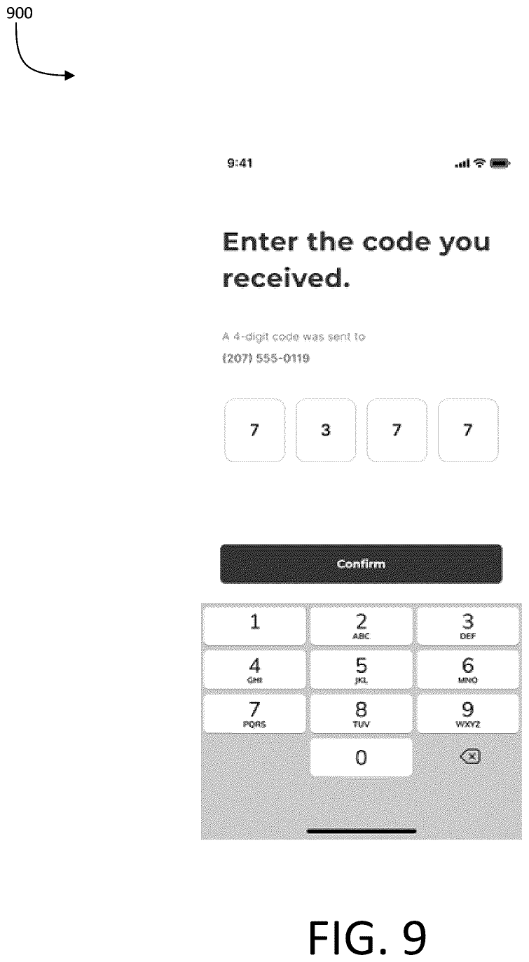

After the buyer computing device 102 receives a user selection of a “Getting Started” button on the start-up screen 700, the control logic 110 may control the GUI 108 to display screens to input and verify the buyer's phone number. FIG. 8 illustrates an example of a phone-number-entry screen 800 through which a buyer enters their phone number. Responsive to receiving the buyer's phone number, the control logic 110 may control the buyer computing device 102 to send a one-time code to the entered phone number. For example, the one-time code may be a four-time one-time password. The control logic 110 may then control the GUI 108 to display a screen to verify the buyer's phone number. FIG. 9 illustrates an example of a code-entry screen 900 through which a buyer enters the code sent to their phone number.

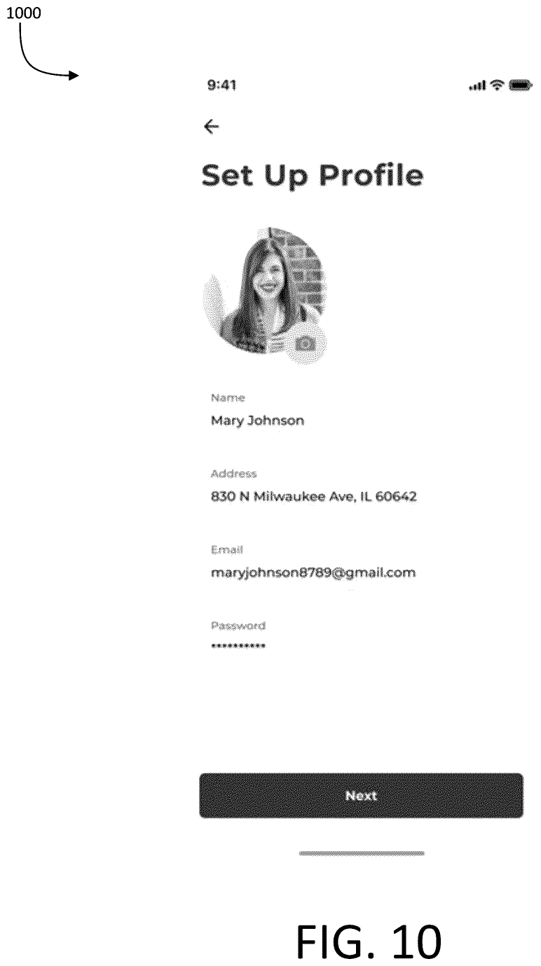

Upon verification of the buyer computing device 102 by entering the one-time code, the control logic 100 may control the GUI 108 to display an account-information-setup screen. FIG. 10 illustrates an example of an account-information-setup screen 1000 through which a buyer enters personal account information. Such personal account information may include, for example, the buyer's name, mailing address, email address, and account password. The buyer's account may then be initialized.

At act 204, the buyer computing device 102 receives buyer authentication information. Buyer authentication information may include at least one of financial information or identity information of the buyer. Financial information may include, for example, bank-account information indicative of an amount of money currently available to the buyer in a bank account. The bank-account information may include, for example, documentation provided by the buyer's bank attesting to the amount of money held in the bank account. In another example, the financial information may include loan documentation indicative of an amount of money for a loan that the buyer is pre-approved for. In other examples, the financial information may include any other documentation that a buyer might use to prove that the buyer can immediately satisfy a purchase for up to a certain amount of money. The buyer computing device 102 may control the GUI 108 to display fields or links that enable a buyer to upload financial documentation or images thereof.

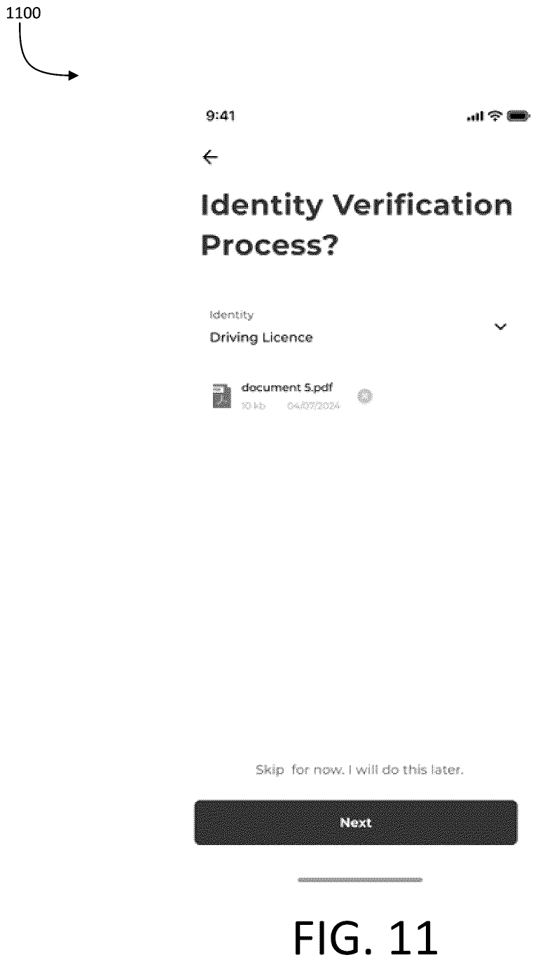

Identity information may include documentation that proves the buyer's identity. Identity information may include, for example, a birth certificate, a driver's license, or another form of identification of the buyer. The buyer computing device 102 may control the GUI 108 to display fields or links that enable a buyer to upload financial documentation or images thereof. FIG. 11 illustrates an authentication-information-upload screen 1100 that the GUI 108 may display to enable a buyer to upload identity documentation such as a driver's license or a birth certificate, and the GUI 108 may display a similar screen to enable a buyer to upload financial documentation. In some examples, the buyer computing device 102 may enable buyers to skip providing authentication information during the initial account setup; in various examples, however, the buyer may not be able to place bids or make purchases before undergoing the authentication process.

In various examples, the buyer computing device 102 may authenticate the buyer authentication information. For example, the control logic 110 may execute one or more software processes, such as by executing a machine-vision process, to analyze and verify the authentication information. In at least one example, the control logic 110 may execute one or more machine-learning-based algorithms to adapt over time to providing enhanced authentication results. In various examples, the control logic 110 may communicate the authentication information to the remote computing device 106 via the communication network 124, and the control logic 122 may execute one or more software processes, such as by executing a machine-vision process, to analyze and verify the authentication information. In still other examples, authentication information may be manually reviewed in addition to, or in lieu of, the computing device 102 and/or 106 automatically authenticating the authentication information.

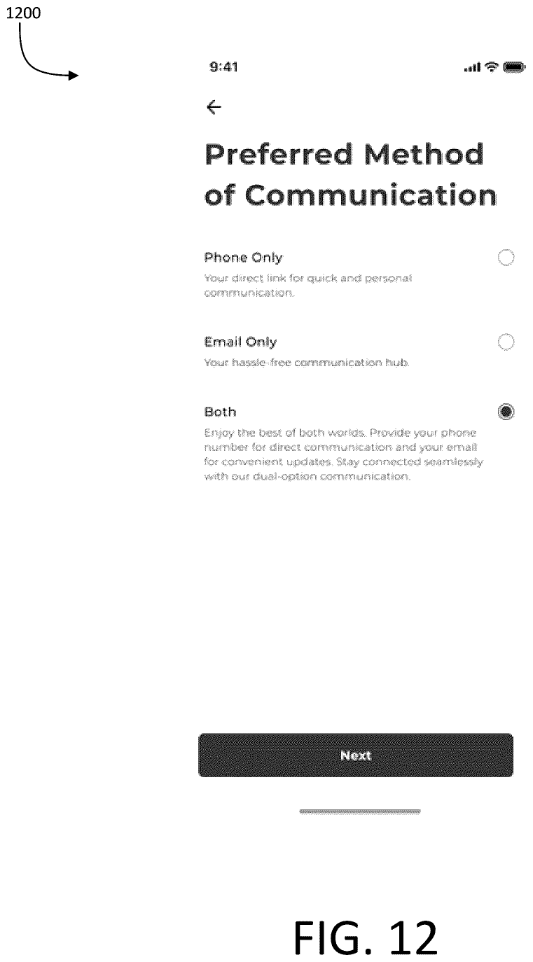

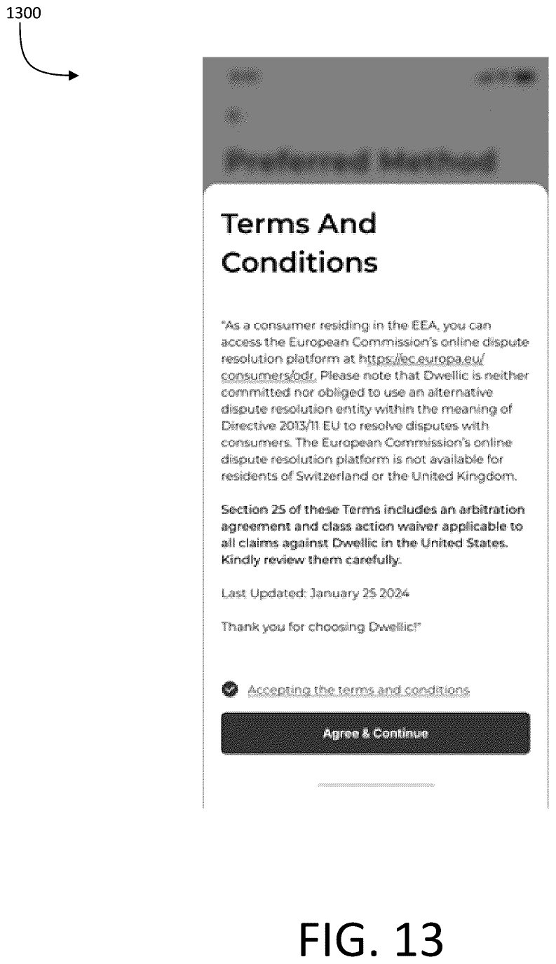

The buyer computing device 102 may then prompt a buyer to select a preferred method of communication, and then prompt the buyer to review and accept terms and conditions. For example, FIG. 12 illustrates an example of a communication-preference screen 1200 that the control logic 110 may control the GUI 108 to display for a user to select a preferred communication medium (for example, phone call, text, email, and so forth). FIG. 13 illustrates an example of a terms-and-conditions screen 1300 that the control logic 110 may control the GUI 108 to display for a user to review and accept terms and conditions.

At act 206, the buyer computing device 102 may provide a buyer with one or more assets for sale. For example, the control logic 110 may control the GUI 108 to display a list of one or more assets, such as real-estate assets, currently for sale. The control logic 110 may receive listing information indicative of the list of one or more assets from the remote computing device 106 via the communication network 124. The remote computing device 106 may store the listing information in the storage and/or memory 120, and may continuously update the listing information in real-time as assets are newly listed for sale or newly taken off the market.

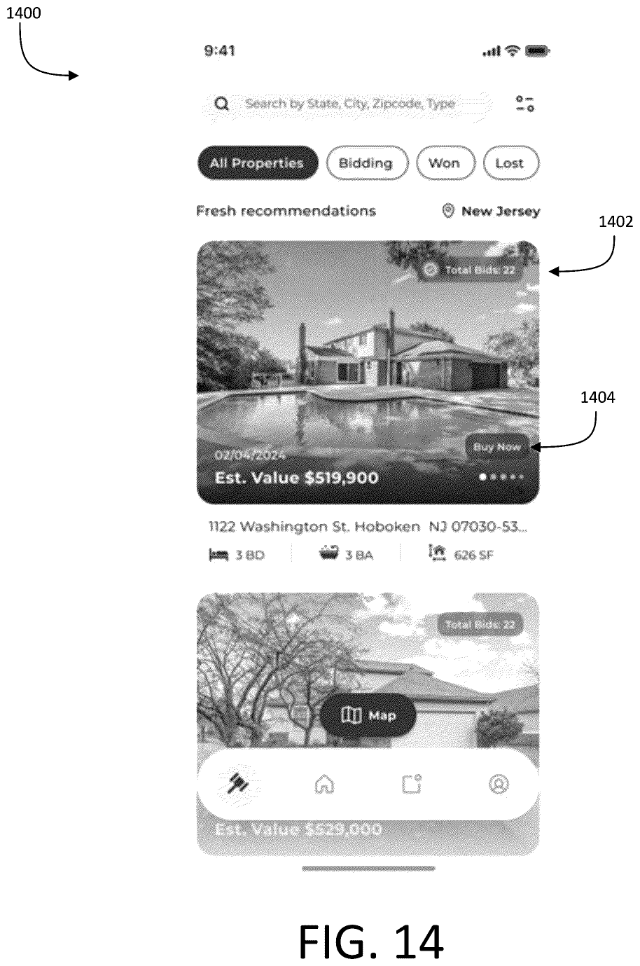

FIG. 14 illustrates a listing screen 1400 depicting listing information that the control logic 110 may control the GUI 108 to display. The listing screen 1400 includes a search bar for a buyer to enter search information (for example, a geographical region, a type of asset, and so forth) to control which assets are displayed. Each asset in the listing information is displayed with an asset section 1402 that provides information about the asset, such as (using a real-estate asset as an example), an image of the asset, a total number of bids placed on the asset, an end date and/or time for the auction, an estimated value of the asset, an address of the asset, asset specifications, a number of bedrooms, a number of bathrooms, square footage, a location map, a verified tick mark if the asset has been verified as discussed below, and/or a “Buy Now” button 1404 that enables the buyer to immediately purchase the asset.

At act 208, the buyer computing device 102 may receive a buyer selection of an asset listing. A buyer may interact with the asset section 1404 for a given asset to access additional information about the selected asset listing and to place a bid to purchase a selected asset. For example, the buyer may click on the “Buy Now” button 1404 to access additional information about the asset listing and to potentially submit a bid or purchase offer to the seller.

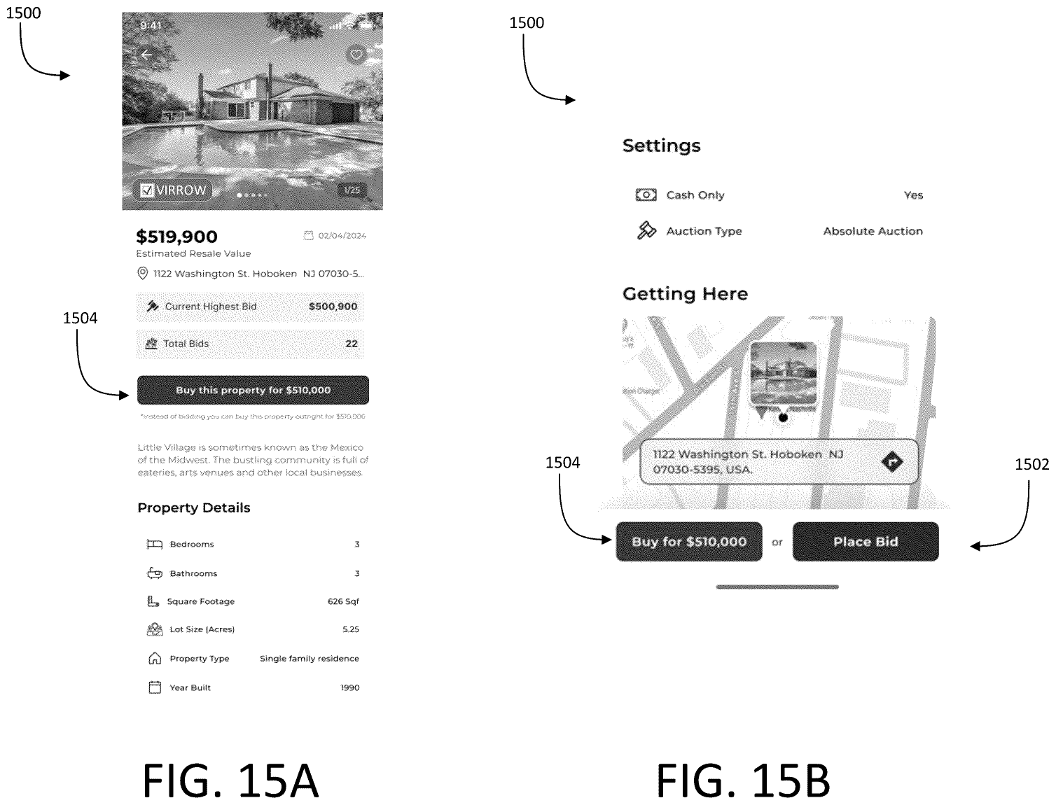

FIGS. 15A and 15B illustrate a bidder-interface screen 1500 which the control logic 110 may control the GUI 108 to display responsive to a user selection of the “Buy Now” button 1404. FIGS. 15A and 15B may illustrate a top section and a bottom section, respectively, of the bidder-interface screen 1500. Although the bidder-interface screen 1500 may be displayed as a continuous vertical screen in various examples, for clarity of illustrate, the bidder-interface screen 1500 has been separated into two images.

The bidder-interface screen 1500 may also be referred to as an absolute-auction screen because the seller has listed the asset for sale under an absolute auction scheme. Under an absolute auction scheme, the buyer may place an auction bid on the asset from the screen 1500 by interacting with a place-bid button 1502, and no minimum reserve price has been set for the asset. The buyer may alternatively buy the asset outright by submitting a defined immediate-purchase price which is higher than the current highest bid, but which may circumvent the auction and secure the property for the buyer. The buyer computing device 102 may register the buyer submitting an immediate-purchase price by determining that the buyer has interacted with immediate-purchase buttons 1504.

The bidder-interface screen 1500 provides additional information about the asset, such as an estimated resale value of the asset, an address of the asset, a current highest bid (if any) on the asset, a total number of bids (if any) on the asset, asset details (such as a number of bedrooms, a number of bathrooms, a square footage, a lot size, a property type, a year of construction, and so forth), asset-sale settings (such as whether the asset is listed for sale for cash only and an auction type), a map view that shows the asset's location and enables a buyer to interact with a directions button to receive directions to the asset, and so forth.

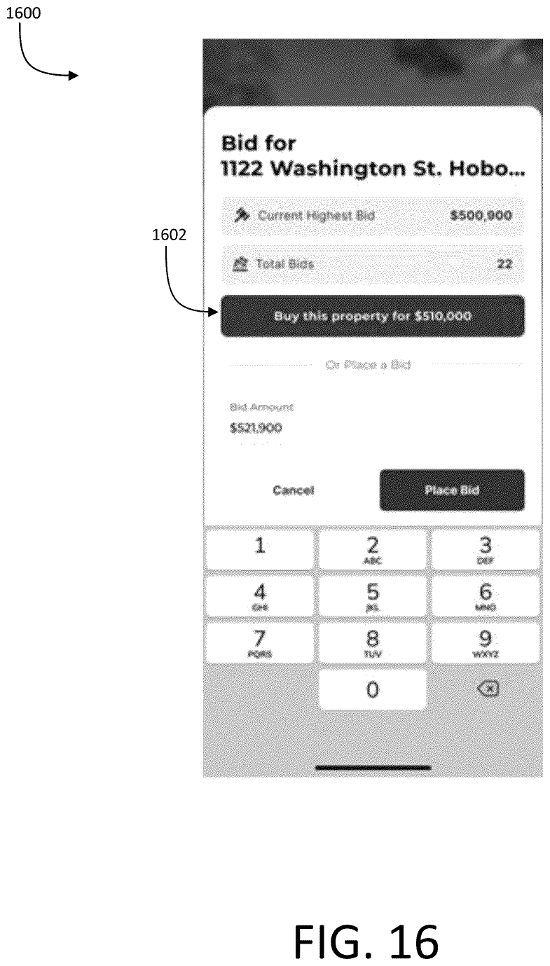

If a buyer selects the place-bid button 1502, the control logic 110 may control the GUI 108 to display a bid-placement screen. FIG. 16 illustrates an example of a bid-placement screen 1600 that enables a buyer to place a bid on a selected asset. The bid-placement screen 1600 may provide bid information such as identifying information about the asset (for example, an address of the asset), a current highest bid, a total number of bids, and so forth. The bid-placement screen 1600 may also include a field to enable a buyer to input a bid to place. The bid-placement screen 1600 may also include a “Buy Now” button 1602 to enable a buyer to immediately purchase the asset for a defined immediate-purchase price.

At act 210, the buyer computing device 102 may begin or enter an asset sale process. For example, the buyer computing device 102 may begin or enter the asset sale process responsive to receiving a bid or immediate-purchase selection from a buyer. Examples of performing a sale process, through bidding and/or immediately purchasing, are discussed in greater detail below with respect to FIG. 4. A description of the buyer's perspective of engaging in a sale process immediately follows, and a more detailed discussion of a sale process is subsequently provided with respect to FIG. 4.

Returning to the listing screen 1400, a buyer may navigate between all listed properties, all properties that the buyer has bid on, all properties that the buyer has successfully purchased, and all properties that the buyer submitted a bid for but did not win, by selecting a respective option on a list of filtering options. For example, if the buyer selects the “Bidding” option of the filtering options, the control logic 110 may control the GUI 108 to display a bidding-listing screen.

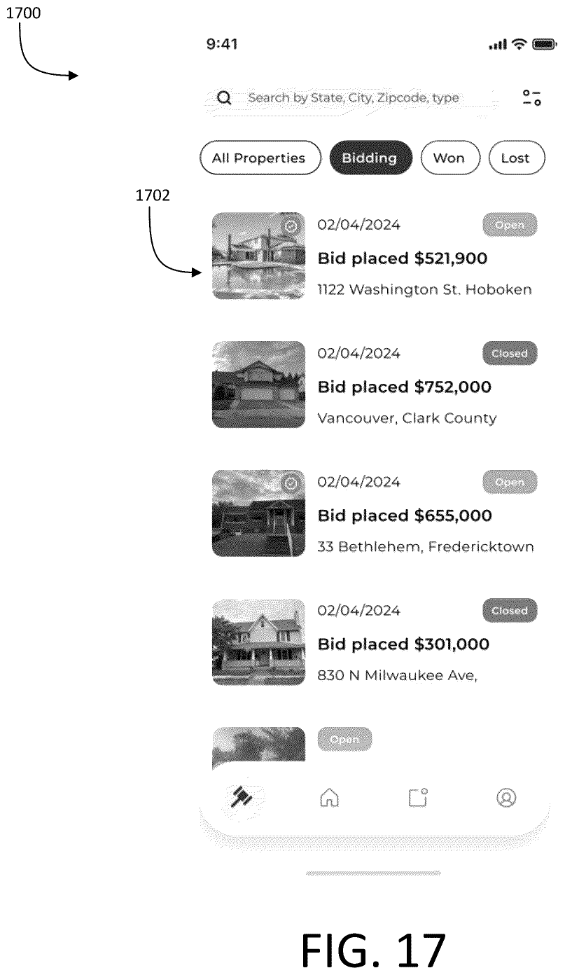

FIG. 17 illustrates a bidding-listing screen 1700 according to an example. The bidding-listing screen 1700 displays information about assets that the buyer has placed bids on, whether the bid was successful, unsuccessful, or has not yet closed. Each asset listing may display information such as a bid placed amount, a bid end date, a property image, a property address, a status of the bid (for example, “Open” if the auction has not yet closed or “Closed” if the auction has closed), and so forth. A buyer may interact with any of the asset listings to access additional information about a given bid, in response to which the control logic 110 may control the GUI 108 to display a bidding-information screen. For example, a buyer may interact with a first listing 1702 to display additional information about the corresponding asset.

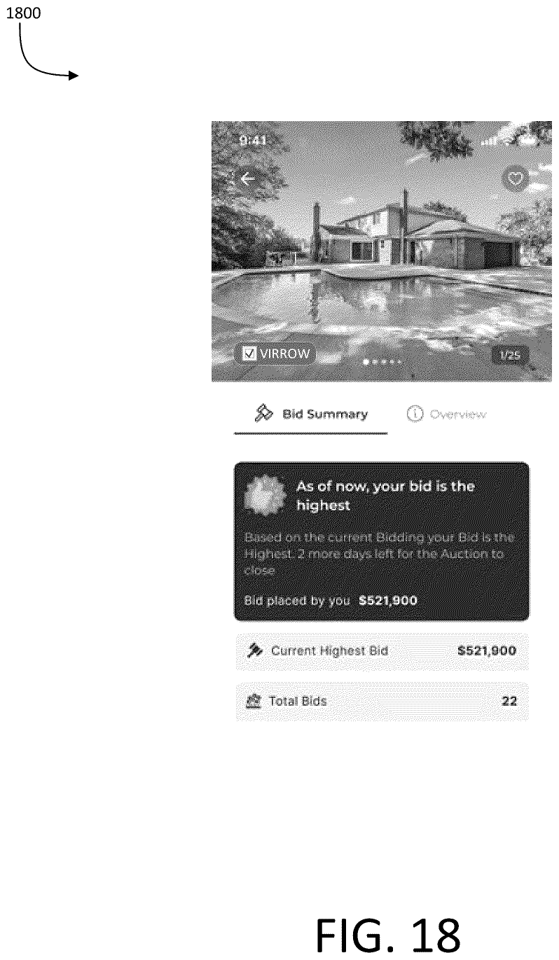

FIG. 18 illustrates a bidding-information screen 1800 according to an example in which the buyer has placed the bid that is currently the highest. The bidding-information screen 1800 displays additional information about an asset that the buyer has placed a currently winning bid on. The additional information may include, for example, a summary of the buyer's bid (for example, a number of days left in the auction and an amount of the bid), a current highest bid, and a total number of bids. For example, as shown in the bidding-information screen 1800, the buyer has placed a $521,900 bid which is current the highest bid.

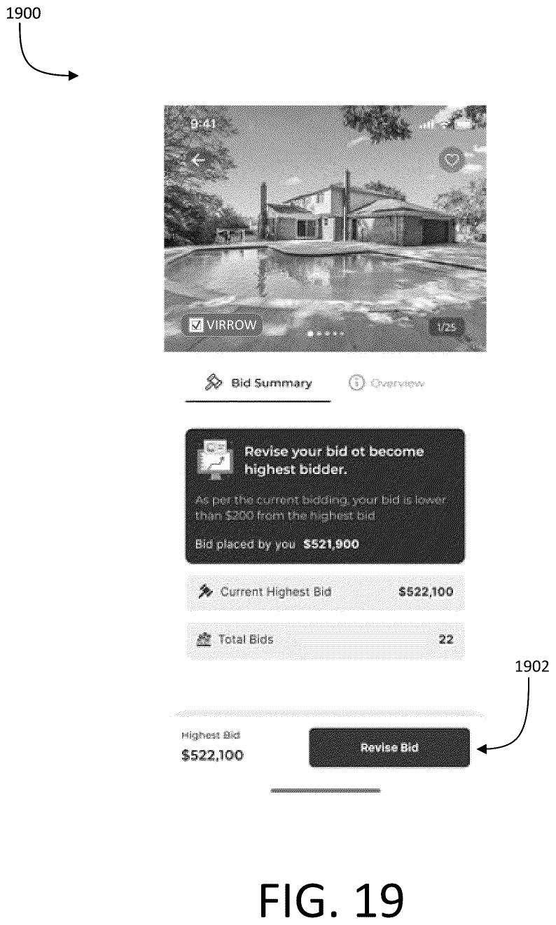

FIG. 19 illustrates a bidding-information screen 1900 according to an example in which the buyer has placed the bid that is not currently the highest. The bidding-information screen 1900 is thus similar to the bidding information screen 1800, but displays additional information about an asset that the buyer has placed a currently losing bid on. The additional information may include, for example, a summary of the buyer's bid (for example, a number of days left in the auction and an amount of the bid), a current highest bid, and a total number of bids. For example, as shown in the bidding-information screen 1900, the buyer has placed a $521,900 bid but the highest bid is a $522,100 bid. The bidding-information screen 1900 thus includes a revise-bid button 1902 to enable a buyer to increase their bid. A buyer may interact with the revise-bid button 1902, in response to which the control logic 110 may control the GUI 108 to display a revise-bid screen.

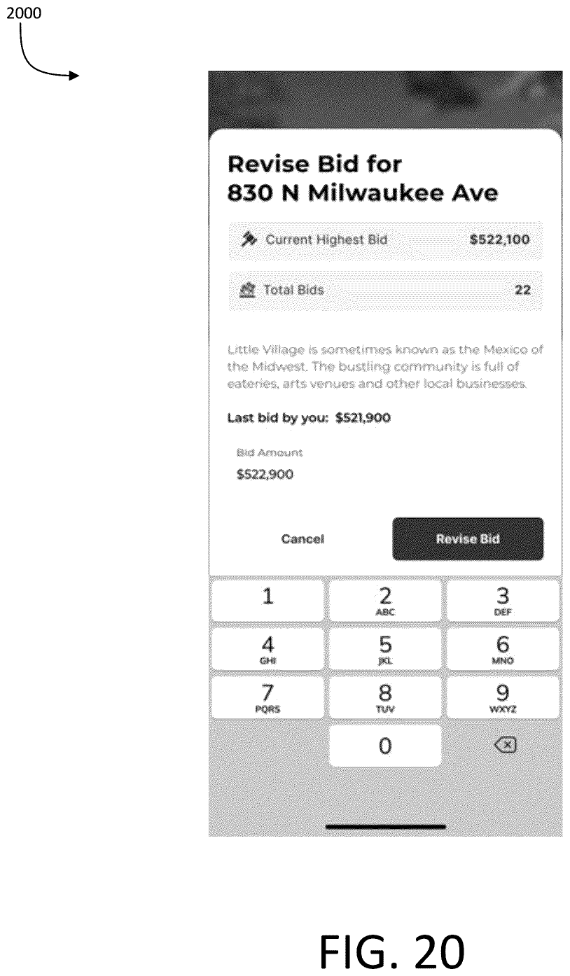

FIG. 20 illustrates a revise-bid screen 2000 according to an example. The revise-bid screen 2000 displays information about a current highest bid and a total number of bids, and enables a buyer to submit a revised bid. The revise-bid screen 2000 displays information such as identifying information about the asset (for example, property address information), a description of the asset, a last bid amount by the buyer, and so forth. Upon the buyer submitting a revised bid, the buyer computing device 102 may display a bidding-listing screen similar to the bidding-listing screen 1700 but showing the revised bid. For example, the control logic 110 may control the GUI 108 to display a revised-listing screen responsive to a buyer revising their bid.

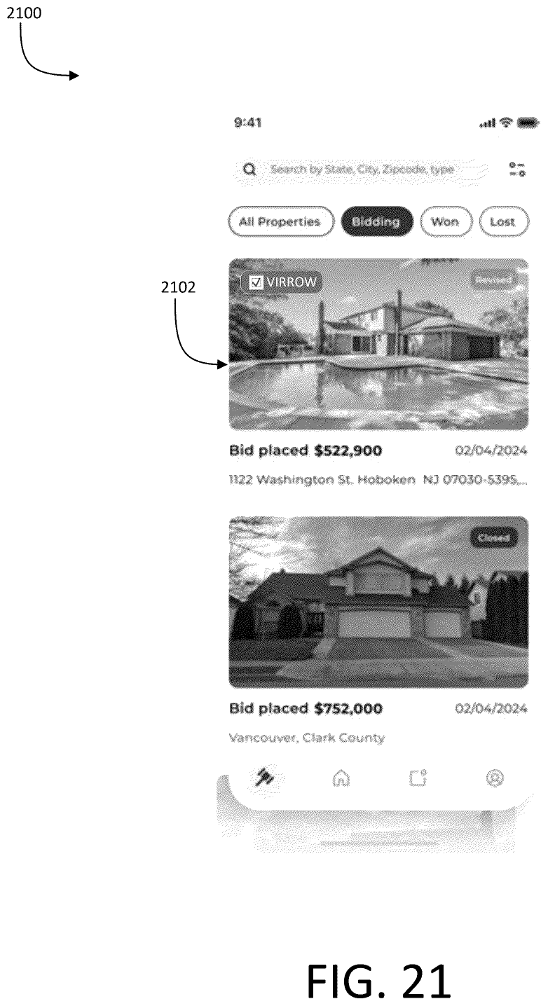

FIG. 21 illustrates a revised-listing screen 2100 according to an example. The revised-listing screen 2100 is similar to the bidding-listing screen 1700. However, the revised-listing screen 2100 includes a revised listing 2102 that captures the revised bid submitted by the buyer via the revise-bid screen 2000 for $522,900.

In some examples, revised bids may not be automatically accepted. The platform and/or the seller may determine whether to allow the bid to be revised. Accordingly, a listing tagged as “revised” may include a listing for a property for which a bid revision is pending. If the revision is approved, the tag may be updated to “approved” on a bidding-listing screen. In these examples, the control logic 110 may control the GUI 108 to display an approved-revised-listing screen responsive to the revised bid being accepted.

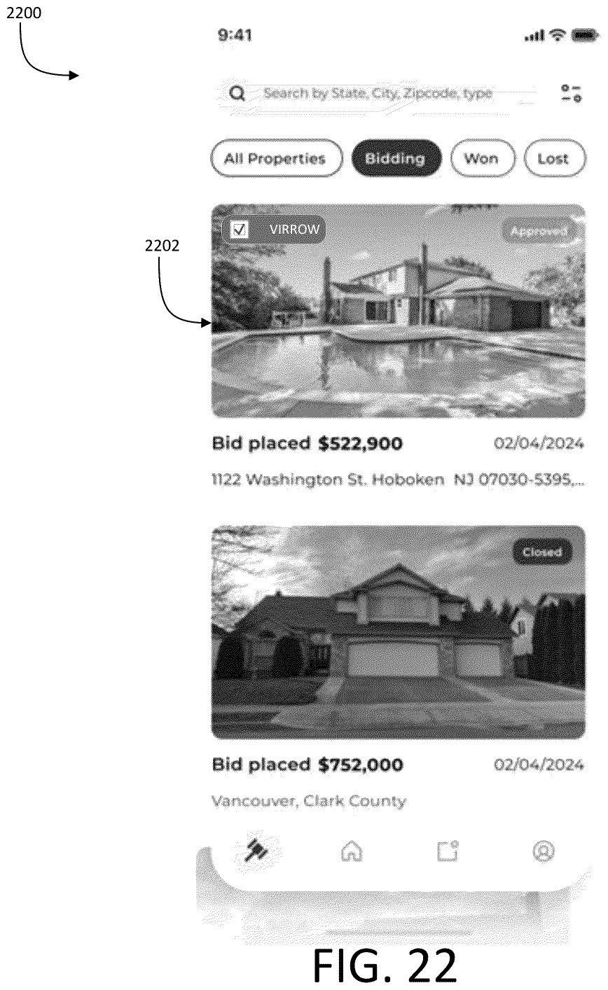

FIG. 22 illustrates an approved-revised-listing screen 2200 according to an example. The approved-revised-listing screen 2200 is similar to the revised-listing screen 2100. However, the approved-revised-listing screen 2200 includes an approved-revised listing 2202 that indicates that the revised bid has been accepted. If a buyer successfully wins an auction, such as by having submitted the highest bid, the buyer may access a bid-processing screen to complete the transaction for the property that the buyer has successfully bid upon. The control logic 110 may control the GUI 108 to display a transaction-closing process responsive to the buyer winning the auction.

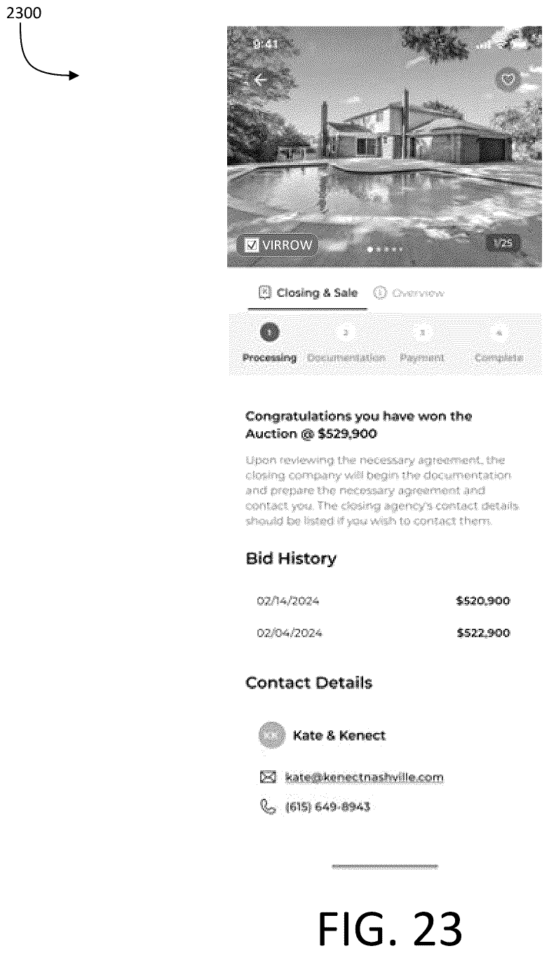

FIG. 23 illustrates a processing screen 2300 for a transaction-closing process according to an example. The control logic 110 may control the GUI 108 to display the processing screen 2300 responsive to the buyer winning the auction. The processing screen 2300 may display transaction information such as summary information about the final transaction, past bid information, and contact details for the seller (or the seller's agents, such as a closing company). After reviewing the transaction information, the buyer may continue to a bid-documentation screen of the transaction-closing process.

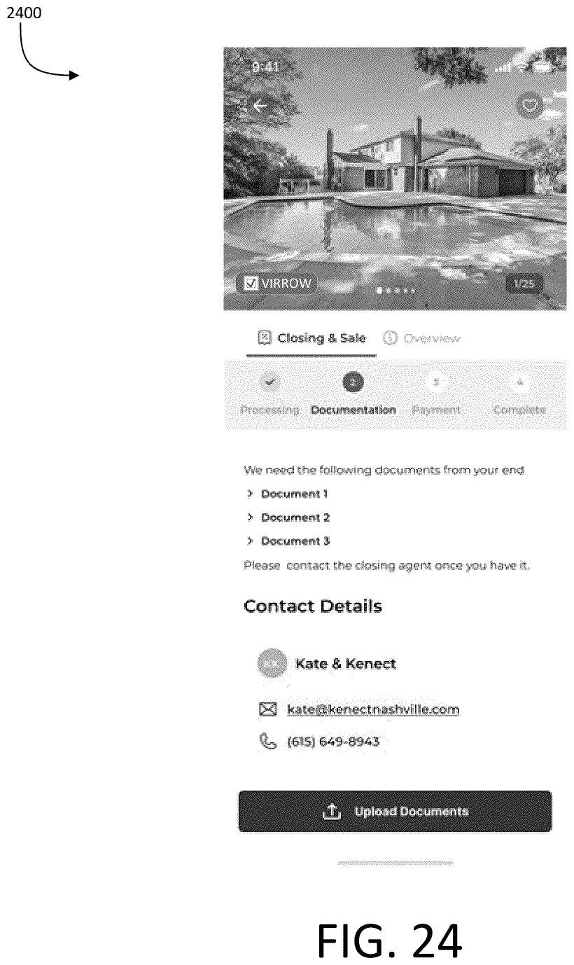

FIG. 24 illustrates a bid-documentation screen 2400 for a transaction-closing process according to an example. The control logic 110 may control the GUI 108 to display the bid-documentation screen 2400 responsive to the buyer reviewing the transaction information. The bid-documentation screen 2400 may display information such as a summary of documentation required from the buyer and the contact information for the seller or seller's agent. The documentation required may be the same or different than the authentication information received at act 204. For example, the documentation required may include a current statement of the buyer's financial information (whereas the authentication information received at act 204 may include several-days-old financial information). In other examples, the documentation required may be the same as the authentication information received at act 204 and the buyer may simply re-upload the same documentation on the bid-documentation screen 2400. After the buyer completes uploading the bid documentation, the control logic 110 may control the GUI 108 to display a bid-payment screen.

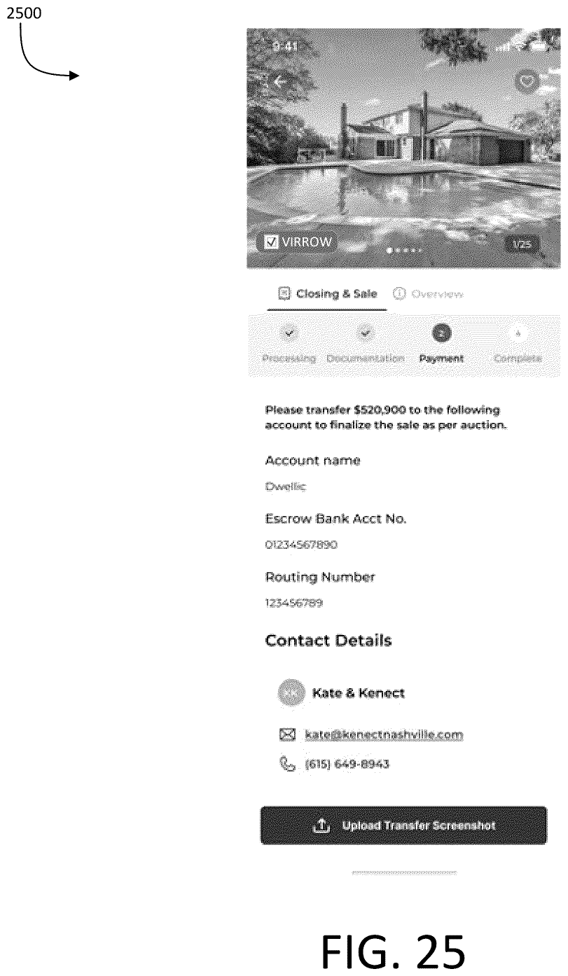

FIG. 25 illustrates a bid-payment screen 2500 for a transaction-closing process according to an example. The control logic 110 may control the GUI 108 to display the bid-payment screen 2500 responsive to the buyer submitting the bid documentation. The bid-payment screen 2500 may display the seller's payment information for the buyer to submit payment to, such as an account name, an escrow bank account number, and a routing number. In some examples, the bid-payment screen 2500 may include, display, or link to a portal that enables the buyer to pay the seller directly through the bid-payment screen 2500. In other examples, the buyer may pay the seller through a separate portal, and subsequently upload, via the bid-payment screen 2500, proof of the payment having been sent (for example, a screenshot showing confirmation of the payment. After the buyer completes the payment process, the control logic 110 may control the GUI 108 to display a bid-completion screen.

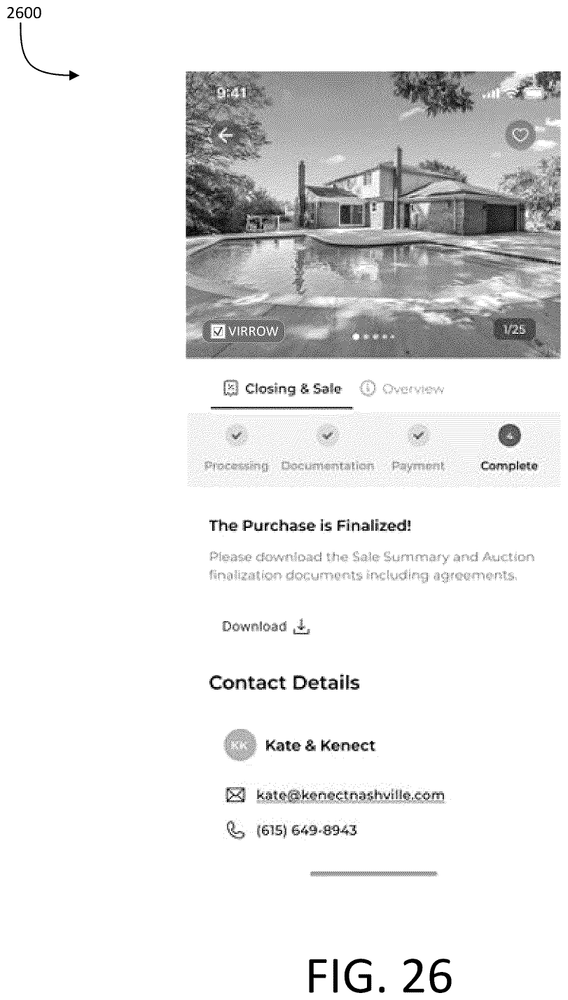

FIG. 26 illustrates a bid-completion screen 2600 for a transaction-closing process according to an example. The control logic 110 may control the GUI 108 to display the bid-completion screen 2600 responsive to the buyer submitting the bid payment. The bid-completion screen 2600 may display final summary information of the transaction, and may enable the buyer to download documentation summarizing the transaction.

In various examples, the auctions discussed above may include absolute auctions, that is, auctions without a minimum reserve price. In other examples, sellers may put properties up for a minimum auction with a reserve price. Selecting a property that is put up for minimum auction may cause the control logic 110 to control the GUI 108 to display a minimum-auction screen about the property that differs slightly from the bidder-interface screen 1500 of FIGS. 15A and 15B.

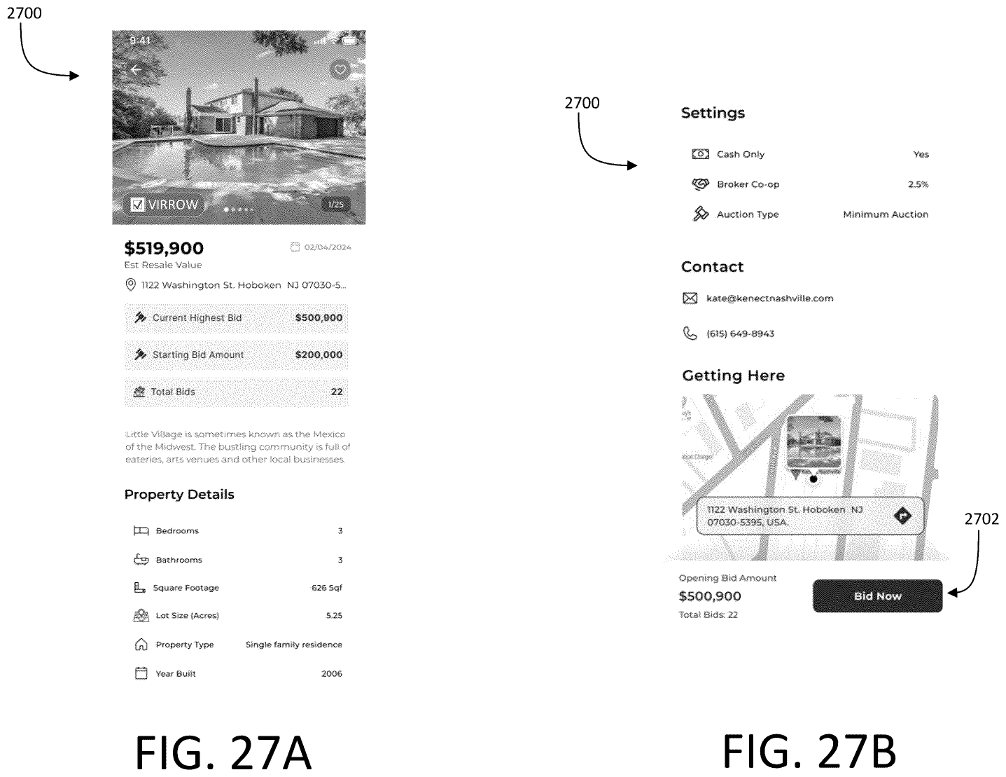

FIGS. 27A and 27B illustrate a bidder-interface screen 2700 according to an example. FIGS. 27A and 27B may illustrate a top section and a bottom section, respectively, of the bidder-interface screen 2700. Although the bidder-interface screen 2700 may be displayed as a continuous vertical screen in various examples, for clarity of illustrate, the bidder-interface screen 2700 has been separated into two images.

The bidder-interface screen 2700 may be referred to as a minimum-auction screen because the seller has listed the asset for sale under a minimum auction scheme. Under a minimum auction scheme, the buyer may place an auction bid on the asset from the screen 2700 by interacting with a place-bid button 2702, but a minimum bid price has been set for the asset. The buyer may also lack the option to buy the asset outright by submitting a defined immediate-purchase price which is higher than the current highest bid.

The bidder-interface screen 2700 provides additional information about the asset, such as an estimated resale value of the asset, an address of the asset, a current highest bid (if any) on the asset, a total number of bids (if any) on the asset, asset details (such as a number of bedrooms, a number of bathrooms, a square footage, a lot size, a property type, a year of construction, and so forth), asset-sale settings (such as whether the asset is listed for sale for cash only and an auction type), a map view that shows the asset's location and enables a buyer to interact with a directions button to receive directions to the asset, and so forth. If a buyer interacts with the place-bid button 2702, the control logic 110 may control the GUI 108 to display a bid-placement screen for a minimum auction.

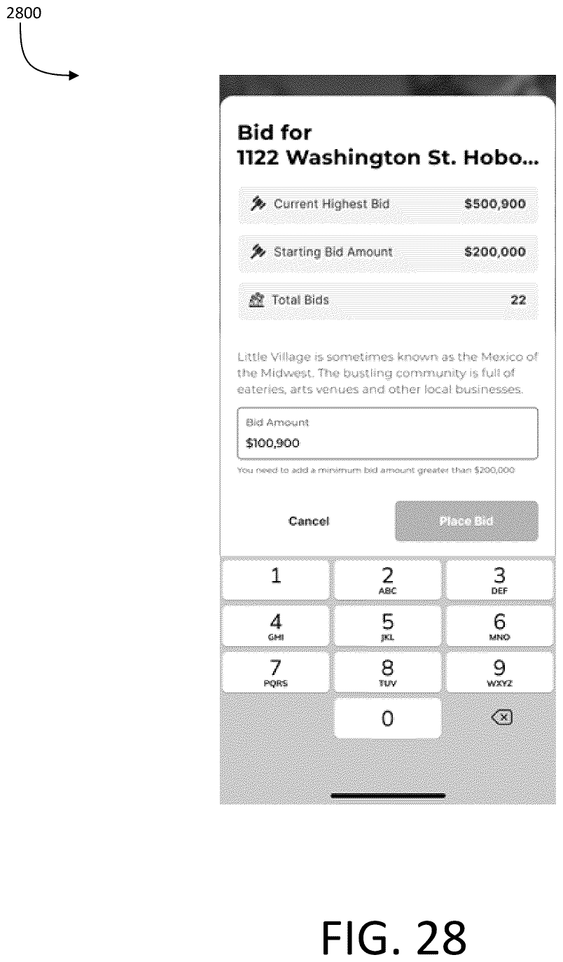

FIG. 28 illustrates a bid-placement screen 2800 for a minimum auction according to an example. The control logic 110 may control the GUI 208 to display the bid-placement screen 2800 responsive to the buyer interacting with the place-bid button 2702. The bid-placement screen 2800 enables a buyer to submit a bid, and includes information such as identifying information for the asset (for example, an address of the asset), a current highest bid, a starting bid amount, a total number of bids, and so forth. Because the minimum auction has a minimum bid displayed by the starting bid amount, a buyer will be warned that they must submit a bid greater than the minimum bid amount if the buyer attempts to submit a bid lower than the starting bid amount.

Accordingly, examples of the disclosure therefore offer absolute auctions and minimum auctions. In some examples, reserve auctions may also be supported, that is, auctions for which a seller may accept or reject a winning bid. Selecting a property that is put up for reserve auction may yield a reserve-auction screen about the property that differs slightly from the bidder-interface screen 1500 of FIGS. 15A and 15B or the bidder-interface screen 2700 of FIGS. 27A and 27B. If a buyer interacts with a property listing for an asset associated with a reserve auction, the control logic 110 may control the GUI 108 to display a reserve-auction screen.

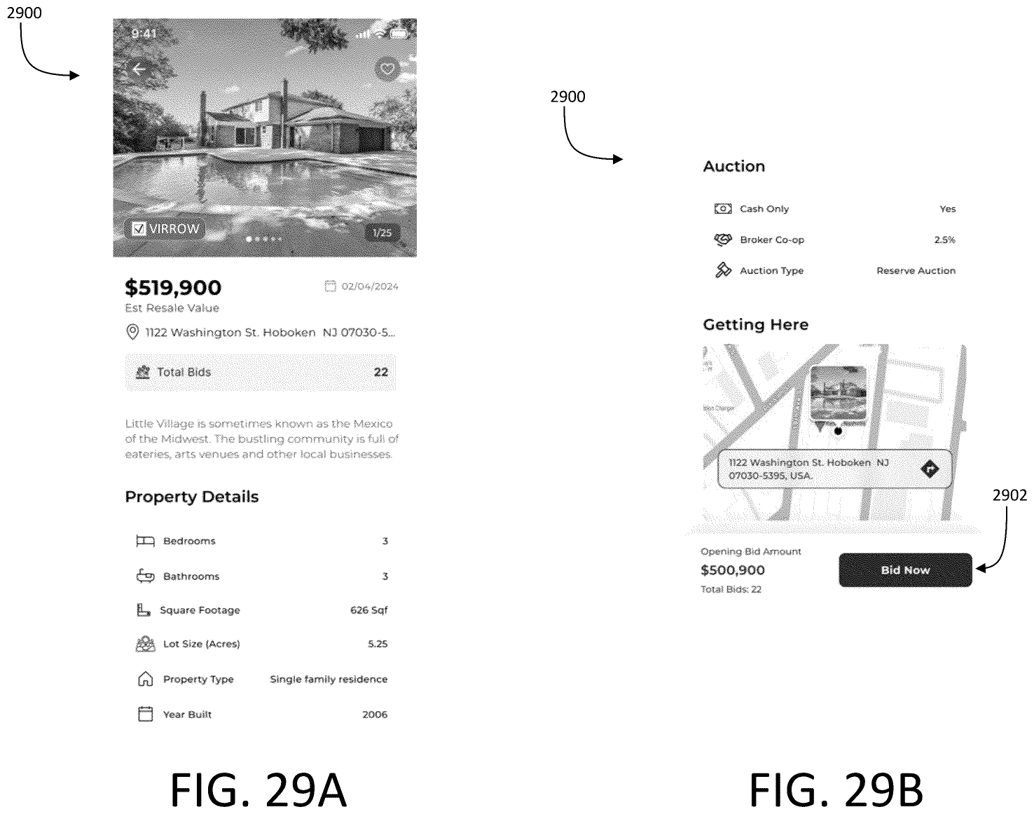

FIGS. 29A and 29B illustrate a bidder-interface screen 2900 according to an example. FIGS. 29A and 29B may illustrate a top section and a bottom section, respectively, of the bidder-interface screen 2900. Although the bidder-interface screen 2900 may be displayed as a continuous vertical screen in various examples, for clarity of illustrate, the bidder-interface screen 2900 has been separated into two images.

The bidder-interface screen 2900 may be referred to as a reserve-auction screen because the seller has listed the asset for sale with a reserve-price scheme. Under a reserve-price scheme, the buyer may place an auction bid on the asset from the screen 2900 by interacting with a place-bid button 2902, but a minimum reserve price has been set for the asset.

The bidder-interface screen 2900 provides additional information about the asset, such as an estimated resale value of the asset, an address of the asset, a current highest bid (if any) on the asset, a total number of bids (if any) on the asset, asset details (such as a number of bedrooms, a number of bathrooms, a square footage, a lot size, a property type, a year of construction, and so forth), asset-sale settings (such as whether the asset is listed for sale for cash only and an auction type), a map view that shows the asset's location and enables a buyer to interact with a directions button to receive directions to the asset, and so forth. If a buyer interacts with the place-bid button 2902, the control logic 110 may control the GUI 108 to display a bid-placement screen for a reserve auction.

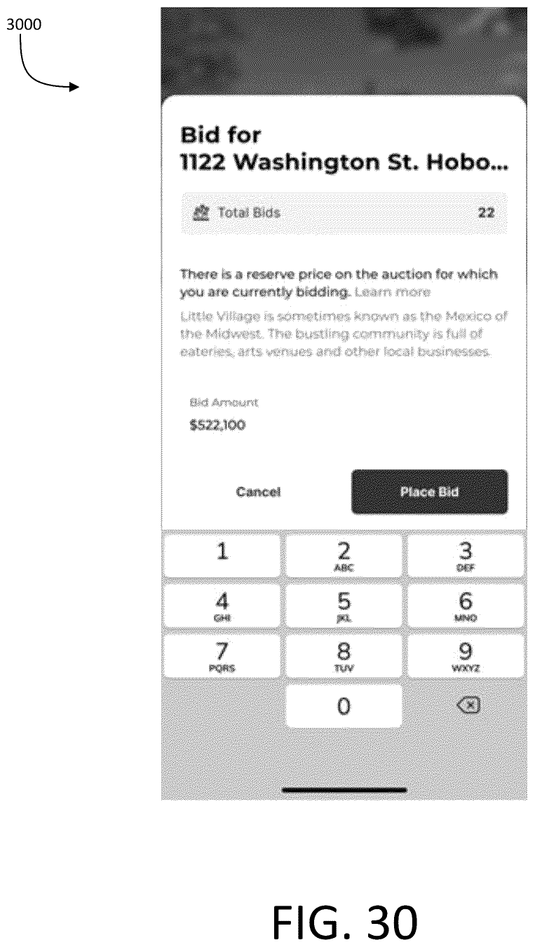

FIG. 30 illustrates a bid-placement screen 3000 for a reserve auction according to an example. The control logic 110 may control the GUI 208 to display the bid-placement screen 3000 responsive to the buyer interacting with the place-bid button 2902. The bid-placement screen 3000 enables a buyer to submit a bid, and includes information such as identifying information for the asset (for example, an address of the asset), a total number of bids, and so forth. Because the reserve auction has a reserve price, the sale will not be consummated unless a bid equal to or greater than the reserve price is submitted. In various examples, the reserve price may be secret from a buyer; accordingly, buyers may be incentivized to submit a higher bid to at least meet the reserve price.

Accordingly, buyers may set up a user account and search listed properties to place bids on in absolute auctions, minimum auctions, and reserve auctions. As discussed above, buyers may also purchase properties outright in some examples for a set price. In some examples, the immediate-purchase price may be selected by a seller listing the property. In other examples, the platform may automatically dynamically determine an optimal immediate-purchase price based at least in part on bid activity on the property, as discussed in greater detail below.

Sellers may undergo an account-setup process that is substantially similar or identical to the account-setup process of the buyer in some respects. FIG. 3 illustrates a process 300 of operating a seller computing device according to an example. For example, the process 300 may provide an example of operating the seller computing device 104. For purposes of example, the process 300 is described as beginning when a user initially begins using the seller computing device 104 for an online transaction.

At act 302, the seller computing device 104 initializes a seller account. Act 302 may be substantially similar to act 202, albeit with respect to a seller rather than a buyer. Accordingly, the control logic 116 may control the GUI 114 at act 302. The control logic 116 may control the GUI 114 to display screens substantially similar or identical to the screens 600-1300 of FIGS. 6-13, although the screen 1100 may only request identifying information (rather than financial information) from a seller.

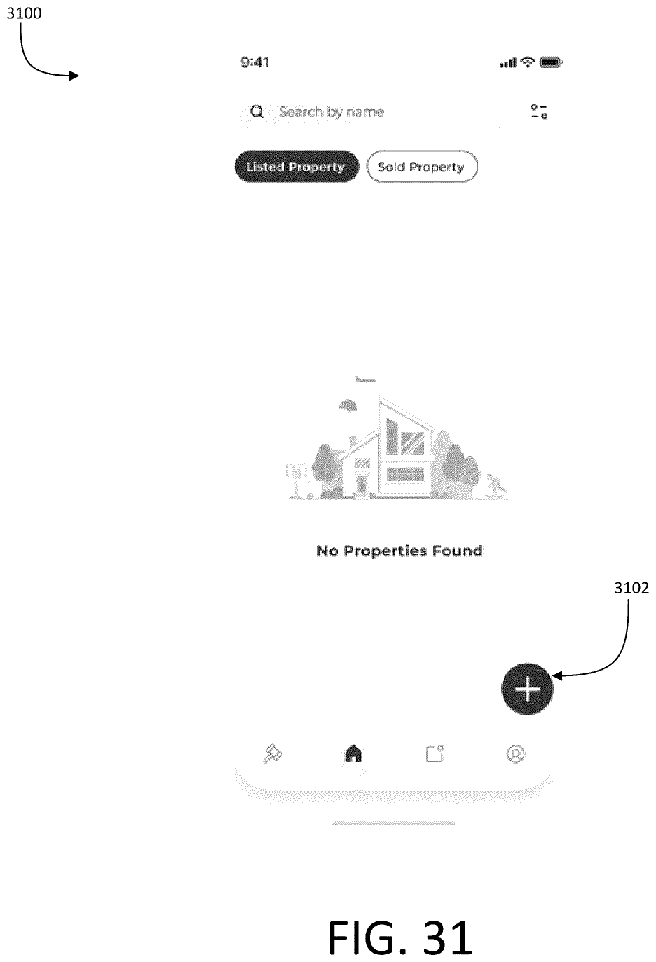

After the seller's account is initialized, the control logic 116 may control the GUI 114 to display a default listing screen. For example, FIG. 31 illustrates a default listing screen 3100 according to an example. The default listing screen 3100 may illustrate properties that the seller has listed for sale or already sold. Because the seller has just initialized an account, no properties may be listed. However, the seller may interact with an add-property button 3102 to add asset information for the property.

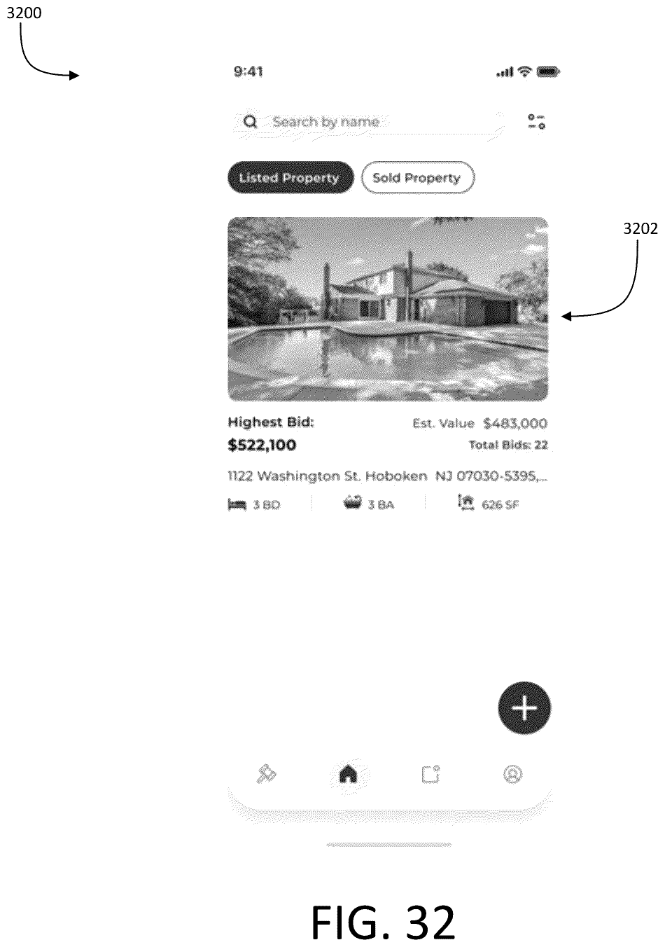

At act 304, the seller computing device 104 receives asset information from the seller for an asset. Once the asset information is collected, the control logic 116 may control the GUI 114 to display the asset listing. For example, FIG. 32 illustrates an updated asset-listing screen 3200 which is similar to the default listing screen 3100, but which includes a listing 3202 for an asset. After the seller inputs all of the details for the asset, details of which are discussed below, the listing 3202 displays those details. Responsive to a seller selecting the add-property button 3102, the control logic 116 may control the GUI 114 to display a terms-and-conditions screen.

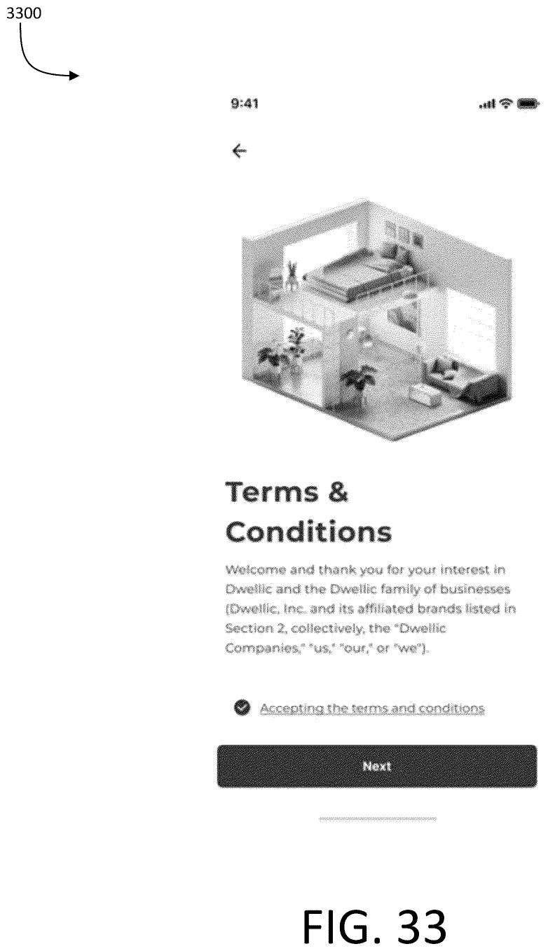

FIG. 33 illustrates a terms-and-conditions screen 3300 according to an example. The control logic 116 may control the GUI 114 to display the terms-and-conditions screen 3300 responsive to receiving a user selection of the add-property button 3102. The terms-and-conditions screen 3300 allows a seller to review and accept terms and conditions. Once a seller has accepted the terms and conditions, the control logic 116 may determine whether the seller has previously provided all necessary authentication information, such as identifying information. If the control logic 116 determines that the seller has not provided all necessary authentication information, then the control logic 116 may control the GUI 114 to display a complete-identification-process screen. If the control logic 116 determines that the seller has provided all necessary authentication information, then the control logic 116 may control the GUI 114 to display an address-entry screen.

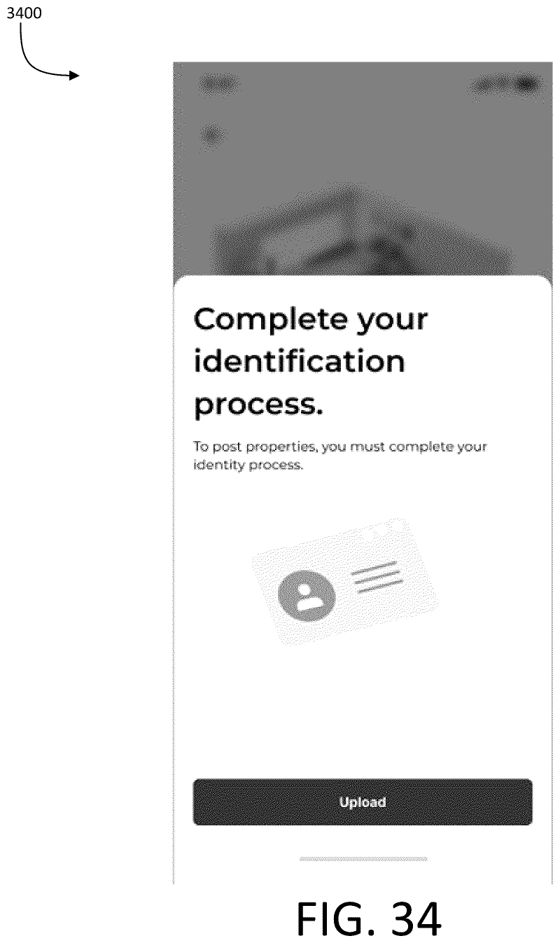

FIG. 34 illustrates a complete-identification-process screen 3400 according to an example. The control logic 116 may control the GUI 114 to display the complete-identification-process screen 3400 responsive to determining that a seller has not yet provided all necessary identifying information. The complete-identification-process screen 3400 informs a user that identifying information is necessary to list a property, and prompts a user to upload the identifying information. The control logic 116 then controls the GUI 114 to display an authentication-information-upload screen.

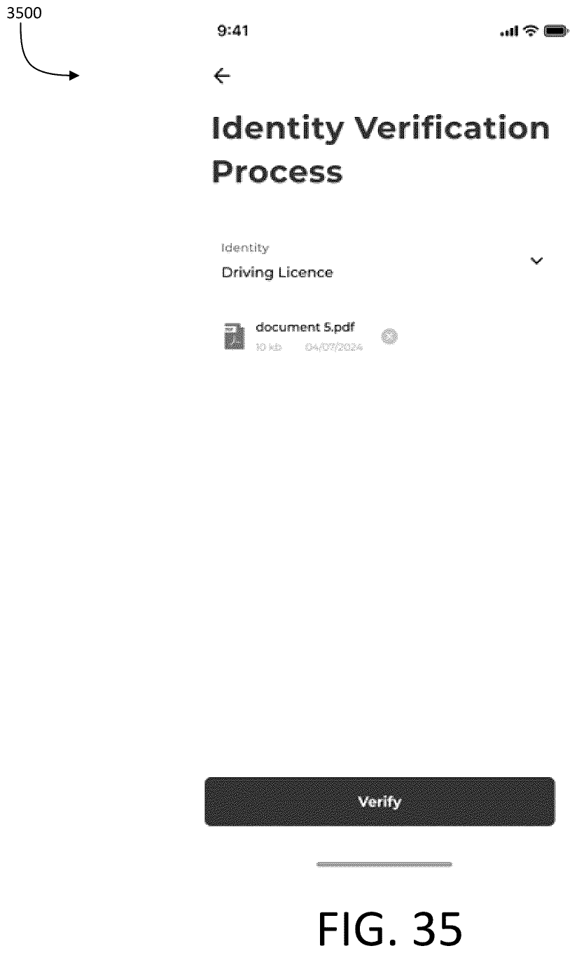

FIG. 35 illustrates an authentication-information-upload screen 3500 according to an example. The control logic 116 may control the GUI 114 to display the authentication-information-upload screen 3500 to enable the seller to upload identity documentation such as a driver's license or a birth certificate. In various examples, the authentication-information-upload screen 3500, and the associated automated and/or manual authentication process, may be substantially similar or identical to the authentication-information-upload screen 1100. Once a user has provided the authentication information, the control logic 116 may control the GUI 114 to display an address-entry screen.

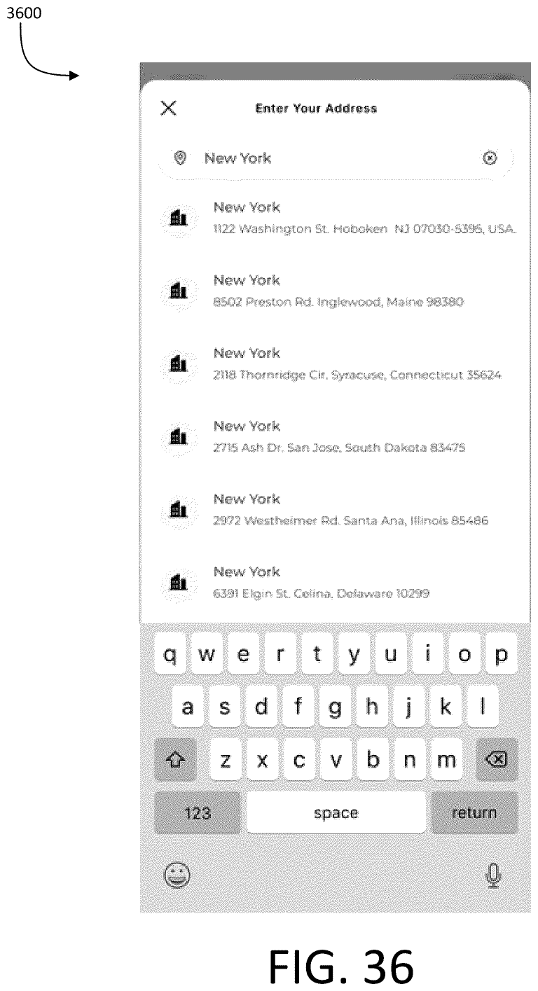

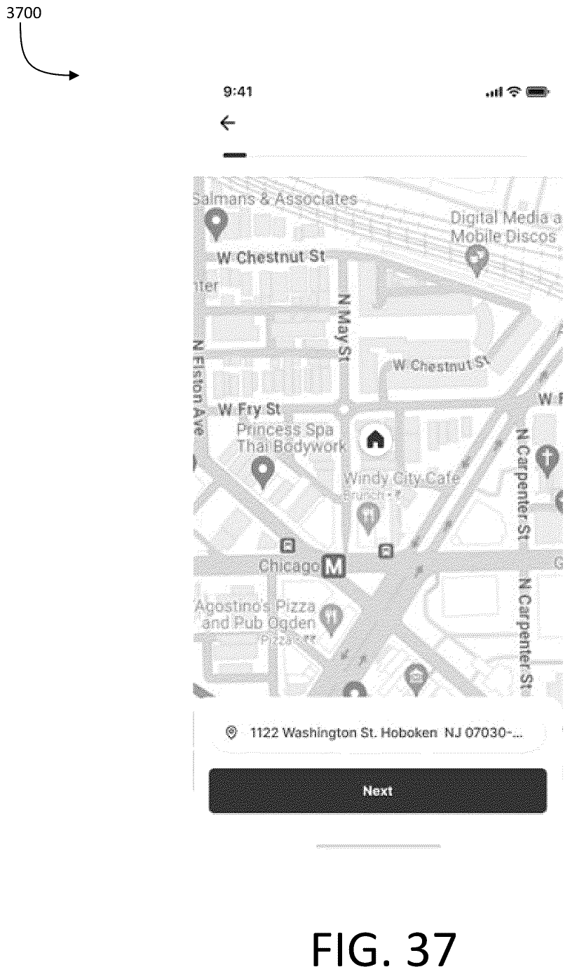

FIG. 36 illustrates an address-entry screen 3600 according to an example. The control logic 116 may control the GUI 114 to display the address-entry screen 3600 responsive to determining that the seller's identity has been verified (for example, subsequent to showing either the screen 3300 if the seller was previously authenticated or the screen 3500 if the seller was not previously authenticated). The address-entry screen 3600 enables a seller to input the address of the asset that the seller is listing for sale. In some examples, the control logic 116 may control the GUI 114 to display a map depicting a location of an entered address. For example, FIG. 37 illustrates a map screen 3700 according to an example, which the control logic 116 may control the GUI 114 to display responsive to the seller entering an address. Once the seller has entered the address information, the control logic 116 may control the GUI 114 to display a property-details-entry screen.

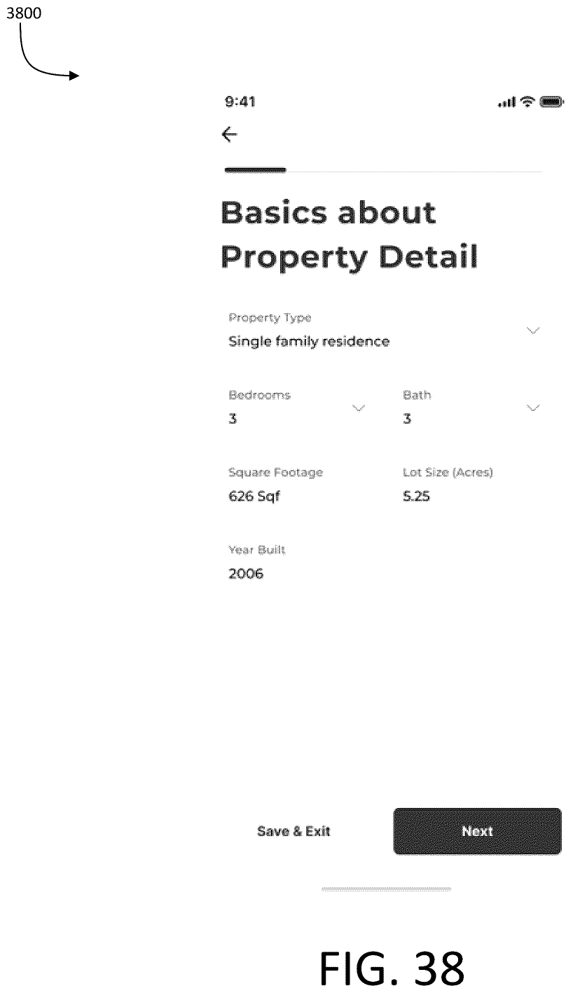

FIG. 38 illustrates a property-details-entry screen 3800 according to an example. The control logic 116 may control the GUI 114 to display the property-details-entry screen 3800 responsive to the seller entering the address information. The property-details-entry screen 3800 enables a seller to select various fields to enter information about the asset, such as a property type, a number of bedrooms, a number of bathrooms, a square footage, a lot size, and a year of construction.

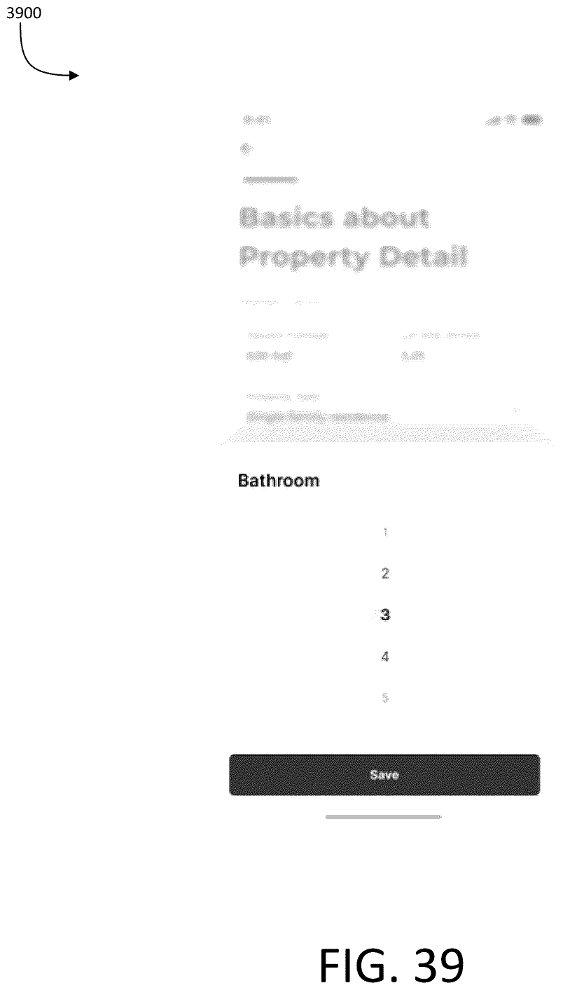

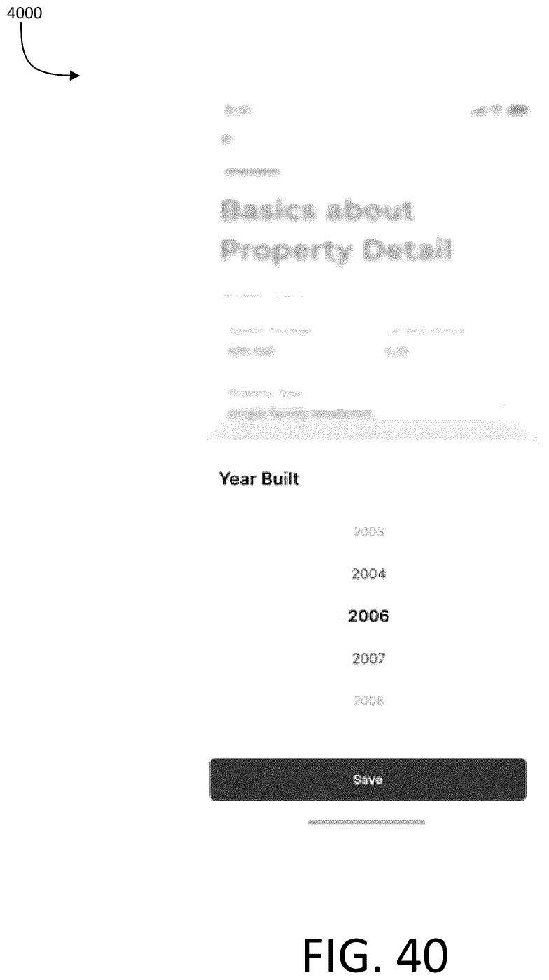

For example, if the seller selects the field to enter the number of bathrooms, the control logic 116 may control the GUI 114 to display a bathroom-entry screen. FIG. 39 illustrates an example of a bathroom-entry screen 3900, which the GUI 114 may display to enable a seller to input a number of bathrooms in the property. If the seller selects the field to enter the year of construction, the control logic 116 may control the GUI 114 to display a construction-year-entry screen. FIG. 40 illustrates an example of a construction-year-entry screen 4000, which the GUI 114 may display to enable a seller to input a year of construction of the property. Similar screens may be displayed for the other fields of the property-details-entry screen 3800. Once the seller has entered all necessary asset details, the control logic 116 may control the GUI 114 to display a documentation screen.

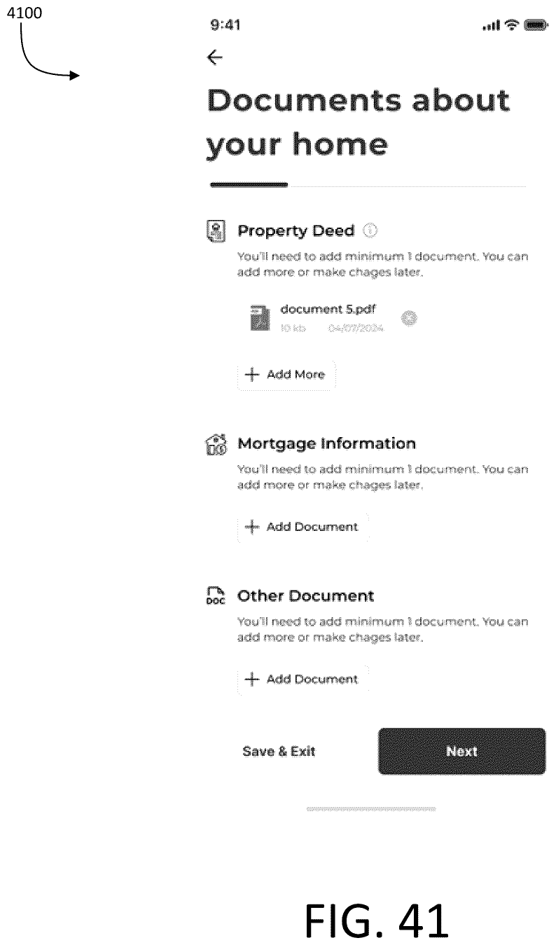

FIG. 41 illustrates a documentation screen 4100 according to an example. The control logic 116 may control the GUI 114 to display the documentation screen 4100 responsive to the seller entering general asset information. The documentation screen 4100 enables a seller to upload closing documentation about the asset, such as a property deed, mortgage documentation, or other documentation which might be necessary or valuable for closing, such as inspection information or other relevant information about the property. Such other relevant information may include, for example, documentary proof of a successful radon inspection, proof of a roof repair having been completed at a certain date, and so forth. Each documentation field may be set as optional or required; for example, while a property deed may be required, a mortgage document may not be required because some sellers may own the property outright. Once the seller has provided all necessary documentation, the control logic 116 controls the GUI 114 to prompt the seller to add videos and photos of the property.

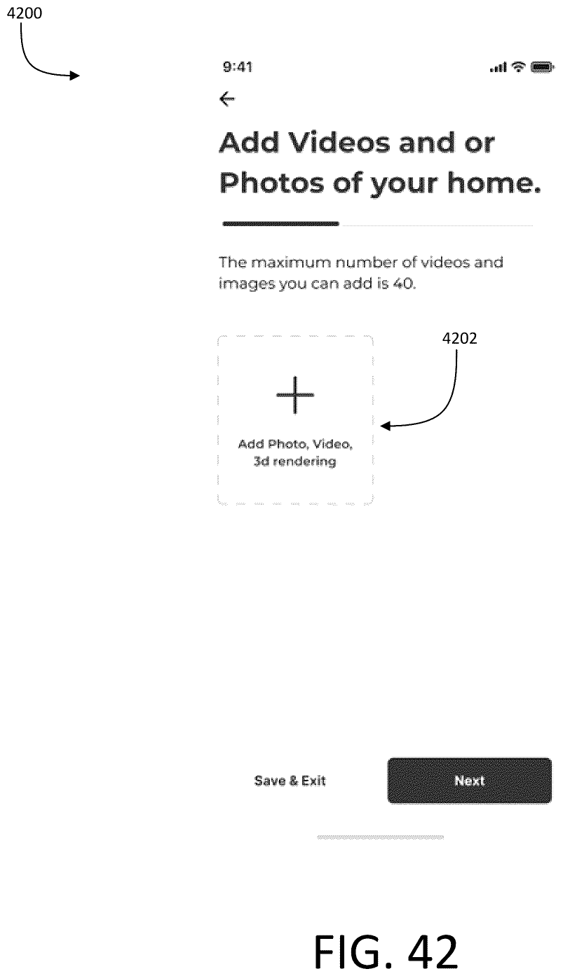

FIG. 42 illustrates a media-upload screen 4200 according to an example. The control logic 116 may control the GUI 114 to display the media-upload screen 4200 responsive to the seller entering all necessary documentation. The media-upload screen 4200 may enable a seller to upload videos and/or photos of an asset to be listed. Selecting an add button 4202 may prompt the control logic 116 may control the GUI 114 to display a media-type-selection screen to enable the seller to select a type of media to be uploaded.

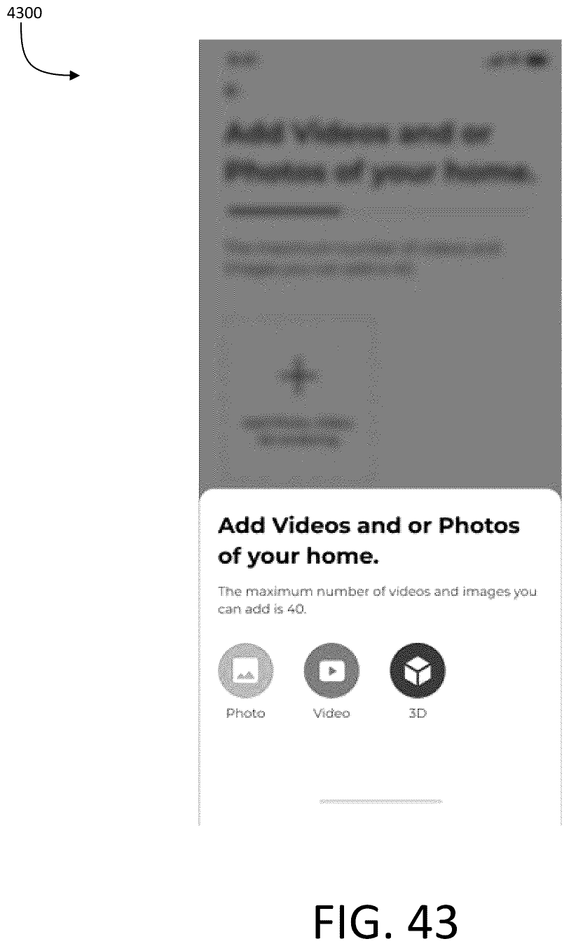

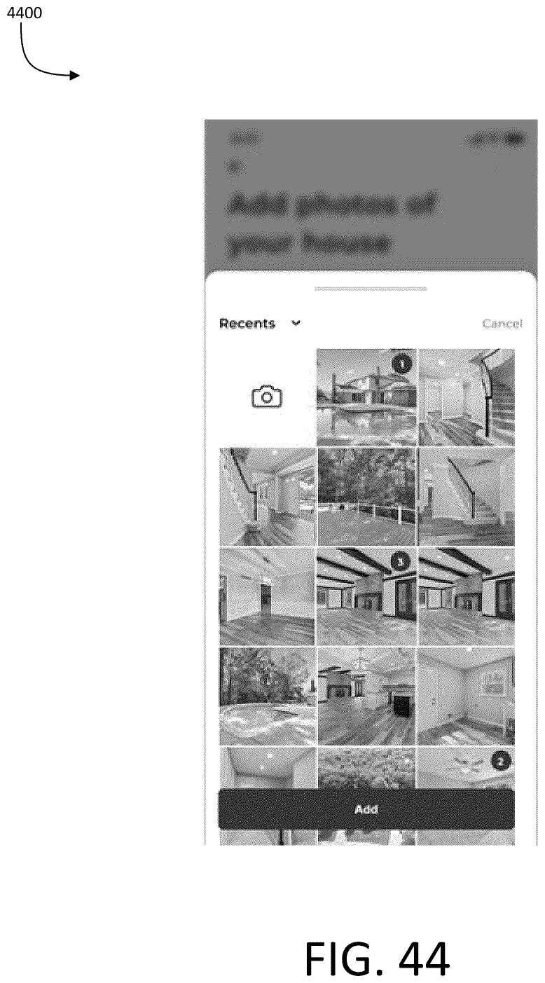

FIG. 43 illustrates a media-type-selection screen 4300 according to an example. The control logic 116 may control the GUI 114 to display the media-type-selection screen 4300 responsive to the seller selecting the add button 4202. The media-type-selection screen 4300 may enable a seller to select whether to upload a photo, video, or 3D rendering. For example, if the seller selects a photo button, the control logic 116 may control the GUI 114 to display a photo-roll screen. FIG. 44 illustrates a photo-roll screen 4400 according to an example. The photo-roll screen 4400 opens the seller's photo roll and allows the seller to select photos to upload. Once all media is selected for upload, the seller may rearrange selected media as desired on a preview screen.

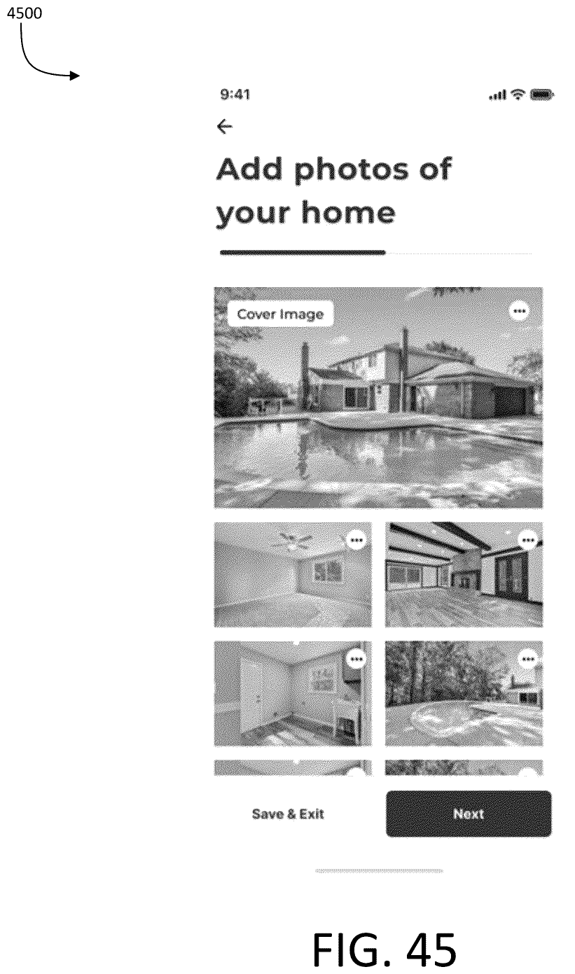

FIG. 45 illustrates a preview screen 4500 according to an example. The control logic 116 may control the GUI 114 to display the preview screen 4500 responsive to the seller uploading all desired media. The seller may then use the preview screen 4500 to arrange the media in a desired order, such as by selecting a cover photo and subsequent photos. Once the seller has ordered media in a desired order, the control logic 116 may control the GUI 114 to display a property-details screen.

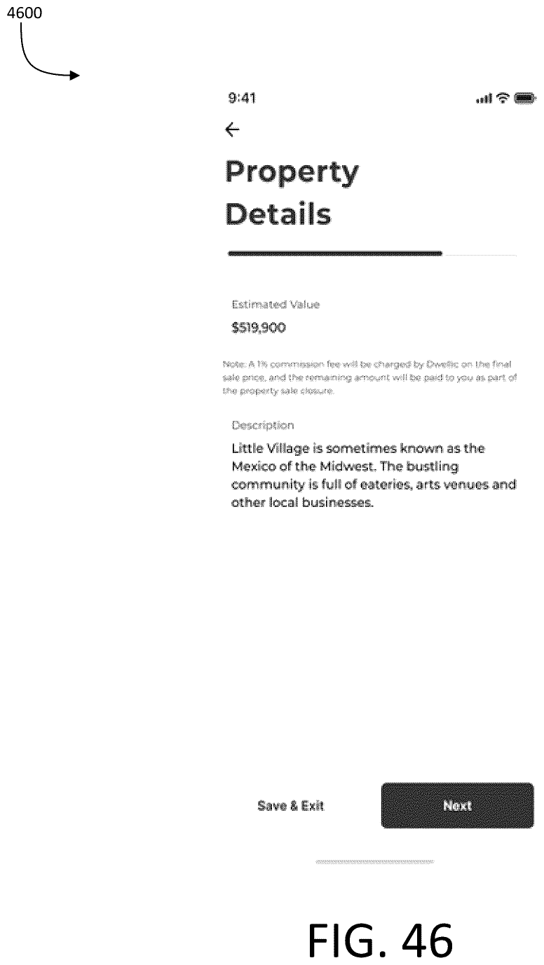

At act 306, the seller computing device 104 receives seller sale metrics from the seller. FIG. 46 illustrates a property-details screen 4600 according to an example. The control logic 116 may control the GUI 114 to display the property-details screen 4600 responsive to the seller completing the process of providing details about the asset at act 304. The property-details screen 4600 enables a seller to input critical sale details about the asset, such as an estimated value and a short description of the property and/or surrounding neighborhood. Once a seller has input the estimated value and the short description, the control logic 116 may control the GUI 114 to display an auction-type-selection screen.

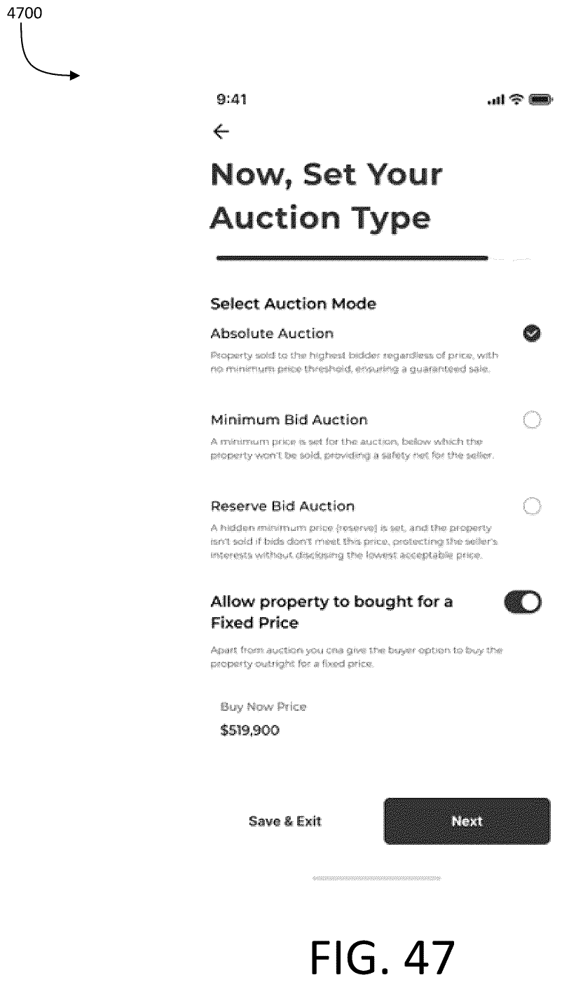

FIG. 47 illustrates an auction-type-selection screen 4700 according to an example. The control logic 116 may control the GUI 114 to display the auction-type-selection screen 4700 responsive to the seller entering the estimated value and the short description. The auction-type-selection screen 4700 enables the seller to select between an absolute auction, a minimum bid auction, and a reserve bid auction. If the seller selects the minimum bid auction or the reserve bid auction setting, the control logic 116 may control the GUI 114 to prompt the user to enter a minimum-bid price or a reserve-bid price, respectively. The auction-type-selection screen 4700 may also include a setting for a seller to allow the property to be bought immediately, bypassing the auction, for a fixed or dynamic price. If the seller opts to allow the property to be bought for a fixed price, the seller may input the fixed price. Alternatively, if the seller selects an option to allow the property to be sold for an immediate-purchase price that is determined dynamically (not explicitly illustrated), then in various examples the seller may or may not be prompted to enter a starting immediate-purchase price. After the seller selects the type of auction and associated details, the control logic 116 may control the GUI 114 to display an escrow-information screen.

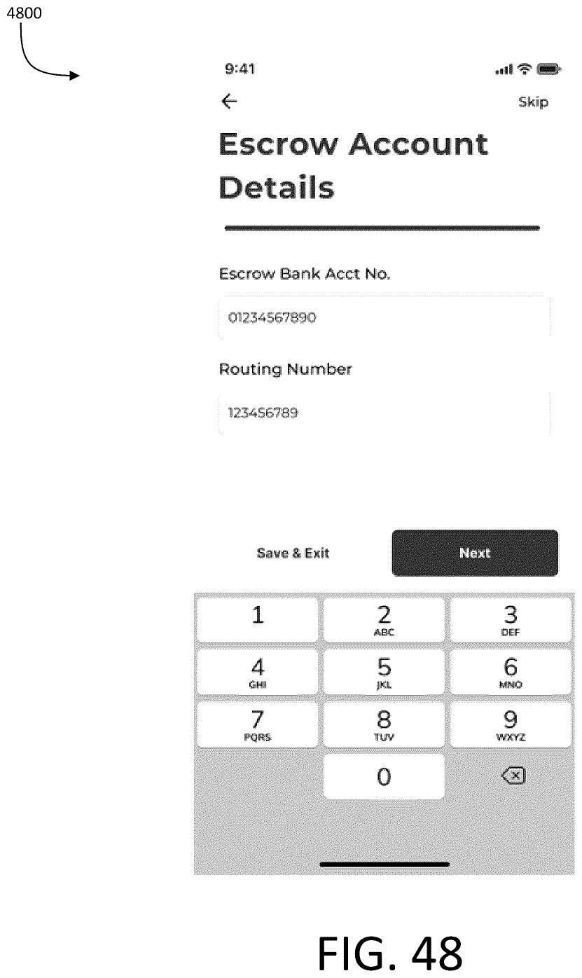

FIG. 48 illustrates an escrow-information screen 4800 according to an example. The control logic 116 may control the GUI 114 to display the escrow-information screen 4800 responsive to the seller selecting an auction type and associated details. The escrow-information screen 4800 enables a seller to input escrow information for a transaction to be completed. The seller may input an escrow bank account number and routing number into the escrow-information screen 4800. After the seller does so, the control logic 116 may control the GUI 114 to display a property-sale-agreement screen.

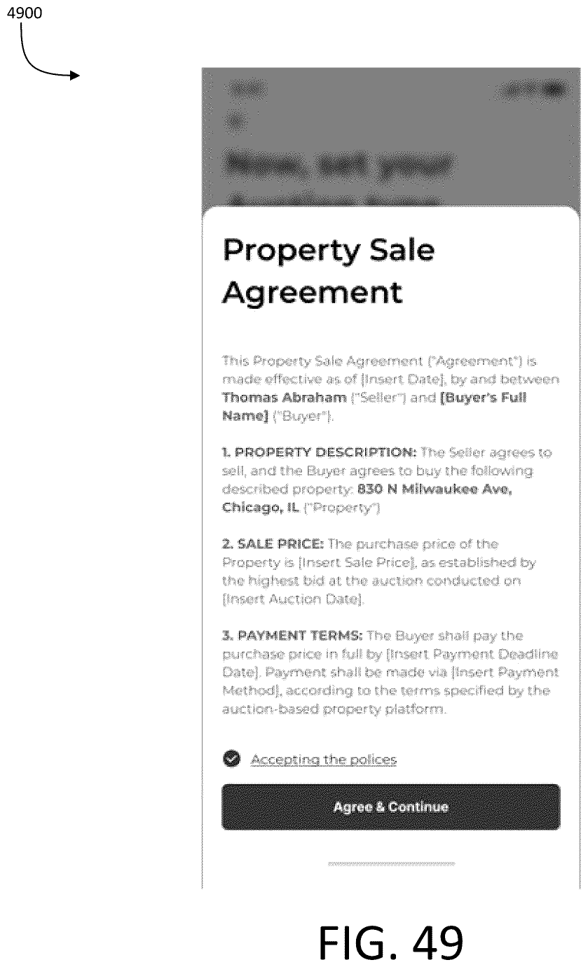

FIG. 49 illustrates a property-sale-agreement screen 4900 according to an example. The control logic 116 may control the GUI 114 to display the property-sale-agreement screen 4900 responsive to the seller inputting escrow-account information. The property-sale-agreement screen 4900 may provide the seller with a preview of what form a property sale agreement may take if the property is sold. The seller may review and accept the format of the property-sale agreement on the property-sale-agreement screen 4900, after which the control logic 116 may control the GUI 114 to display a verification screen.

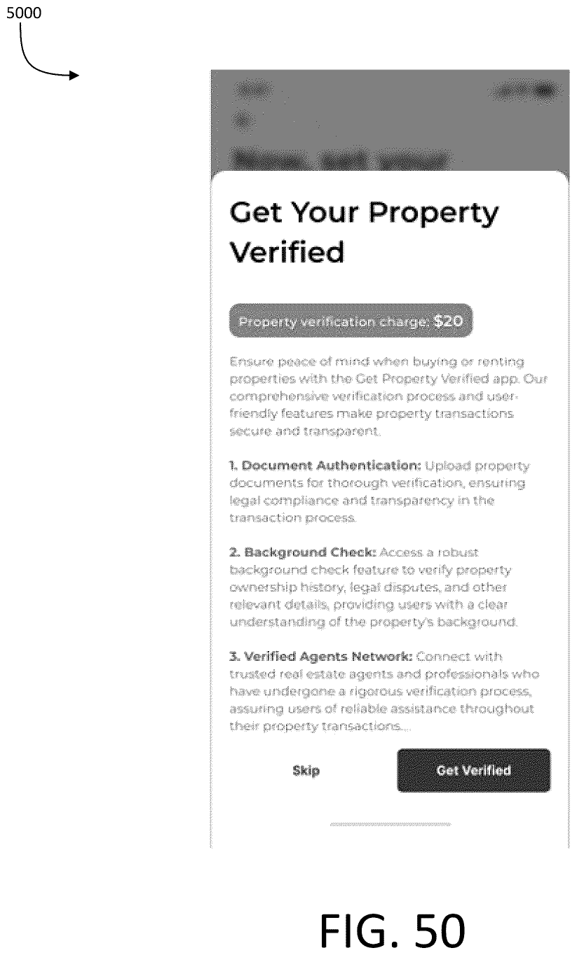

FIG. 50 illustrates a verification screen 5000 according to an example. The control logic 116 may control the GUI 114 to display the verification screen 5000 responsive to the seller reviewing and accepting the property-sale agreement. The verification screen 5000 may provide the seller with the opportunity to have the property verified. For example, verification may include the seller providing documentation for authentication, a background check of the seller, and so forth. In some examples, performing the verification also allows the seller to connect with a network of trusted real estate agents or other professionals. Verification may be optional, but may incentivize buyers to buy a property that they know has been verified. If the seller opts for verification, then the control logic 116 may control the GUI 114 to display a payment-details screen for the seller to pay for a verification charge. If the seller opts not to have verification, then the control logic 116 may control the GUI 114 to display a listing-preview screen.

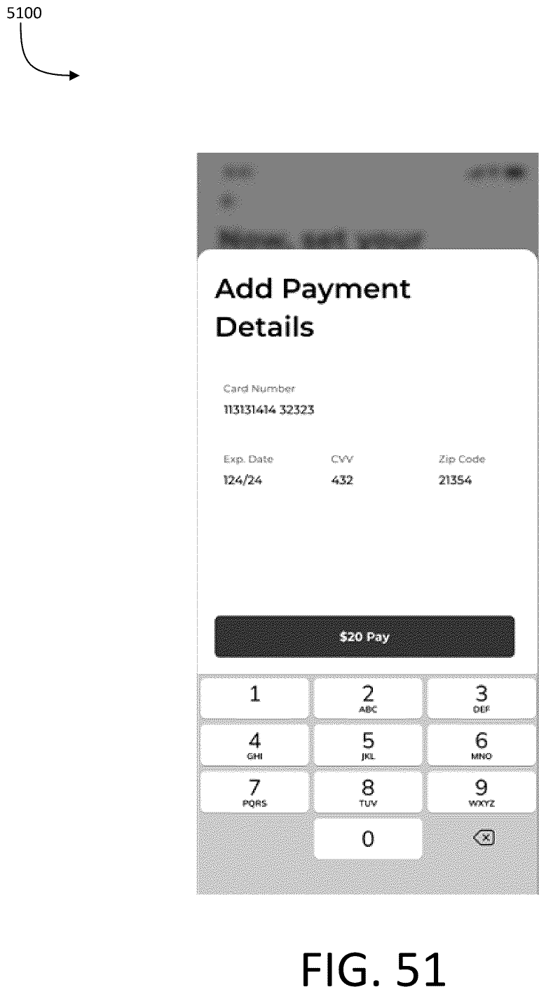

FIG. 51 illustrates a payment-details screen 5100 according to an example. The control logic 116 may control the GUI 114 to display the payment-details screen 5100 responsive to the seller opting to pay for verification. The payment-details screen 5100 may provide a portal through which the seller can enter payment details to pay for the verification charge. Once the seller submits the payment details, the seller may be charged and the seller may undergo an authentication procedure. For example, the seller's documentation may be manually or automatically (for example, by the control logic 122) reviewed for authentication. The control logic 116 may then control the GUI 114 to display a listing-preview screen.

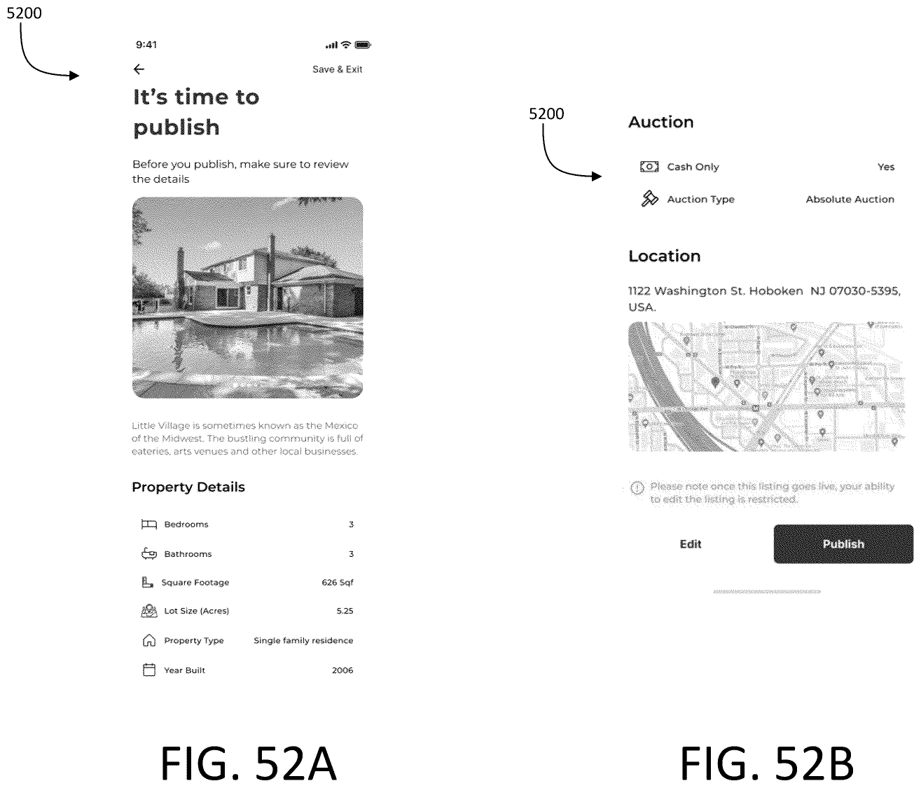

FIGS. 52A and 52B illustrate a listing-preview screen 5200 according to an example. FIGS. 52A and 52B may illustrate a top section and a bottom section, respectively, of the listing-preview screen 5200. Although the listing-preview screen 5200 may be displayed as a continuous vertical screen in various examples, for clarity of illustrate, the listing-preview screen 5200 has been separated into two images. The control logic 116 may control the GUI 114 to display the listing-preview screen 5200 responsive to the seller completing, or opting out of, the verification process.

The listing-preview screen 5200 provides a preview of the listing for the listed asset. The listing-preview screen 5200 includes information about the asset such as an image of the property, a description of the property, a number of bedrooms, a number of bathrooms, square footage, lot size, property type, a year of construction, location information, and auction-details information (for example, a type of auction). The seller may either edit details of the listing or publish the listing.

At act 308, the seller computing device 104 lists the asset for sale. For example, the seller computing device 104 may list the asset for sale responsive to the seller publishing the property listing. Act 308 may include the control logic 116 communicating details of the listing to the remote computing device 106. The control logic 122 may store information indicative of the listing in the storage and/or memory 120. Buyers may subsequently access the property listing; for example, as discussed above at act 206, a buyer may use the control logic 110 to access the listing stored by the remote computing device 106 via the communication network 124.

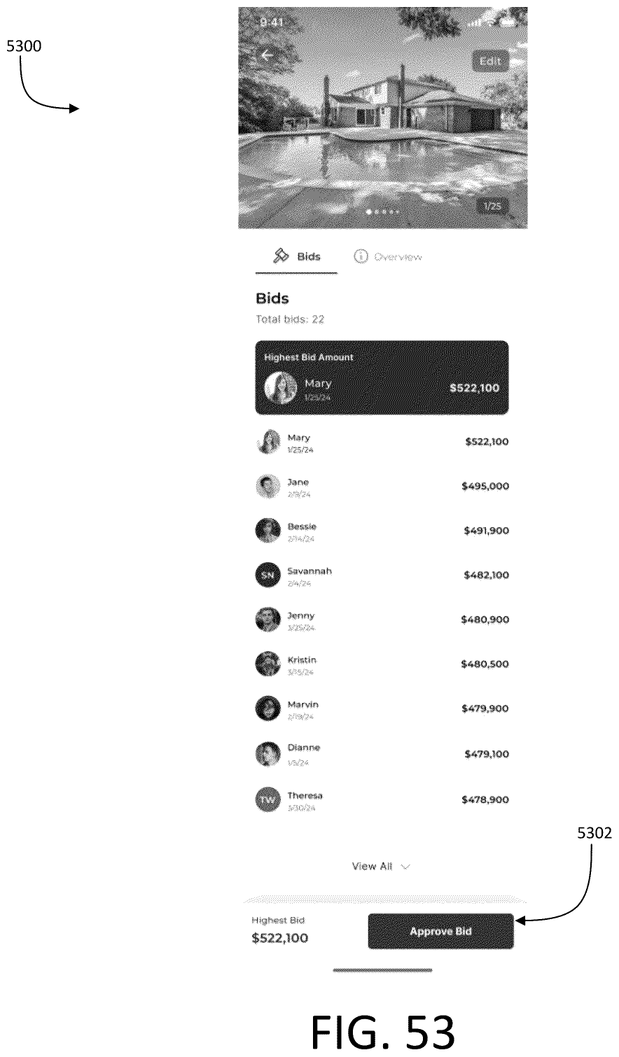

Once the seller's listing has been published, buyers may submit bids on the listing. The control logic 116 may control the GUI 114 to display a bids screen displaying bids that have been placed on the seller's property. FIG. 53 illustrates a bids screen 5300 according to an example. The bids screen 5300 may display information about bids that have been placed on the property, such as a total number of bids, a value of each bid, an identity of each bidder, and so forth. If the seller opted to manually review and approve a highest bid, then the control logic 116 may control the GUI 114 to display an approve-bid button 5302. The seller may interact with the approve-bid button 5302 to approve a current highest bid. Alternatively or additionally, the seller may interact with the listing itself to prompt the control logic 116 to control the GUI 114 to display a listing-overview screen.

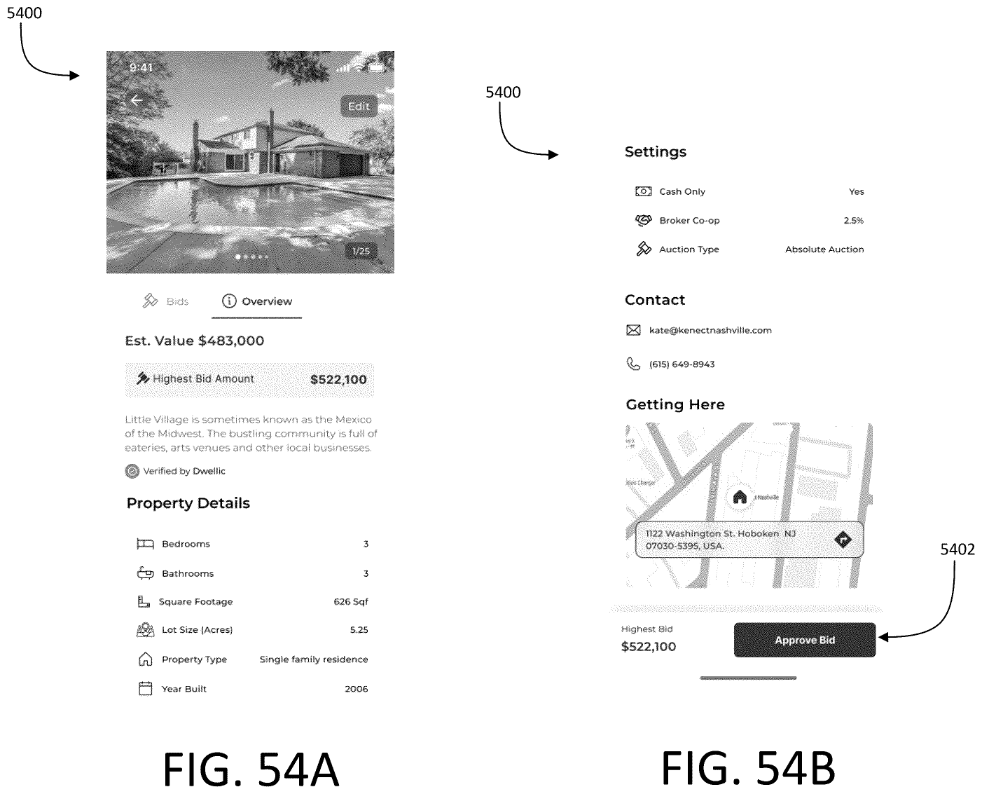

FIGS. 54A and 54B illustrate a listing-overview screen 5400 according to an example. FIGS. 54A and 54B may illustrate a top section and a bottom section, respectively, of the listing-overview screen 5400. Although the listing-overview screen 5400 may be displayed as a continuous vertical screen in various examples, for clarity of illustrate, the listing-overview screen 5400 has been separated into two images. The control logic 116 may control the GUI 114 to display the listing-overview screen 5400 responsive to the seller completing, or opting out of, the verification process.

The listing-overview screen 5400 displays similar information about the listed asset as the listing-preview screen 5200, such as a property image, estimated property value, highest bid amount, an optional verification mark indicating whether the property has been verified, property details (for example, a number of bedrooms, a number of bathrooms, square footage, lot size, property type, construction year, etc.), auction information, and so forth. In addition, the listing-overview screen 5400 displays information about a highest bid and includes an approve-bid button 5402 to approve a highest bid. If the seller interacts with the approve-bid button 5402, the control logic 116 may approve the bid and may initiate a transaction-closing process, in response to which the control logic 116 may control the GUI 114 to display a processing screen of a transaction-closing process.

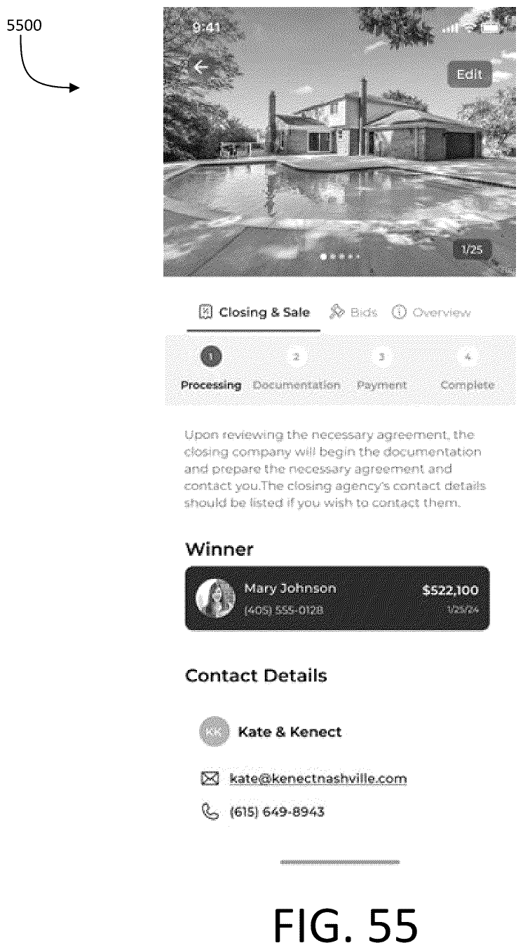

FIG. 55 illustrates a processing screen 5500 of a transaction-closing process according to an example. The control logic 116 may control the GUI 114 to display the processing screen 5500 responsive to an auction closing with a winning buyer. The processing screen 5500 may include information such as a description of the closing sale, a name of a winning buyer, contact information for the buyer and/or closing company, an amount of the winning bid or immediate-purchase price, a date that the winning bid or immediate-purchase price was submitted, and so forth.

Accordingly, buyers and sellers may be presented with screens to create accounts, list and buy properties, and close transactions. Administrators of the platform (for example, an operate of the remote computing device 106) may also access features of the platform via administrator screens. For example, administrators may access an overview screen providing an overview of activity on the platform.

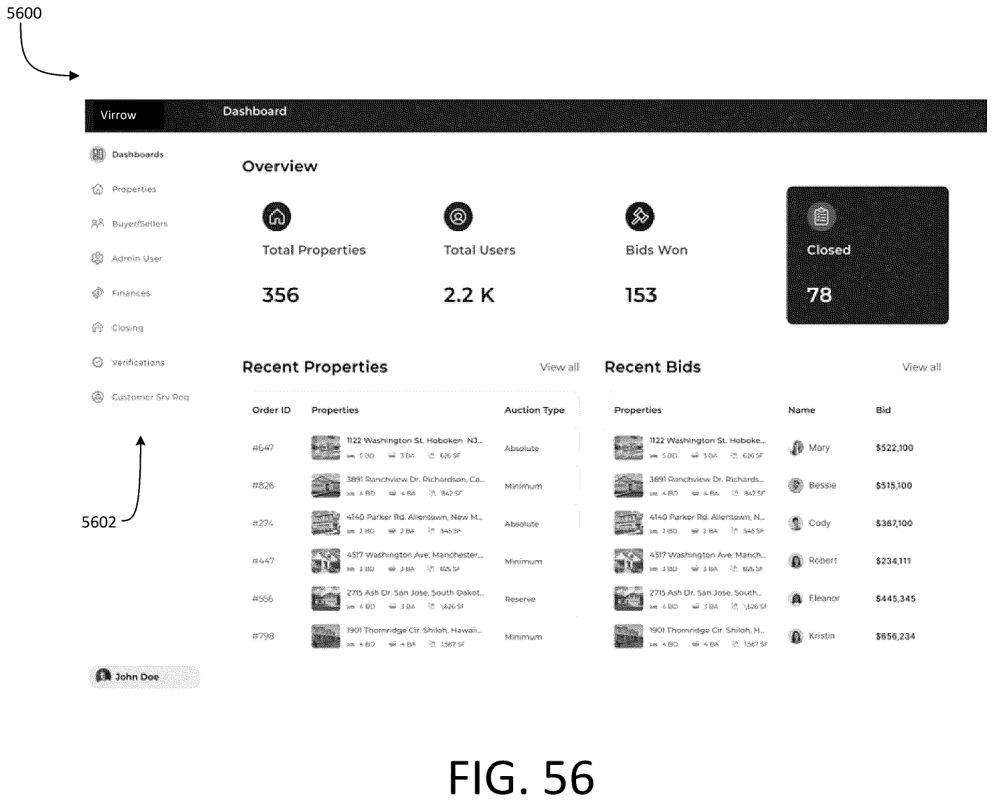

FIG. 56 illustrates an overview home screen 5600 for an administrator according to an example. For example, the control logic 122 may control a GUI (such as a remote computer terminal) to display the overview home screen 5600 to an administrator. The overview home screen 5600 may provide information for an administrator indicative of activity on the platform and other relevant details, such as a total number of properties listed on the platform, a total number of registered users, a total number of bids won, a list of recently listed or big-upon properties, asset identifiers such as property addresses, indicators of auction type (for example, minimum, absolute, or reserve), and recent bid information, such as property addresses, bid amounts, and bidder user names.

The overview home screen 5600 further includes a list of tabs 5602 on the side of the screen 5600. A user selection of the tabs 5602 may prompt the control logic 122 to display a different screen. For example, a user selection of a “Properties” tab may redirect to a properties-information screen.

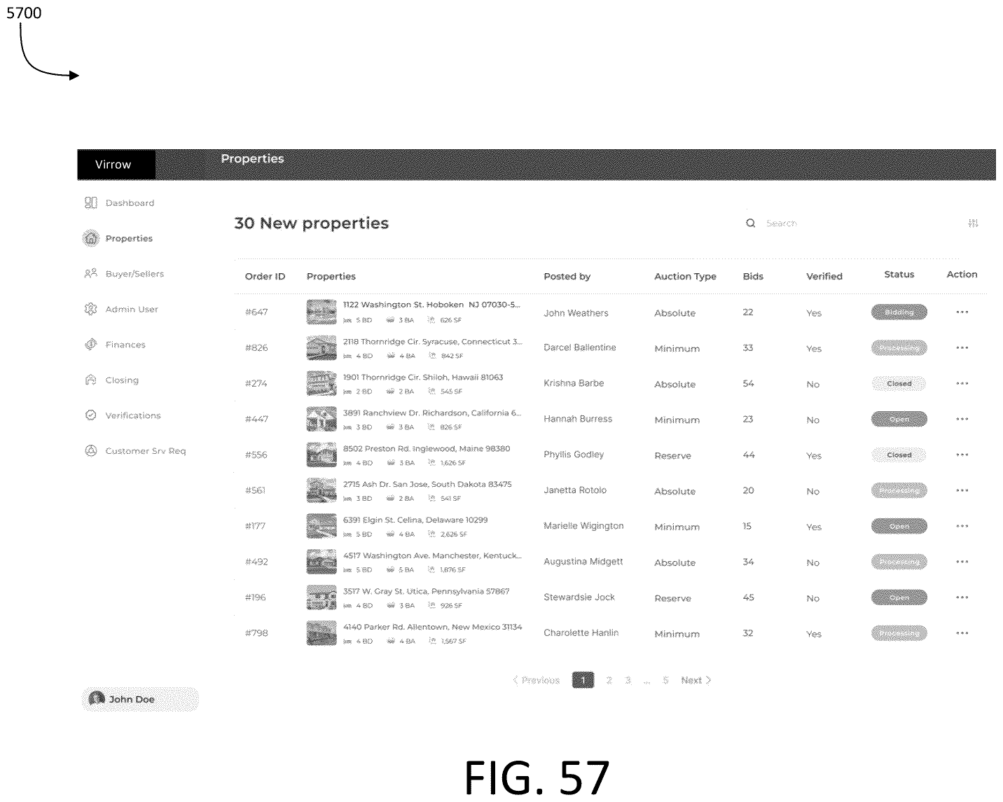

FIG. 57 illustrates a properties-information screen 5700 according to an example. The control logic 122 may control a GUI to display the properties-information screen 5700 responsive to, for example, an administrator selecting the “Properties” tab of the overview home screen 5600. The properties-information screen 5700 may provide an administrator with a list of properties listed on the platform with associated information, such as a unique identifier for each property, a property name, a property poster (for example, owner), an auction type, a number of bids, an indication of whether the property is verified, a current status of the property listing, a search field to search for specific properties, an option to select an action for a given property, pagination tools to page through different pages of property listings, and so forth. Administrators may use the properties-information screen 5700 to manage and monitor property listings. If the control logic 122 receives a user selection of a given property, the control logic 122 may control the GUI to display a property-information screen.

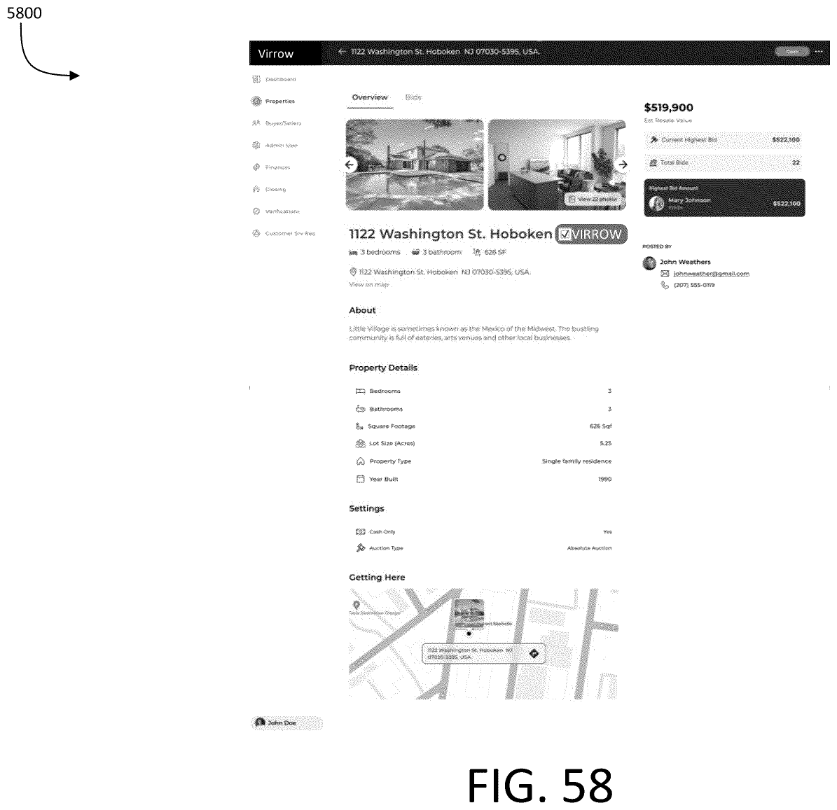

FIG. 58 illustrates a property-information screen 5800 according to an example. The control logic 122 may control a GUI to display the property-information screen 5800 responsive to a user selecting a listed property on the properties-information screen 5700. The administrator may use the property-information screen 5800 to view additional information about a given property, such as an image of the property, a name of the property, a brief description of the property, property details (for example, a number of bedrooms, a number of bathrooms, square footage, lot size, construction year, and so forth), settings (for example, whether cash only and an auction type), property location, property status, an estimated value, a current highest bid, a total number of bids, a highest bid amount, an identification of who posted the listing, and so forth. If a property has been successfully bid upon and the property is undergoing a closing process, then a user selection of a property on the properties-information screen 5700 may cause the control logic 122 to control a GUI to display a different, property-closing-information screen.

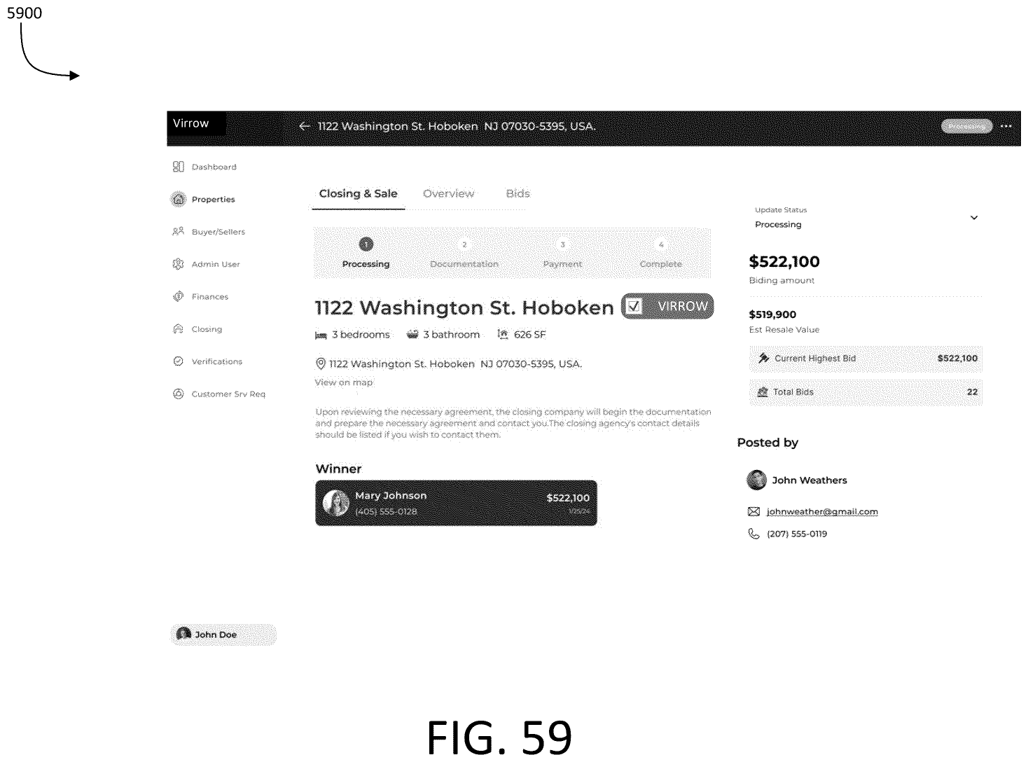

FIG. 59 illustrates a property-closing-information screen 5900. The control logic 122 may control a GUI to display the property-closing-information screen 5900 responsive to a user selection of a listed property on the properties-information screen 5700 that is undergoing a closing process. The administrator may use the property-closing-information screen 5900 to view additional information about a property that is undergoing a closing process, such as a current status of the closing process, a name of the property, an indication of a verification status, property details, a description of next steps in the closing process, information about the buyer, an estimated resale value of the property, bid information (for example, a winning highest bid, a total number of bids, and so forth), seller information, and so forth.

Returning to FIG. 56, the tabs 5602 may also include a “Buyers/Sellers” tab. A user selection of the “Buyers/Sellers” tab may redirect to a user-listing screen.

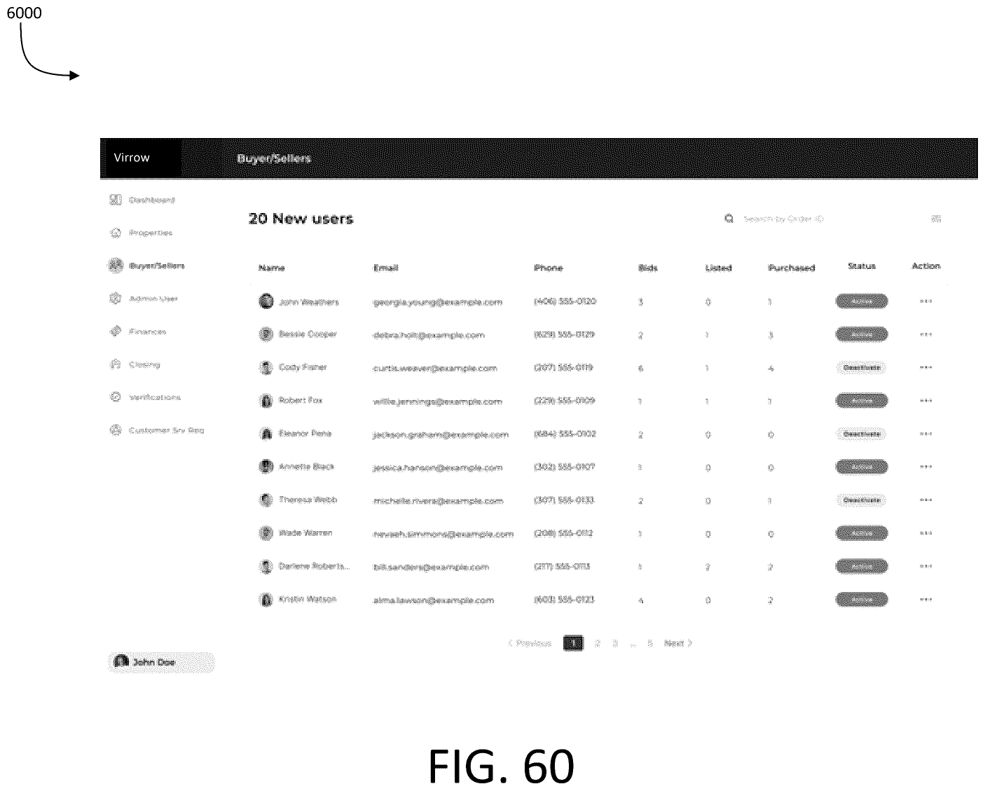

FIG. 60 illustrates a user-listing screen 6000 according to an example. The control logic 122 may control a GUI to display the user-listing screen 6000 responsive to an administrator selecting the “Buyers/Sellers” tab of the screen 5700. The user-listing screen 6000 provides an administrator with information about buyers and sellers, such as user names, user contact information (for example, email and phone number), bid information for buyers (for example, a total number of bids placed and/or successful purchases), property-listing information for sellers (for example, a total number of listed properties), user status (for example, indicating whether an account is active or deactivated), an action interface to enable an administrator to take action on an account, a filter option to filter between users, a search field to enable an administrator to search users, a pagination field to enable an administrator to page through different user pages, and so forth. An administrator may use the user-listing screen 6000 to manage and monitor user accounts. In some examples, an administrator may select an individual user to view additional details about the user on a user-information screen.

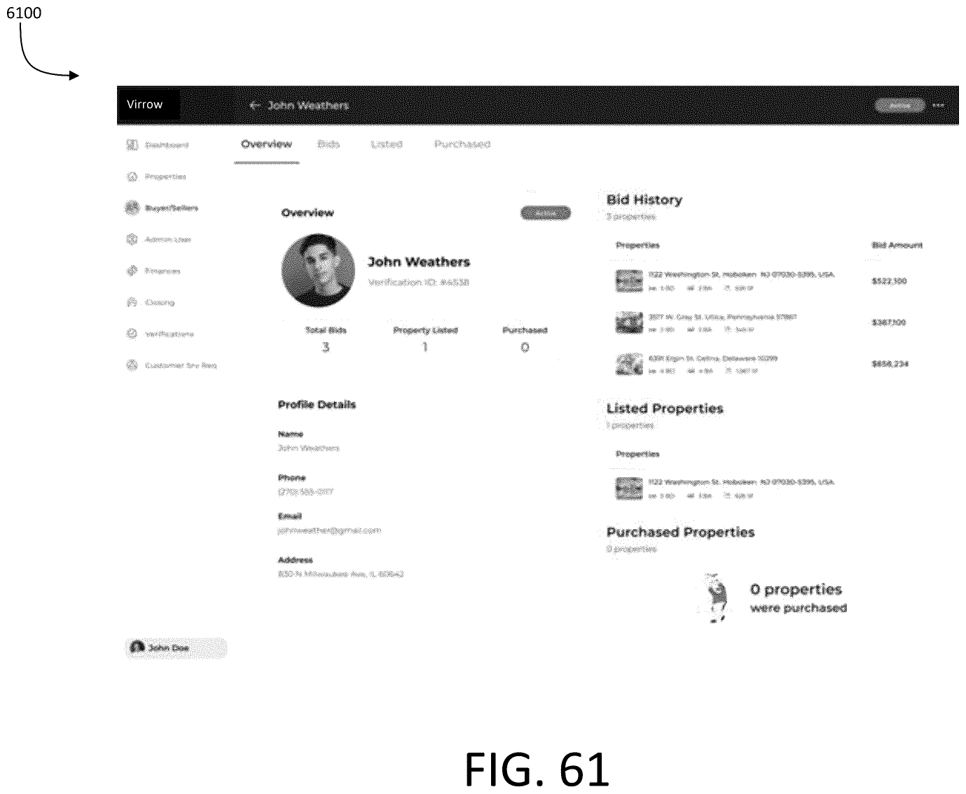

FIG. 61 illustrates a user-information screen 6100 according to an example. The control logic 122 may control a GUI to display the user-information screen 6100 responsive to selection of a user on the user-listing screen 6000. The user-information screen 6100 provides additional information about the selected user, such as a user's name, identification number, buyer activity information (for example, a total number of bids placed, a total number of properties purchased, and so forth), seller activity information (for example, a total number of properties listed or sold), profile information (for example, identifying and/or contact information), user status information, and so forth. An administrator may use the user-information screen 6100 to gain insight into the activities and/or profile details of individual users.

Returning to FIG. 56, the tabs 5602 may also include a “Admin User” tab. A user selection of the “Admin User” tab may redirect to an admin-listing screen.

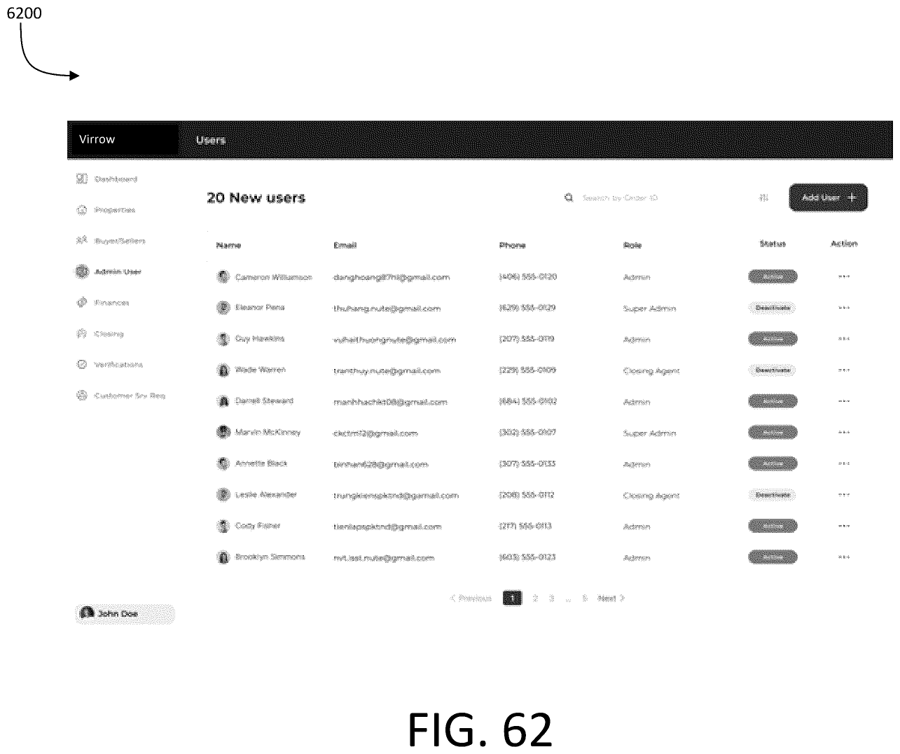

FIG. 62 illustrates an admin-listing screen 6200 according to an example. The control logic 122 may control a GUI to display the admin-listing screen 6200 responsive to a user selection of the “Admin User” tab on the screen 5700. The admin-listing screen 6200 provides the administrator with a list of other administrators, including information such as identifying information (for example, a name of the user), contact information (for example, email and phone information), role information, user status information, an action tab to enable the administrator to take an action with respect to the other administrator's account, a search field to search administrators, a pagination field to page through different pages of administrators, an add-user button to add additional administrators, and so forth. The admin-listing screen 6200 enables the administrator to manage other administrators' accounts.

Returning to FIG. 56, the tabs 5602 may also include a “Closing” tab. A user selection of the “Closing” tab may redirect to a closing-information screen.

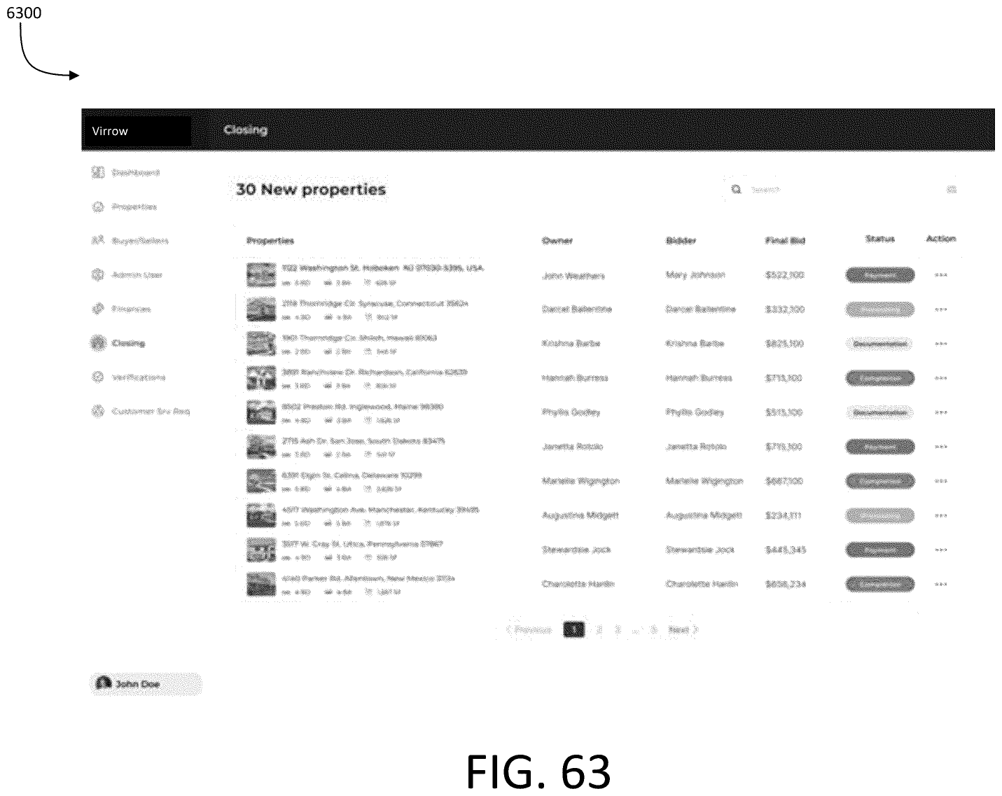

FIG. 63 illustrates a closing-information screen 6300 according to an example. The control logic 122 may control a GUI to display the closing-information screen 6300 responsive to selection of the “Closing” tab of FIG. 56. The closing-information screen may provide information about properties which are undergoing a closing process, and may include information such as property details (for example, an address of the property and details such as bathrooms, bedrooms, and so forth), owner information, buyer information, final purchase information, status information, an action field to enable the administrator to take some action on the listing, a pagination field to page through different pages of administrators, a search field to search properties, and so forth. The closing-information screen 6300 enables an administrator to review and manage properties during a closing procedure. An administrator may select a listed property to display a closing-review screen.

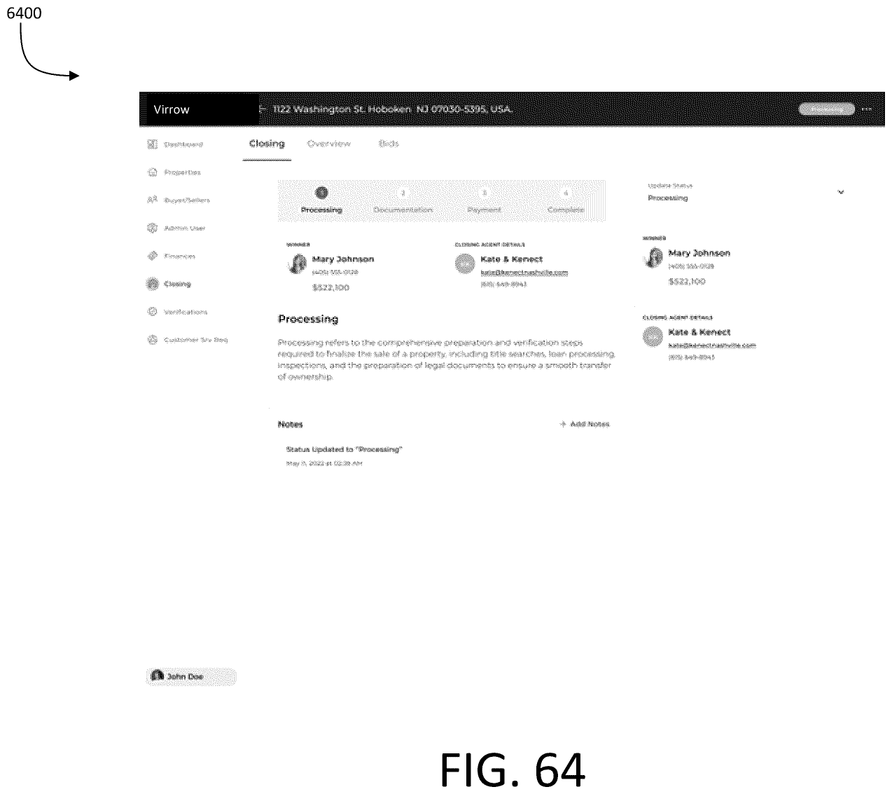

FIG. 64 illustrates a closing-review screen 6400 according to an example. The control logic 122 may control a GUI to display the closing-review screen 6400 responsive to selection of a listed property on the closing-information screen 6300. The closing-review screen 6400 provides information about the selected property such as a name of the selected property, property details, an indication of verification status, a status of the closing process, identifying information for the buyer, an add-notes button to enable the administrator to add notes to the transaction, closing-agent information, and so forth. The closing-review screen 6400 enables an administrator to closely monitor each individual closing procedure as necessary. In some examples, an administrator may choose to manually update the status of the transaction, such as by changing the transaction from being in process to closed. Manually updating the closing status may display a change-status screen.

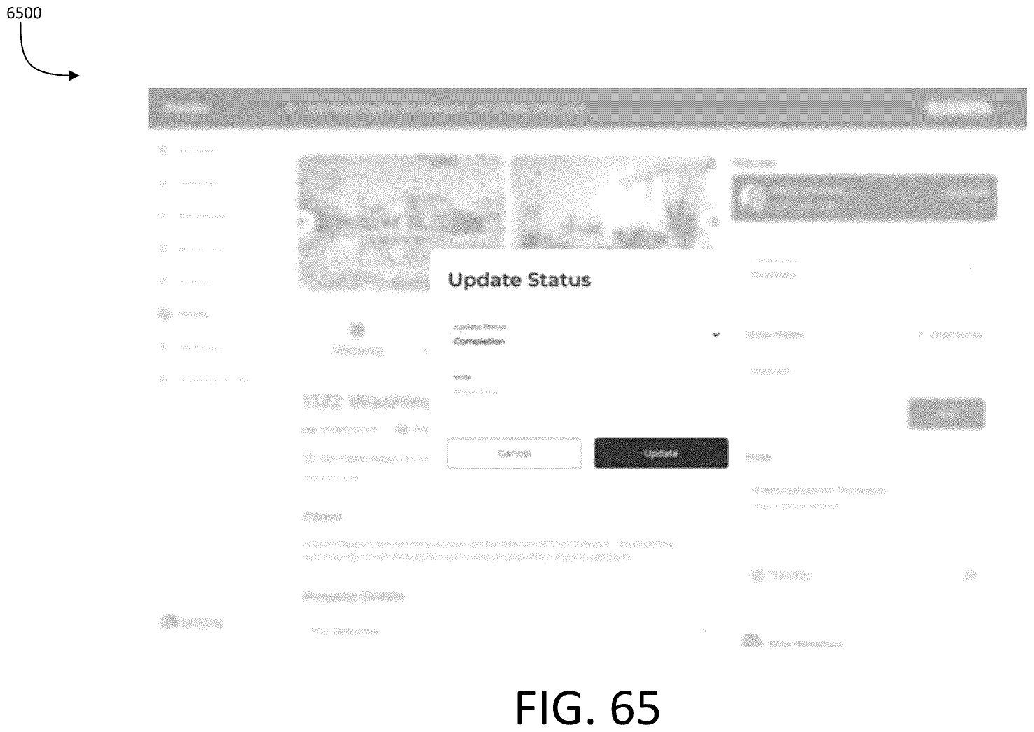

FIG. 65 illustrates a change-status screen 6500 according to an example. The control logic 122 may control a GUI to display the change-status screen 6500 responsive to selection of a status button on the closing-review screen 6400. The change-status screen 6500 may include fields for the administrator to update the status of the selected transaction (for example, from processing to completed) and a field to add notes about the change.

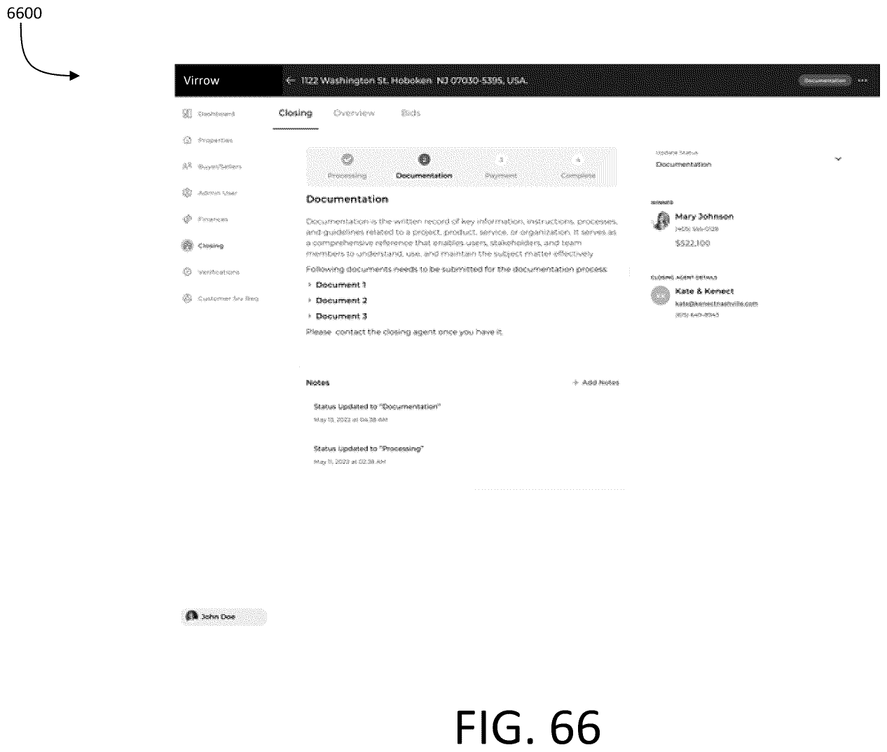

Administrators may also review closing documentation for a selected transaction from the closing-information screen 6300. FIG. 66 illustrates a documentation-review screen 6600 according to an example. The control logic 122 may control a GUI to display the documentation-review screen 6600 responsive to an administrator selecting a “Documentation” tab after selecting a property from the closing-information screen 6300. The documentation-review screen 6600 includes a status of the transaction, a status description, notes fields to enable an administrator to add notes, closing agent information, buyer information, fields to view and/or edit uploaded documentation, a selectable field to update the status of the transaction, and so forth. An administrator may use the documentation-review screen 6600 to review and manage the process of providing documentation for a transaction.

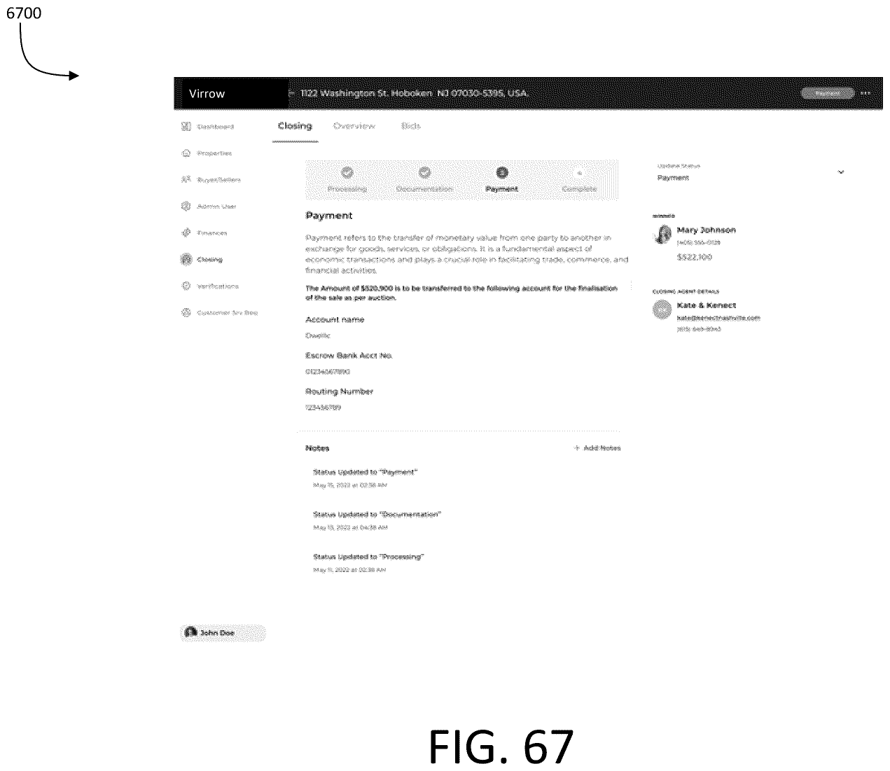

Administrators may also review payment information for a selected transaction from the closing-information screen 6300. FIG. 67 illustrates a payment-review screen 6700 according to an example. The control logic 122 may control a GUI to display the payment-review screen 6700 responsive to an administrator selecting a “Payment” tab after selecting a property from the closing-information screen 6300. The payment-review screen 6700 includes information such as payment status information, payment description information (including details such as an escrow account name, account number, and routing number), an add-notes button for the administrator to add notes, closing agent information, an update-status button to update the transaction status, buyer information, and so forth. The payment-review screen 6700 enables the administrator to review and manage payment details of a transaction.

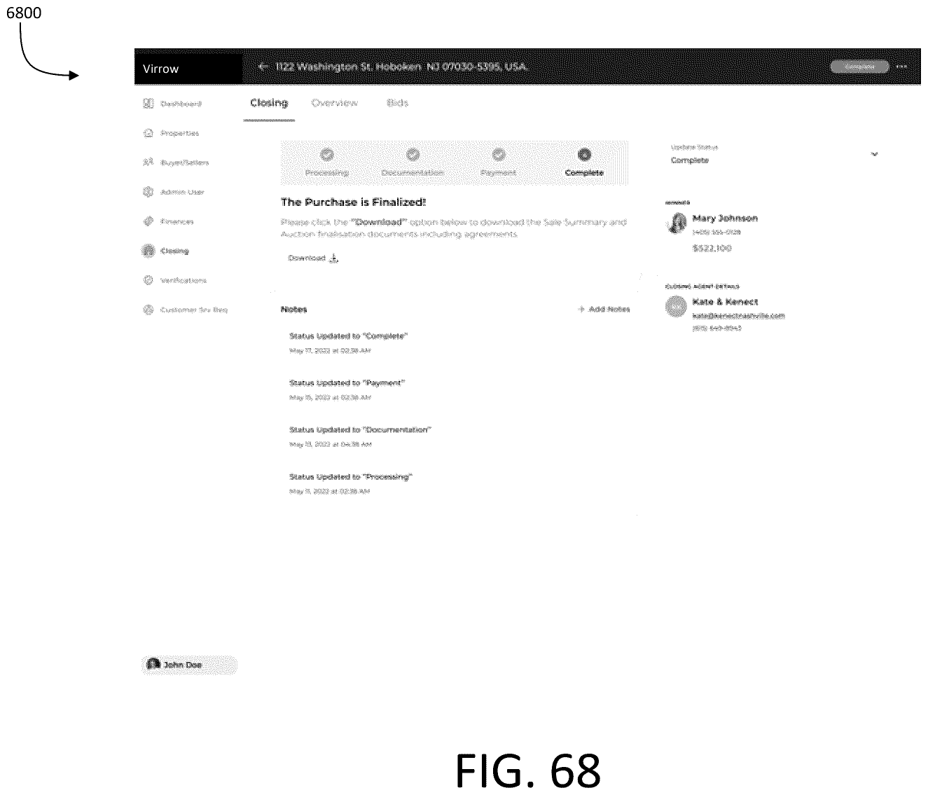

Administrators may also review transaction-confirmation information for a selected transaction from the closing-information screen 6300. FIG. 68 illustrates a transaction-confirmation screen 6800 according to an example. The control logic 122 may control a GUI to display the transaction-confirmation screen 6800 responsive to an administrator selecting a “Complete” tab after selecting a property from the closing-information screen 6300. The transaction-confirmation screen 6800 includes transaction status information, a status description, a download button to download transaction details, an add-notes button for the administrator to add notes to the transaction, buyer information, closing agent information, and so forth. The transaction-confirmation screen 6800 enables the administrator to review and manage an overall transaction.

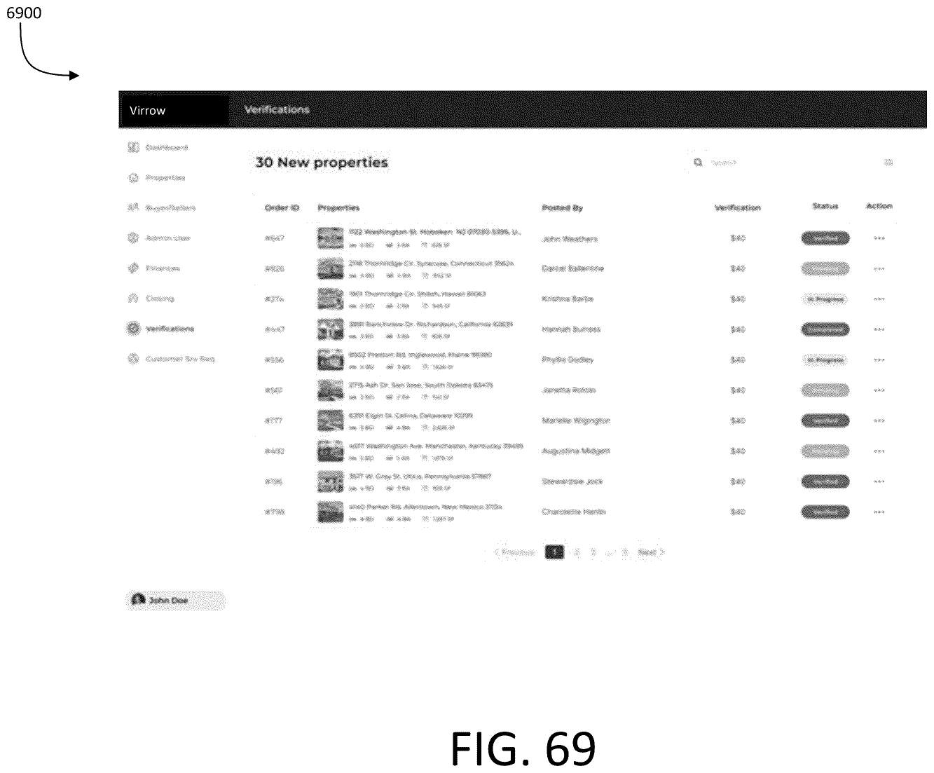

Administrators may also review transaction-verification requests from the closing-information screen 6300. FIG. 69 illustrates a transaction-verification screen 6900 according to an example. The control logic 122 may control a GUI to display the transaction-verification screen 6900 responsive to an administrator selecting a “Verifications” tab after selecting a property from the closing-information screen 6300. The transaction-verification screen 6900 may include information such as a verification request identification number, details about the property to be verified, details about the seller, a verification fee amount, verification status, a pagination field to page through pages of requests, a search field to search requests, and an action field for the administrator to take action on the verification request. As noted above, in some examples, the control logic 122 (or other control logic in the system 100) may automatically process verification requests, such as by implementing machine-vision-based document review. In examples in which requests are at least partially manually reviewed, however, the transaction-verification screen 6900 may enable administrators to manage and review verification requests.

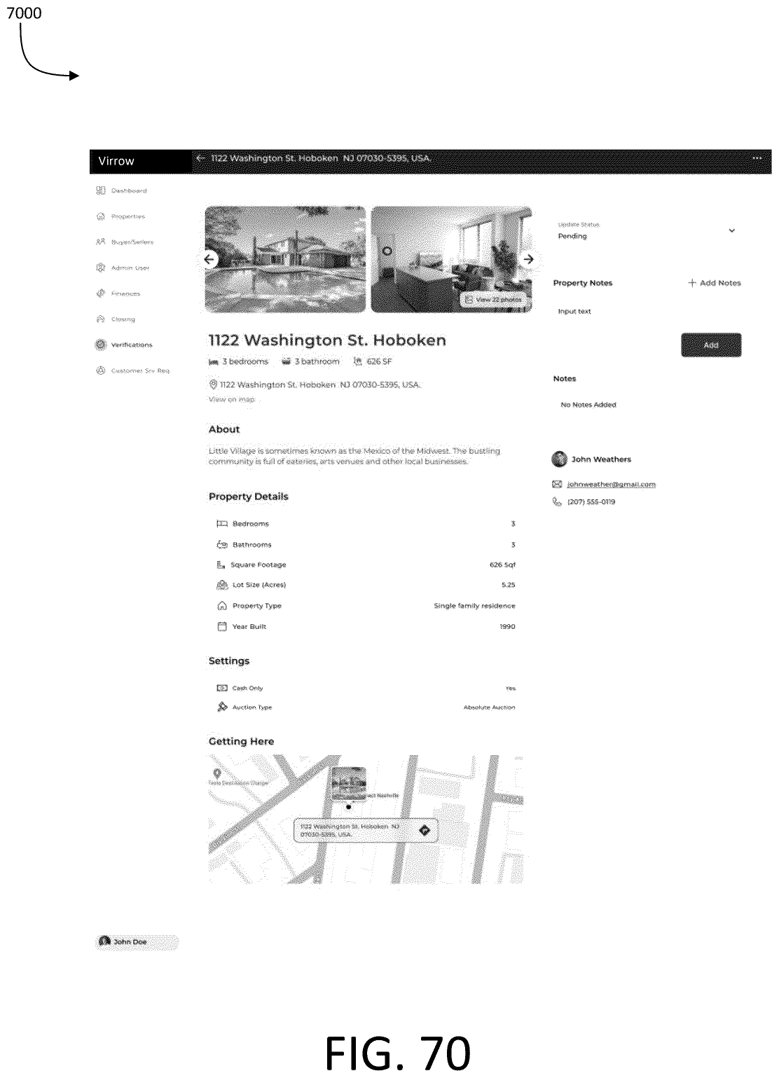

If the administrator selects a given request from the transaction-verification screen 6900, an individual verification-request screen may be displayed. FIG. 70 illustrates a verification-request screen 7000 according to an example. The control logic 122 may control a GUI to display the verification-request screen 7000 responsive to an administrator selecting an entry from the transaction-verification screen 6900. The verification-request screen 7000 may include information such as an image of a property, a name of the property, property details (for example, bedrooms, bathrooms, and so forth), listing settings, property location, an update-status field for the administrator to manage the request, an add-notes field for the administrator to add notes about the request, seller information, and so forth. The verification-request screen 7000 enables the administrator to view and manage individual verification requests to ensure timely and accurate verification.

In some transactions, parties may pay or earn commissions. For example, a seller or buyer may pay a commission to the platform, or to each other, for sales occurring on the platform. Administrators may review these commission details on a commission-review screen.

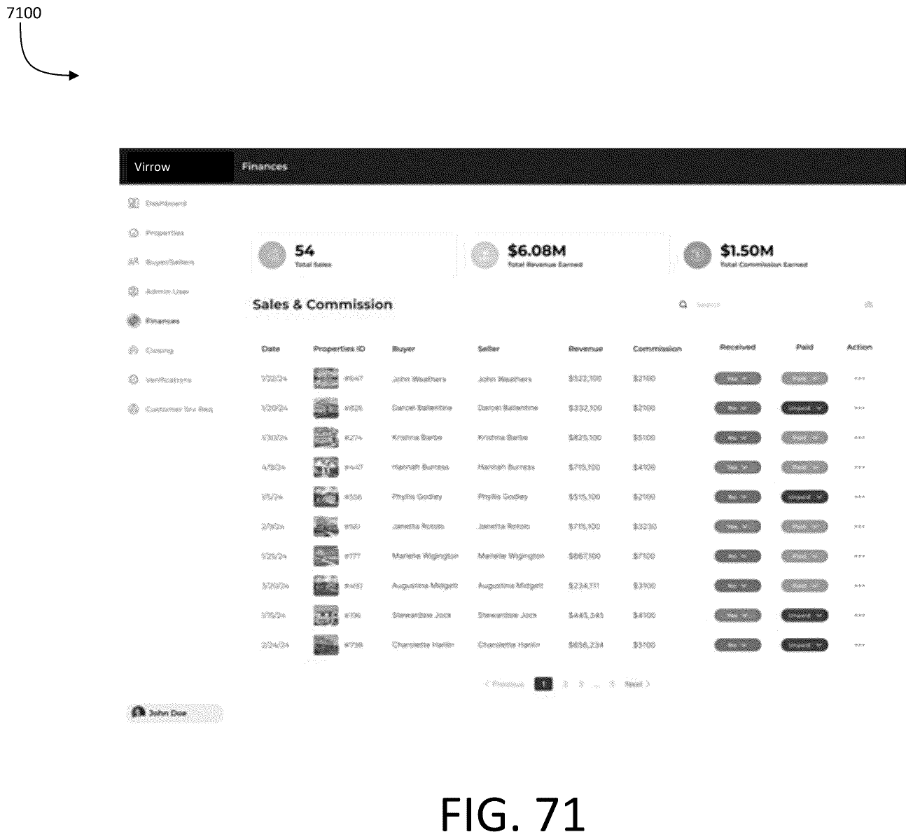

FIG. 71 illustrates a commission-review screen 7100 according to an example. The control logic 122 may control a GUI to display the commission-review screen 7100 responsive to an administrator selecting a “Finances” tab from the closing-information screen 6300. The commission-review screen 7100 includes information such as a total number of asset sales, a total amount of revenue earned, a total commission earned, and sales information such as sale date, property identifier, buyer information, seller information, sale price information, commission price information, commission-receipt-status information, an action field to enable the administrator to take action on a given sale, a pagination filed to enable the administrator to page through pages of sales information, a search field to enable the administrator to search the entries, and so forth.

As discussed above, a seller may initiate listing a property for sale by selecting the add-property button 3102. Upon completing the process of preparing and publishing a listed discussed above with respect to FIGS. 31-52B, an auction may commence. FIG. 4 illustrates an example of conducting an auction.

FIG. 4 illustrates a process 400 of operating a computing device to execute a sale process according to an example. In some examples, the sale process may be referred to as an auction which may receive bids. However, as discussed above (for example, with respect to FIG. 47), sellers may opt to make their property available for immediate purchase for a fixed or dynamically determined price. Accordingly, although a sale process may be referred to as an auction process, in some examples an asset may be purchased outright for an immediate-purchase price rather via a successful bid. For purposes of explanation, an example of FIG. 4 is provided in which the control logic 122 executes the process 400. In other examples, one or more acts of the process 400 may be executed by one or more of the control logics 110, 116, and/or 122.

At act 402, the control logic 122 determines an auction close time at which the auction will close. Act 402 may be executed responsive to a seller publishing a sale listing. In some examples, the seller may select a duration, start time, and/or close time for the auction. In other examples, the control logic 122 may automatically determine a duration, start time, and/or close time for the auction. For example, the auction close time may be 72 hours after the auction is initially opened, or some other amount of time.

At act 404, the control logic 122 opens the auction. The control logic 122 opens the auction by making the asset listing available to buyers. Buyers may then view and select the asset listing as discussed above with respect to, for example, FIG. 14.

At act 406, the control logic 122 provides a bidder interface to buyers. For example, as discussed above, selecting a listing on the listing screen 1400 may display a bidder-interface screen 1500. The bidder interface may include one or more first user-interface elements to enable a bidder to place a bid on the property. For example, the bidder-interface screen 1500 includes a place-bid button 1502 to enable a bidder to place a bid on a property. The bidder-interface screens 2700, 2900 similarly include place-bid buttons 2702, 2902.

At act 408, the control logic 122 determines whether to provide an immediate-purchase option to a buyer. As discussed above, sellers may opt out of making a property available for immediate purchase and may instead only accept bids (with or without a minimum purchase price and/or reserve price). Some sellers may opt to make an immediate-purchase option available to a buyer, including fixed and dynamically determined immediate-purchase options.

In some examples, only authenticated buyers may have access to the immediate-purchase option. Accordingly, at act 408, the control logic 122 may dynamically and in real-time determine whether each buyer accessing the bidder interface has access to an immediate-purchase option. For example, the control logic 122 may repeatedly, dynamically, and in real-time determine whether the buyer has been properly authenticated and whether the buyer has enough authenticated capital to satisfy an immediate-purchase price.

This process may include the control logic 122 repeatedly, dynamically, and in real-time authenticating the buyer's authentication credentials, such as the buyer's proof of funds. In some examples, the control logic 122 may be linked to the buyer's bank account such that act 408 includes the control logic 122 repeatedly, dynamically, and in real-time polling the buyer's bank account to verify that the buyer has sufficient funds to satisfy the immediate-purchase price. As discussed above and in greater detail below, the immediate-purchase price may be dynamically determined and thus change over time; in various examples, act 408 may include repeatedly, dynamically, and in real-time authenticating the buyer's authentication credentials such that the control logic 122 is constantly authenticating the buyer's ability to take advantage of the immediate-purchase option as the immediate-purchase price, and/or the buyer's access to funds, changes.

If the control logic 122 determines that the buyer has access to the immediate-purchase option (408 YES), then the process 400 continues to act 410. Otherwise, if the control logic 122 determines that the buyer does not have access to the immediate-purchase option (408 NO), then the process 400 continues to act 412.

At act 410, the control logic 122 provides an immediate-purchase option on the bidder interface. Providing an immediate-purchase option may include providing one or more second user-interface elements on the bidder interface to enable the bidder to immediately purchase the asset for a listed immediate-purchase price prior to the auction close time determined at act 402 expiring; For example, as discussed above, the bidder-interface screen 1500 includes multiple instances of the immediate-purchase buttons 1504 to enable a buyer to immediately purchase the asset even if the auction close time has not expired. Act 410 may include displaying the immediate-purchase price to the buyer.

At act 412, the control logic 122 determines whether a bid has been received. For example, the control logic 122 may determine whether a buyer has placed a bid via the bidder interface provided at act 406, such as by determining that a buyer has interacted with the place-bid buttons 1502, 2702, 2902. In various examples, bids may be received only when the online auction is in progress, that is, after the auction is opened at act 404 and before the auction close time determined at act 402 expires. If the control logic 122 determines that a bid has been received (412 YES), the process 400 continues to act 414. Otherwise, if the control logic 122 determines that a bid has not been received (412 NO), the process 400 continues to act 416.

At act 414, the control logic 122 updates the bidder interface responsive to determining that a bid has been received. The control logic 122 updates the bidder interface in real-time so that buyers have immediate access to the most up-to-date information about the auction. As discussed above, the bidder interfaces 1500, 2700, 2900 may include bid information such as a current highest bid and a total number of bids. The control logic 122 may therefore update the current highest bid and the total number of bids on the bidder interface at act 414 to reflect the newly received bid.

At act 416, the control logic 122 determines whether to update the immediate-purchase option. In some examples, act 416 may be optionally executed if the seller opts into having a dynamically determined immediate-purchase price. As discussed in greater detail below with respect to FIG. 5, which provides an example of act 416, the control logic 122 may monitor asset-popularity metrics to determine how popular the listed asset is and whether the immediate-purchase price should be updated to reflect the asset's popularity (whether by increasing or decreasing the immediate-purchase price).

If the control logic 122 determines that the immediate-purchase option should be updated (416 YES), then the process 400 continues to act 418. Otherwise, if the control logic 122 determines that the immediate-purchase option should not be updated (416 NO), then the process 400 continues to act 420. In various examples, act 416 may be optional; for example, if the bidder interface does not include an immediate-purchase option (408 NO), then act 416 may not be executed and act 412-NO and act 414 may proceed directly to act 424, discussed in greater detail below. In another example, if an immediate-purchase option is provided (408 YES) but is fixed and not dynamic, then act 416 may not be executed and act 412-NO and act 414 may proceed directly to act 420, discussed in greater detail below.

At act 418, the control logic 122 updates the immediate-purchase option. For example, the control logic 122 may update the immediate-purchase price listed on the bidder interface.

At act 420, the control logic 122 determines whether an immediate-purchase selection has been received. For example, the control logic 122 may determine whether a buyer has selected the one or more second user-interface elements (for example, the immediate-purchase buttons 1504) to immediately purchase the asset prior to the auction close time determined at act 402 expiring. If the control logic 122 determines that an immediate-purchase selection has been received (420 YES), then the process 400 continues to act 422. Otherwise, if the control logic 122 determines that an immediate-purchase selection has not been received (420 NO), then the process 400 continues to act 424.

At act 422, the control logic 122 closes the auction prematurely in real-time with the buyer selecting the immediate-purchase option. The auction is closed prematurely inasmuch as the auction close time determined at act 402 has not yet expired; accordingly, the buyer is advantaged in being able to circumvent the uncertainty (both in terms of a final price and whether the buyer will win the auction) of the auction process by buying the asset immediately and in real-time.

Moreover, because the buyer may be pre-authenticated and/or real-time-continuously-re-authenticated to execute and satisfy the immediate-purchase option, it may be feasible for the control logic 122 to confidently close the auction prematurely in real-time with the buyer selecting the immediate-purchase option. In a non-online auction or an online auction that does not necessarily involve pre-authentication or real-time-continuously-re-authentication, it may be inappropriate to end the auction in real-time because the seller and/or auctioneer may need to verify that the buyer can satisfy the transaction. Thus, prematurely closing the auction in such situations may lead to undesirable situations in which a buyer who is unable to consummate the transaction submits an immediate-purchase offer, causing the auction to be unnecessarily closed before a determination can be made as to whether the buyer can actually satisfy the transaction. Executing online auctions in real-time as discussed herein therefore provides substantial improvements to the field of online transactions, and is inherently rooted in computer technology at least because of the unique possibility of continuous and/or real-time authentication in a computerized environment.

At act 424, based on not having yet received a selection of an immediate-purchase option, the control logic 122 determines whether the auction close time has expired. For example, the control logic 122 may determine whether the auction close time determined at act 402 has expired. If the control logic 122 determines that the auction close time has expired (424 YES), then the process 400 continues to act 426. Otherwise, if the auction close time has not yet expired (424 NO), then the process 400 returns to act 412 to again monitor for additional bids in real-time.

At act 426, the control logic 122 closes the auction at the auction close time. Closing the auction may include preventing other buyers from submitting any additional bids. As discussed above, a closing process may then be initiated in which the winning bidder and seller complete the closing of the transaction.

As discussed above, FIG. 5 may provide an example of act 416. FIG. 5 illustrates a process 500 of determining whether to update an immediate-purchase option presented to buyers. The control logic 122 may execute the process 500 dynamically in real-time and/or repeatedly while executing the process 400 such that an immediate-purchase option is always up-to-date.

At act 502, the control logic 122 monitors one or more asset-popularity metrics. Asset-popularity metrics may include any parameters or metrics indicative of how popular an asset is (that is, how in-demand the asset is). If the asset is more popular, the immediate-purchase price may be increased to reflect the high demand for the asset. Example asset-popularity metrics include an average number of page views of the asset listing, an average duration of time spent on the asset listing, a number of bids placed on the asset, a frequency of bids placed on the asset, an amount of time until the auction close time expires, individual bidder bidding history information, and so forth.

With respect to the average number of page views and average duration spent on an asset listing, these metrics may be indicative of how much online web traffic is directed to the asset listing. A high-demand asset may be visited by more buyers and for longer durations than low-demand assets. Accordingly, the control logic 122 may monitor these web-traffic metrics in real-time. In other examples, the control logic 122 may monitor other web-traffic metrics indicative of how much more popular one asset listing page is than another.

With respect to the number and frequency of bids placed on an asset listing, these metrics may be indicative of how interested buyers are in submitting bids on the asset. The number of bids placed on the asset may indicate a total number of bids that have been placed since the auction opened. The frequency of bids on the asset may indicate a number of bids placed on the asset over some time period, such as a fixed or rolling-window time period. For example, the frequency of bids may represent how many bids are placed in a rolling window of the past six hours. This may enable the control logic 122 to distinguish between a first listing that receives 20 bids in only the past six hours and a second listing that receives 20 bids over an entire auction time period of, say, 72 hours. Although both listings receive the same number of bids, the first listing may be more in-demand (as indicated by the large number of bids in a short period of time) and thus have a higher bid frequency to reflect its popularity.

With respect to the amount of time until the auction close time expires, this metric may be indicative of how much time remains until the auction closes. In some examples, at the beginning of an auction, there may be less certainty as to what price an asset will sell for. Accordingly, if a substantial amount of time remains until the auction expires, the immediate-purchase price may be increased more dramatically in response to a high number of bids. Conversely, if an auction is almost closed, the immediate-purchase price may be increased by a smaller amount. This scheme may protect sellers from disadvantageously low sale prices; in other examples, the inverse scheme may be implemented, that is, the immediate-purchase price may be increased by larger amounts as time elapses.

With respect to the individual bidder bidding history information, the control logic 122 may track each individual buyer's activity on the platform. For example, if a bidder has already placed a highest bid on the asset, then the immediate-purchase price may be decreased for that particular bidder to incentivize bidding from buyers. In another example, if a bidder has already placed a highest bid on the asset, then the immediate-purchase price may be increased for that buyer to incentivize immediate purchases (rather than placing bids) and/or to account for the fact that the buyer is interested enough in the asset to have placed a bid. Similar principles apply not only to the bidder's number of bids, but also to their frequency of bids. Furthermore, in some examples, the control logic 122 may consider the bidder's individual bidding history across other assets. For example, the control logic 122 may consider the total number of bids placed by the bidder, an average frequency of bids placed by the bidder, a total number of purchased properties by the bidder, information indicative of a percentage of assets the buyer places bids on or immediately purchases that the buyer ultimately purchases (that is, a number of purchased properties divided by the number of properties bid on or immediately purchased), or any other information that may indicate how likely an individual buyer is to purchase the property (that is, how in-demand the particular property is for that particular buyer).

At act 504, the control logic 122 determines whether to update the immediate-purchase price. The control logic 122 may execute the determination continuously and/or in real-time based on the asset-popularity metrics monitored at act 502. For example, the control logic 122 may update the immediate-purchase price each time a bid is placed, or each time a number or frequency of bids exceeds or falls below a threshold or falls within a range, or continuously over time as the auction close time looms closer, or as a number of page views or average or cumulative page-view-duration exceeds or falls below a threshold or falls within a range, or in response to some other update trigger. In at least one example, the control logic 122 may implement machine-learning-based methods of determining whether to update the immediate-purchase price. For example, the control logic 122 may implement an artificial-intelligence (AI)-based algorithm trained at least on asset-popularity metrics and sales data to determine, based on the asset-popularity metrics, what an optimal immediate-purchase price may be. The optimal immediate-purchase price may be tuned to be optimal for the buyer, or optimal for the seller, or optimal for the platform, or optimal for a combination thereof. For example, if the optimal immediate-purchase price is tuned to the seller, then the AI-based algorithm may ingest the asset-popularity metrics and determine what immediate-purchase price is most likely to yield the best (for example, highest) selling price for the seller.

If the control logic 122 determines that the immediate-purchase price should be updated (504 YES), then the process 500 continues to act 508. Otherwise, if the control logic 122 determines that the immediate-purchase price should not be updated (504 NO), then the process 500 continues to act 506.

At act 506, the control logic 122 updates the immediate-purchase price. For example, the control logic 122 may update the immediate-purchase price in real-time in response to changes in the asset-popularity metrics, that is, may update the immediate-purchase price immediately in response to changing asset-popularity metrics. Because the control logic 122 is capable of updating the immediate-purchase price in real-time, buyers always have access to an up-to-date immediate-purchase option, which is advantageous to buyers, and sellers have the peace-of-mind of knowing that the immediate-purchase price is continuously updated in real-time to reflect the most up-to-date asset-popularity metrics representing how in-demand the asset is.

At act 508, the control logic 122 displays the immediate-purchase price. For example, the control logic 122 may provide instructions to the buyer computing device 102 control logic 110, which may control the GUI 108 to display the immediate-purchase price on the bidder interface. For example, the immediate-purchase buttons 1504 displayed on the bidder-interface screen 1500 includes the immediate-purchase price of $510,000.

Acts of the processes 400, 500 are illustrated as occurring in a particular order for purposes of explanation. In various implementations, the order of acts may be adjusted relative to what is shown in FIGS. 4 and 5. For example, acts 412, 416, 420, and 424 may be continuously executed in real-time in parallel with one another rather than in series with one another. Similarly, the control logic 122 may continuously execute acts 502 and 504 in real-time and in parallel with one another. As discussed above, the ability of the control logic 122 to execute certain operations dynamically and in real-time provides substantial advantages unique to online auctions executed in a computer environment, and the examples disclosed herein represent a substantial improvement to the field of sales processes such as online auctions.

As discussed above, one or more electronic devices may execute the platform. For example, the control logics 110, 116, and/or 122 may execute one or more processes discussed above. The electronic device(s) may include one or more controllers to execute various operations discussed above. The controller may also execute one or more instructions stored on one or more non-transitory computer-readable media, which the controller may include and/or be coupled to, which may result in manipulated data. The non-transitory computer-readable media may include memory and/or storage. In some examples, the controller may include one or more processors or other types of controllers. In one example, the controller is or includes at least one processor. In another example, the controller performs at least a portion of the operations discussed above using an application-specific integrated circuit tailored to perform particular operations in addition to, or in lieu of, a processor. As illustrated by these examples, examples in accordance with the present disclosure may perform the operations described herein using many specific combinations of hardware and software and the disclosure is not limited to any particular combination of hardware and software components.

Examples of the disclosure may include a computer-program product configured to execute methods, processes, and/or operations discussed above. The computer-program product may be, or include, one or more controllers and/or processors configured to execute instructions to perform methods, processes, and/or operations discussed above. In various examples, the controller may be coupled to at least one display device. The controller may control the at least one display device to provide a graphical user interface on which the information discussed above with respect to FIGS. 6-71 may be displayed. The controller may also be coupled to one or more user-input devices to receive user inputs from buyers, sellers, and/or administrators.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. At least one non-transitory computer-readable medium storing thereon sequences of computer-executable instructions for providing a real-time dynamically adjusted user interface for an online auction, the sequences of computer-executable instructions including instructions that instruct at least one processor to:
determine, for an asset being auctioned in the online auction, an auction close time at which the online auction will close;
provide a bidder interface for a bidder, the bidder interface including one or more first user-interface elements to enable the bidder to place at least one bid on the asset being auctioned;
determine, dynamically in real-time while the online auction is being conducted, whether the bidder has access to an immediate-purchase option;
in response to determining that the bidder has access to the immediate-purchase option, provide one or more second user-interface elements on the bidder interface to enable the bidder to immediately purchase the asset for an immediate-purchase price prior to the auction close time expiring;
in response to determining that a bid has been received on the asset being auctioned while the online auction is in progress and prior to the auction close time expiring, update the bidder interface in real-time to display a current highest bid; and
in response to determining that a selection of the one or more second user-interface elements has been received to immediately purchase the asset prior to the auction close time expiring, update the bidder interface in real-time prior to the auction close time expiring to indicate that the auction has been closed prematurely.

2. The at least one non-transitory computer-readable medium of claim 1, wherein the instructions further instruct the at least one processor to:
monitor one or more asset-popularity metrics indicative of an amount of interest in the asset; and
dynamically update the immediate-purchase price in real-time on the bidder interface while the online auction is in progress based on the one or more asset-popularity metrics.

3. The at least one non-transitory computer-readable medium of claim 2, wherein the one or more asset-popularity metrics include an amount of website traffic to the bidder interface for the asset.

4. The at least one non-transitory computer-readable medium of claim 2, wherein the one or more asset-popularity metrics include a number of bids placed on the asset.

5. The at least one non-transitory computer-readable medium of claim 2, wherein the one or more asset-popularity metrics include a frequency of bids placed on the asset.

6. The at least one non-transitory computer-readable medium of claim 2, wherein the one or more asset-popularity metrics include an amount of time until the auction close time expires.

7. The at least one non-transitory computer-readable medium of claim 2, wherein the one or more asset-popularity metrics include whether the bidder has previously placed a bid on the asset during the online auction.

8. The at least one non-transitory computer-readable medium of claim 2, wherein dynamically updating the immediate-purchase price is executed within a lower bound and an upper bound of purchase prices.

9. The at least one non-transitory computer-readable medium of claim 2, wherein the instructions further instruct the at least one processor to extend the auction close time based on the one or more asset-popularity metrics.

10. The at least one non-transitory computer-readable medium of claim 1, wherein the instructions further instruct the at least one processor to determine whether the bidder has access to the immediate-purchase option based on authenticating at least one of financial information, identity information, or closing documentation of the bidder.

11. The at least one non-transitory computer-readable medium of claim 10, wherein the financial information includes documentation indicating the bidder's ability to pay the immediate-purchase price.

12. The at least one non-transitory computer-readable medium of claim 11, wherein the documentation includes bank account information indicative of an amount of money currently held by the bidder in a bank account.

13. The at least one non-transitory computer-readable medium of claim 11, wherein the documentation includes loan information indicative of an amount of money available to the bidder as a pre-approved loan.

14. A method of providing a real-time dynamically adjusted user interface for an online auction, the method comprising:
determining, for an asset being auctioned in the online auction, an auction close time at which the online auction will close;
providing a bidder interface for a bidder, the bidder interface including one or more first user-interface elements to enable the bidder to place at least one bid on the asset being auctioned;
determining, dynamically in real-time while the online auction is being conducted, whether the bidder has access to an immediate-purchase option;
in response to determining that the bidder has access to the immediate-purchase option, providing one or more second user-interface elements on the bidder interface to enable the bidder to immediately purchase the asset for an immediate-purchase price prior to the auction close time expiring;
in response to determining that a bid has been received on the asset being auctioned while the online auction is in progress and prior to the auction close time expiring, updating the bidder interface in real-time to display a current highest bid; and
in response to determining that a selection of the one or more second user-interface elements has been received to immediately purchase the asset prior to the auction close time expiring, updating the bidder interface in real-time prior to the auction close time expiring to indicate that the auction has been closed prematurely.

15. The method of claim 14, further comprising:
monitoring one or more asset-popularity metrics indicative of an amount of interest in the asset; and
dynamically updating the immediate-purchase price in real-time on the bidder interface while the online auction is in progress based on the one or more asset-popularity metrics.

16. The method of claim 15, wherein the one or more asset-popularity metrics include an amount of website traffic to the bidder interface for the asset.

17. The method of claim 15, wherein the one or more asset-popularity metrics include a number of bids placed on the asset.

18. The method of claim 15, wherein the one or more asset-popularity metrics include a frequency of bids placed on the asset.

19. The method of claim 15, wherein the one or more asset-popularity metrics include an amount of time until the auction close time expires.

20. The method of claim 15, wherein the one or more asset-popularity metrics include whether the bidder has previously placed a bid on the asset during the online auction.
